(19) United States
(12) Patent Application Publication
(10) Pub. No.: US 2012/0298676 A1
(43) Pub. Date: Nov. 29, 2012

(54) CONTAINERS,ETC WITH OR WITHOUT MULTI-PRODUCTS AND/OR MULTI-PD'S ARE NOT

(75) Inventor: KRISTOFFER COOKS, Dallas, TX (US)

(73) Assignee: kristoffer cooks

(21) Appl. No.: 13/462,706

(22) Filed: May 2, 2012

Related U.S. Application Data
(60) Provisional application No. 61/457,636, filed on May 3, 2011.

(51) Int. Cl. B65D 25/04; B23P 17/00

(52) U.S. Cl. 220/592.21; 29/592; 220/500

(57) ABSTRACT

Pocket department (PD) etc in etc: sports container beverage and food containers etc products etc. Which said PD etc can also cool and heat etc holds etc products etc like power bars etc from melting etc and can combine drinks etc and food etc. Furthermore invention shows also backward and forward products etc and MULTI PDS and MULTI PRODUCTS etc or not and shows with or without products etc and shows companies and customers rights etc and define display PD etc as PD and can be in any product etc not just food and drinks containers and PD etc can be also place in the housing casing the body of any products etc and product etc can be within product etc and invention shows same contents etc. Invention for plants pets humans etc and use each others PDS products materials parts etc.

### CROSS-REFERENCE TO RELATED APPLICATIONS

Provisional patent application, No. 61/457,636, Entitled “Pocket department and products for containers”, filed on May 3, 2011

### FEDERALLY SPONSORED RESEARCH

Not Applicable

### SEQUENCE LISTING OR PROGRAM

Not Applicable

### BACK GROUND OF THE INVENTION

1. Field of Invention

This invention relates to containers, etc (of all kinds casing, housing, in the body of, etc) and products, etc and more particularly or specifically relates to eating, drinking, and storing container, etc and unlimited uses of products, etc.

2. Prior Art

The present invention (PI) reports the prior art, the prior will show different types of containers, etc (casing of, etc body of, etc housing of, etc will be shown through-out the present invention, how said invention will be even more different from prior art) some having compartment are known in the arts, some of there said compartment having articles, here are some examples of prior art:

The background of prior art relates to drink/food container's relating to snack's and other foods and drinks, and articles; known in the arts, the present invention will show to be different from these patents; U.S. Pat. No. 7,845,145; U.S. Pat. No. 7,886,505, etc; which holds drinks and food or there articles; the present invention pocket departments, (PD), etc holds, etc products, etc and uses the touch tech. (TT) 100% surrounding, etc said product, etc and display, etc and allows easy access, etc to (transferring hot and cold, etc to products, etc) it's said product at the same time, etc; and the present invention is more then a single food container, etc; and the present invention uses PD, etc in new use containers, etc and can allow also food and drinks in them and new products in them, etc; so said present invention respectfully is different from other said patents; and more differences will be seen in the present invention accompany text and drawings, etc.

The background of prior art relating to container in (e.g., closure's known in the arts use to hold articles.), the present invention shows to be different from U.S. Pat. No. 7,175,037, etc; the present invention will show easy access, etc to it's cap top PD contents, etc, without removing said cap from it container, etc, to have access to it's PD and difference will be seen through-out the present invention and it's drawing, etc show different uses, etc.

The background of prior art relating to sport bottle which are use for sport, etc use, etc allowing a drink to refuel, etc the body, etc; but the present invention allows newly uses food and drink, etc and products in it's display PD, etc allowing also easy access, etc; to said PD contents, without screw and UN-screwing its compartment and without remove the container from the bike, etc container holder, etc; to gain access to its contents; so respectfully the present invention shows to be different from U.S. Pat. No. 7,798,346, etc.

Furthermore, the present invention will also shows to be different from U.S. Pat. No. 7,214,397; “praline” confectionery, etc; the present invention candy sucker, etc product, etc, can be place in PD, etc (or not; to any present invention product) and can have flavors agents, etc to taste like beverages, etc; and the present invention shows how the use is difference by dipping, etc the head, etc part of the said candy, etc product into the container content, etc or sucking the contents from container with said sucker, etc straw part. And this product, etc shows different the customer can use the present invention product with anyone container with content, etc and said product, etc can be sold apart from its container, etc; more will be said with the accompany text and drawing to come, etc.

Furthermore, the background of prior art will relate to water toys, etc the present invention will also shows to be difference from others prior art patents, etc in this field, etc; so therefore the present invention will shows to be difference from water toys, etc and guns, etc by placing in them the new uses pocket department, etc with and without products, etc; and allowing for the first time away to drink, etc out of, etc the container (water gun, etc it housing can also be said as said container) tank, etc of said water gun, etc, more will be said on this subject with the coming text and drawings, etc, and the present invention will also shows that it do not need; like said in others patent a “via connector”, the present will show holding, etc products, etc and MULTI-PD'S, etc and MULTI-PRODUCTS, etc and, PD'S, etc and products, etc; and the present invention water guns product, etc in a pocket department (said pd made, etc into the casing, etc of the product, etc or any toy or water gun, etc) difference from other patents, and the present invention allows away to hold (these are products made by others companies, etc) others toy water gun, etc or any product, etc; or place your own toy, etc into a product, etc or container, etc or water gun product, etc or in PD, etc.

The present invention is not for just toy water guns, etc; its also for products like laser guns, etc and containers, etc or food, etc or TV, etc, or radio, etc or game device, etc and all waterproof products, etc (or none or all or your choice, etc) in, etc water gun PD, etc; but note with coming text you notice product can be also all waterproof packages, etc and container's, etc and PD itself can also be made waterproof, etc; also note the UN-obvious present invention product, etc or PD'S, etc and it's product, etc or PD, etc can have a product, etc and so on and so on, etc (or not); so therefore the present invention show to be different; and holds, etc any product, etc in the same, etc pocket, etc or in, etc different pocket, etc (notice), I said pocket not connector, etc, so therefore with respect the present invention shows to be different from U.S. Pat. No. 7,025,228, etc.

Once again the present invention and the present invention prior art are those that are housing, casing, etc of any container, etc of any product, etc not just food and drink, etc container, etc, so therefore; the present invention background should be seen as all products, etc; which the present invention will or could surround, etc and the present invention description, etc will show this, but sense all the present invention product, etc and container, etc can also, etc (or not) include food and drink, etc these said patents, etc which reflex's some of the direction of the present invention. The new use sleeve use in coffee shop, to stop hands from being burn now use different as doors, etc as to also prevent, etc the PD product from be heat, etc by your hand, etc by the sun, etc example you are working in your yard and you sit your beverage container, etc on your garden chair the new sleeve prevent the sun from melting, etc your PD, etc product, and place in PD or seal or place in PD to make PD neutral from it container contents, etc TT (to stop the TT) more will be said in coming text, so there the present invention with respect is different from U.S. Pat. No. 6,863,644, etc.

The present invention product with a, etc PD is the being (new), an UN-obvious example of this out of many a, etc dog, etc food edible bone have a, etc PD, etc with loose dog, etc food, etc in, etc its PD, etc; and other different uses and new uses are showing different from these prior art, etc patent, etc will be seen in this present invention and new uses of PD, etc used in plants products, etc and pet, etc containers, etc and products, etc. Note, even patents not show in this relevant prior art text will be shown different from the present invention with the accompany text to coming and the drawing, etc or add a display PD, etc or a, etc product, etc within a, etc product, etc to show difference, etc and newness, etc from others patents, etc, but not in some cases just a pd is need to be add into the product, etc or container, etc because its totally new in that container or product, etc soon to be seen by the reader in the coming up text and drawing, etc; and the present invention PD, etc can be place any where on its container, etc and made all sizes, etc all shapes, etc and all designs, etc; and uses the touch tech (TT), etc, and furthermore the present invention container can be in holders, etc like car cup, etc holders, etc workers truck, etc holders, etc; backpack holders, etc and still have access to said present invention pd, etc contents, etc without removing it from said holders, etc and without twisting or unscrewing, etc a compartment like some other compartments, etc to gain access to there articles, which while driving, etc running, etc biking, etc could be dangerous, etc; many more reason in the present coming text and drawings will show more advantages, etc; and also see product section, etc.

Now will be given some more description of the new present invention products, etc uses, etc and UN-obviousness, etc examples, etc that is different, etc from prior art; the reader (with coming text, etc) must try to understand the present invention it is not a simplification its products, etc and pocket departments, (PD'S) etc come with and without said product, etc parts, etc and PD'S, etc; yes even its PD'S, etc for companies, etc rights, etc (future, etc own, etc of this patent, etc or license's, etc). A teaching example is given, you the reader must do yourself (mentality) on any of the present invention products, etc to try to understand the present invention more; a, etc cell phone product, etc have, etc a, etc pocket, etc that fits, etc a, etc magnetic product, etc removable or not, to be place on your bike, etc; or a, etc cup product, etc with and without a, etc magnetic product and with and without a, etc magnetic PD, etc to be place, etc on your refrigerator product, etc (teaching, yes this refrigerator, etc can have PD, etc); and if its a cup in prior art that does this PI way (teaching) said prior art cup, etc,

the present invention can, etc or, etc will be (or not) able to add in a, etc “new pocket department” (to the old cup, etc without said PD) or product, etc like, etc a electrical calendar product, etc and not violate the other patent, etc if it existed; because now it hold more then one item, etc, or it can come off and become wearable, etc or not to all, its can just be a, etc cup, etc on your refrigerator, etc without any of the other parts, etc said because of companies, etc right, etc and customers, etc rights, etc and, etc; this is what this present invention is also made to do; more will be said about rights in come text, etc.

When said removable, etc or not is to keep cost down, etc and to use that same, product (besides for magnetic product; but not said container, etc can have many pd, etc on one, etc container, etc so PD can be different for other products, etc) etc PD, etc for other products, etc or interchangeable products, etc or not. More UN-obvious text, etc magnetic products, etc can go into any product another UN-obvious, etc example, yes the refrigerator, etc product, etc can have a, etc magnetic PD, etc it can be a, etc compact, etc refrigerator, etc product, etc that stick, etc to your mobile camper, etc and yes this means your ketchup container, etc can also stick to your refrigerator, etc and so on and so on, etc all products, etc for the present invention can also (or not) use this, etc magnetic, etc product, etc.

So therefore the present invention shows (with much respect for other patents, etc) super jump over prior art, etc; the present invention is supervene, etc supreme, etc and is superimpose, etc once again with respectfully in its thoughtfulness of others (the present invention have much respect for inventors). When said the present invention is supervene, (coming unexpectedly) note the soda, etc bottle, etc container PD, etc have a, etc shape, etc as a magnetic product, etc (a quick note same shape PD do not necessary need adhesive said shape can hold said magnetic in said PD, etc) and said magnetic product do not come with (or do) said soda bottle container, etc PD for said cost reasons, etc so; when you get home, etc place your magnetic product in the soda PD the place it on said refrigerator product, etc, note products, etc can be sold apart more will be said come text, etc.

### SUMMARY

According to the invention, a, etc container, etc having a, etc pocket department, etc also means for also carrying, etc holding, etc dipping, etc storing, etc cooling, etc and heating, etc a, etc product for said container, etc; and a, etc already, etc fill container, etc having a, etc product, etc for and without pocket department, etc but for container, etc. The container contents (product filled already container, etc) and product means for proving benefits, etc; the present invention is also a backward and forward PD'S, etc and products, etc and MULTI-PD'S, etc and MULTI-PRODUCT'S, etc. Other systems, etc, methods, etc, feature, etc, advantages, etc and arguments for patent-ability of the invention will be or will become apparent to one skilled in the art upon examination of the following background of the invention and description of drawing and figures and detailed description, etc; all such additional systems, etc methods, etc features, etc advantage, etc and arguments for patent-ability are intended to be included within this description, within the scope of the invention, and is also protected by the accompanying claims, etc.

### DRAWING

### Figures

In the present invention drawing figures shows:

FIG. 1 shows the sport bottle container/bike container and also known as the water bottle container; said container show with a optional stainless pocket department and with grooves for sliding tray.

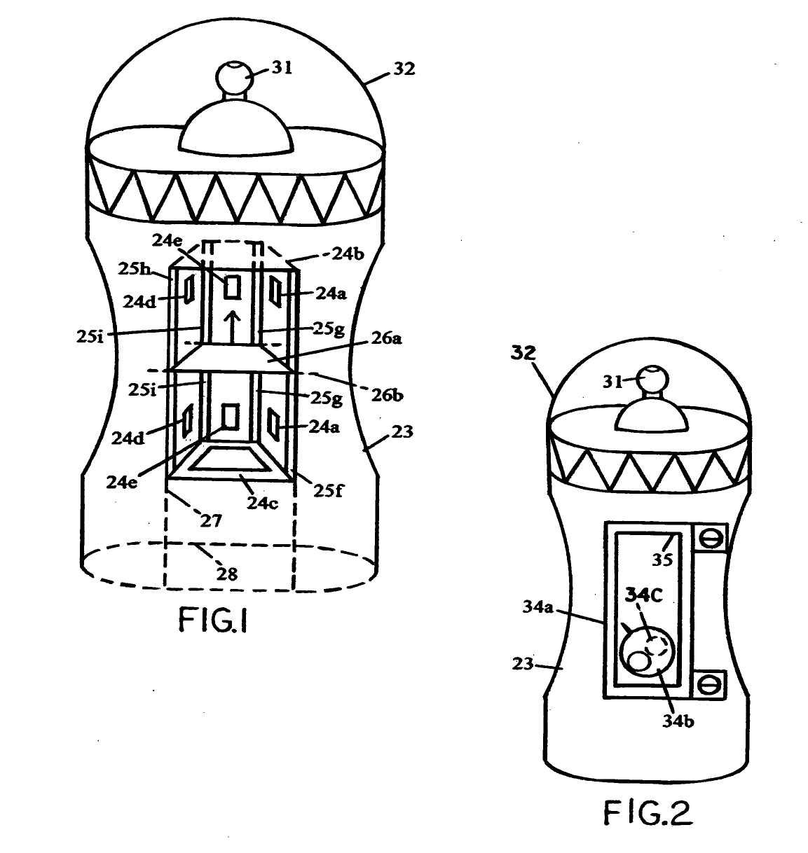

FIG. 2 shows the sport bottle container, etc with its door and its value cover.

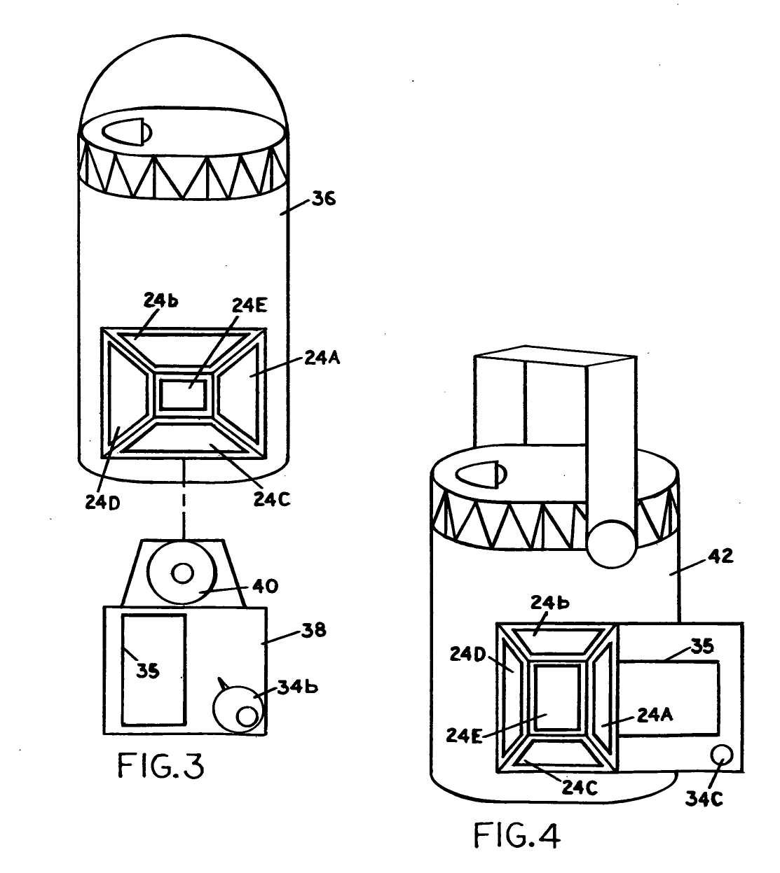

FIG. 3 shows the thermal container and shows its pocket department, slide out plate door; this said door and said pocket department can be made stainless steel, etc or out of the same materials as the container materiel, etc.

FIG. 4 shows the cooler bottle container with its pocket department also shown open.

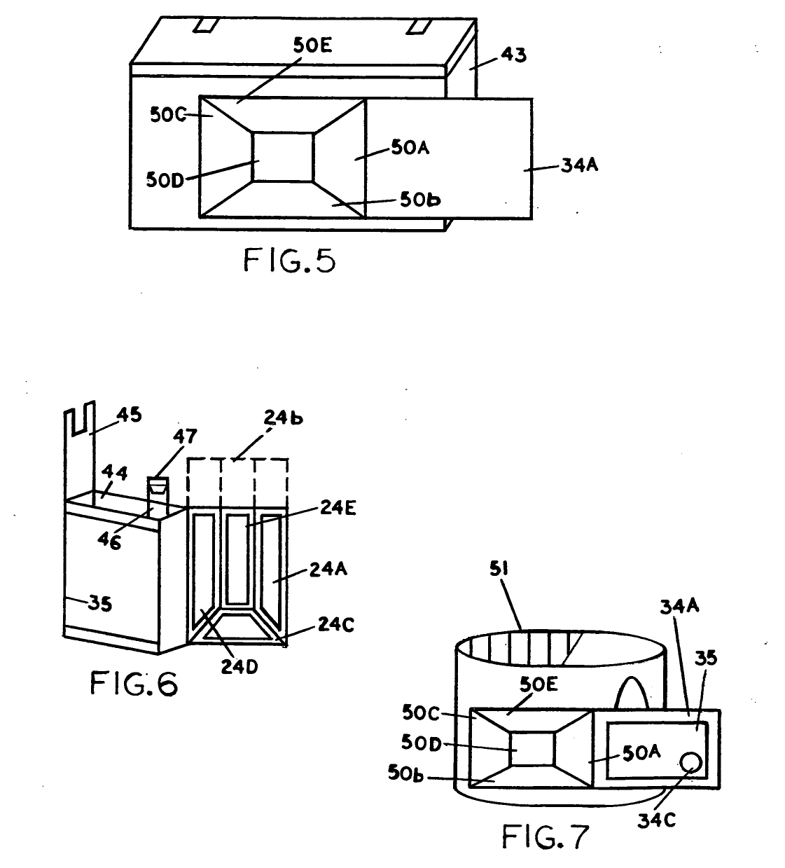

FIG. 5 shows the cooler container also with its door open and this pocket department also shows how a display pocket department can look on the cooler container, etc.

FIG. 6 shows the alternative the ice and hot door container PD show open.

FIG. 7 shows the coffee cup/mug container shown with its door open.

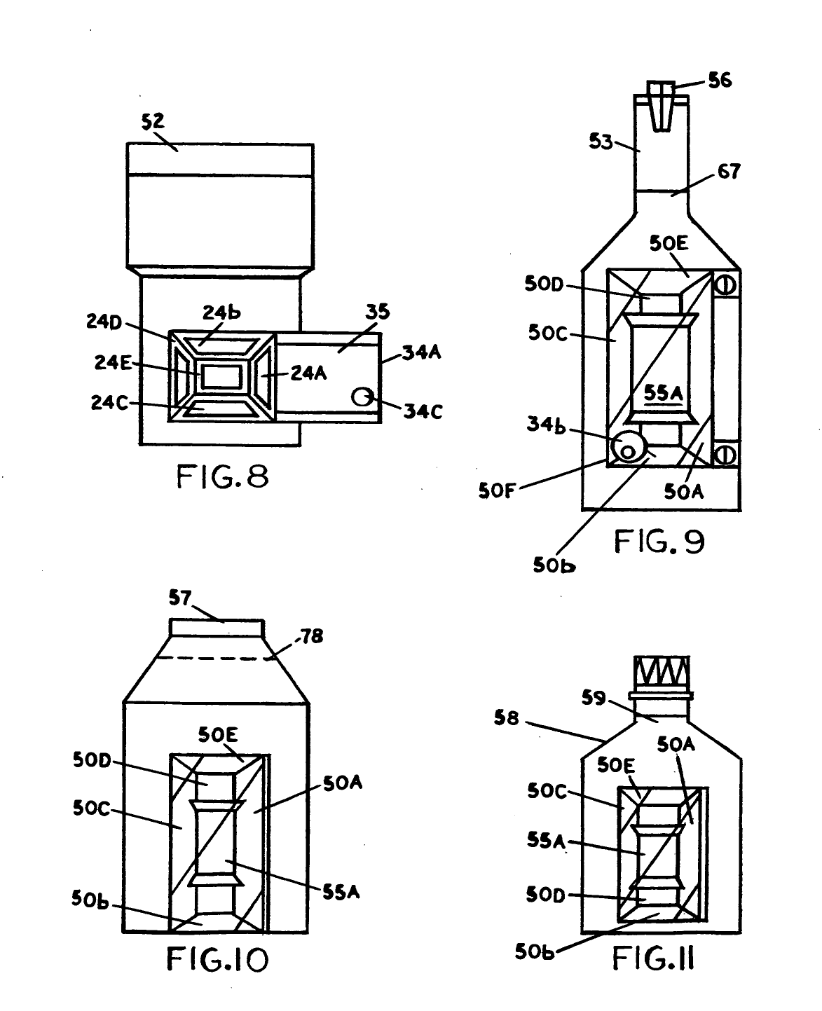

FIG. 8 shows the cup container with display pocket department with its door open.

FIG. 9 shows the wine bottle container with real wine in its container and its pocket department of (optional) stainless steel and door; also can be removable said PD and within said pocket department shows product, etc.

FIG. 10 shows the carton container with hidden lines showing real beverage of any kind (like milk, soda juice, etc any beverage, etc) in the container and product like (cake donuts, etc), in pocket department door also shown clear.

FIG. 11 shows the bottle container with real beverage of all kind like and UN-like (real soda, diet soda, any beverage, and power drink and weight lose drink, etc) in the container and product like, etc (real candy, diet candy, nuts, power bars, diet meals, meals, weight lose food, etc) in pocket department; remember all containers, etc, and PD can use each-other contents, etc also.

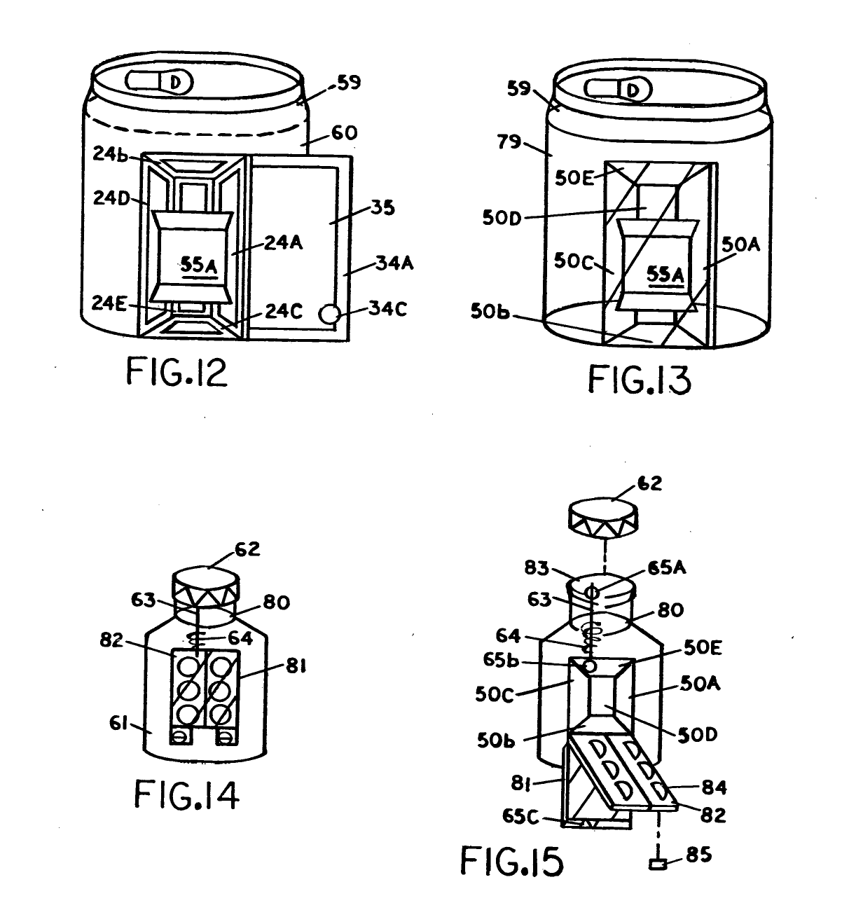

FIG. 12 shows the can container with real beverage of all kind in the container and product in pocket department.

FIG. 13 shows the clear can container with beverage of any kind in the container and product of any kind in the pocket department.

FIG. 14 shows the medicine bottle container with real medicine, liquid medicine, cold medicine, cough medicine, allergy medicine, etc and lubricate drink, etc in the container and real medicines, pills, vitamins, tabs, cough drops, etc in PD, this fig also shows PD with its pin spring locking PD door.

FIG. 15 shows the medicine bottle container shows said container top off this releases pin spring so PD door can open PD to have access to packages, etc contents, etc containers, etc.

FIG. 16 shows the bag container with real product in the bag like and UN-like (chip, cookie, even UN-obvious, etc product like dirt, etc) and the same, etc and UN-like, etc (chip, etc cookie, etc dirt, etc) in the pocket department.

FIG. 17 shows the o-circle container shown see through and it's PD shown close and fig arrow shows how the close lid top dipping, etc pocket department lift up, etc and turn open, etc which allows access to container contents.

FIG. 18 shows the o-circle container shown with real food, etc product, and fig shows the lid top dipping, etc pocket department open to dip, etc chip, etc from the container content, etc.

FIG. 19 shows the o-circle container with the pull out cup display PD, etc.

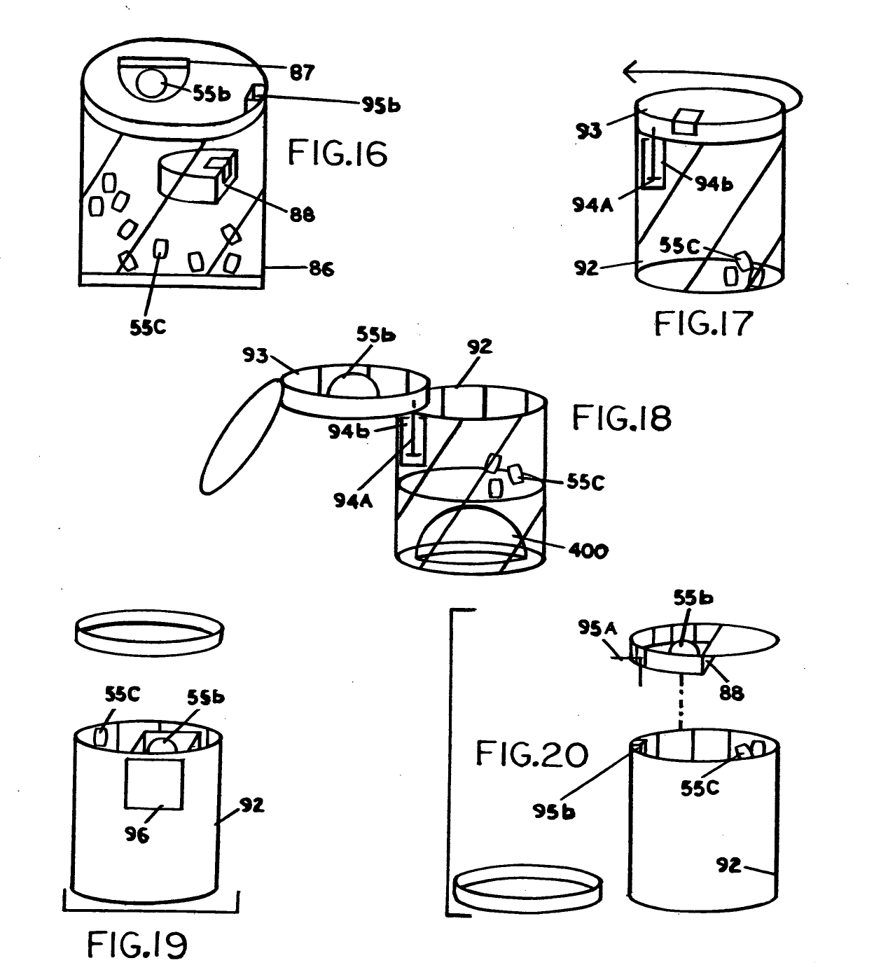

FIG. 20 shows the o-circle container solid not clear and fig shows the connector; removable PD connect to container which allows you to hold container and dip, etc at the same time, etc and the o-circle containers, etc shows how the present invention container ca have many different PD'S, etc

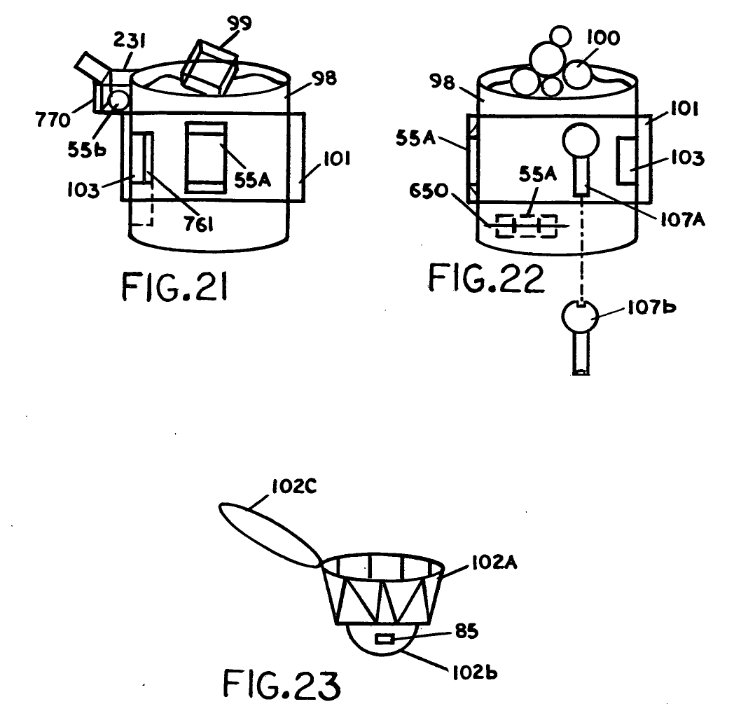

FIG. 21 shows the I representation container, etc this container, etc represent all container for the present invention not shown, etc and this fig show the TT used without the uses of a PD; and fig shows cold content, etc which could be any cold content, etc; and fig show product being held to container by wrapper, etc; and fig show how the present invention will use each-other products, etc and PD'S.

FIG. 22 shows the I representation container, etc with hot content, etc in the container, etc, and this fig shows how the PD will be made all shape, etc and size, etc and design, etc and shows how PD, etc and product will fit together without a door, etc.

FIG. 23 shows the cap top container PD which shows holding, etc carry, etc stores, etc pills, etc candy, etc cake, etc, pie, etc product, etc, and fig show quick access of this, etc PD door open; this PD can also be made all size, etc and can be for any of the present invention container, etc.

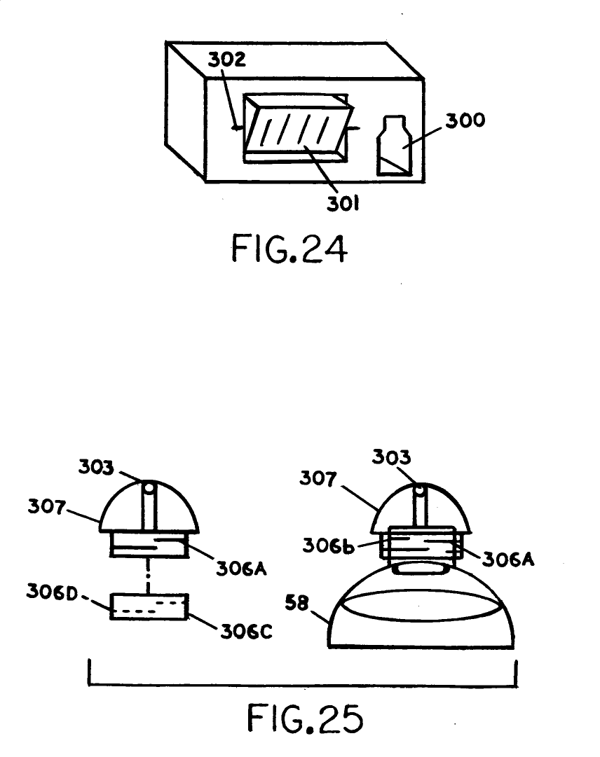

FIG. 24 shows the cooler container with different kinds of pocket departments.

FIG. 25 shows the edible molded closure and any container it can be connected to or can be place in a PD.

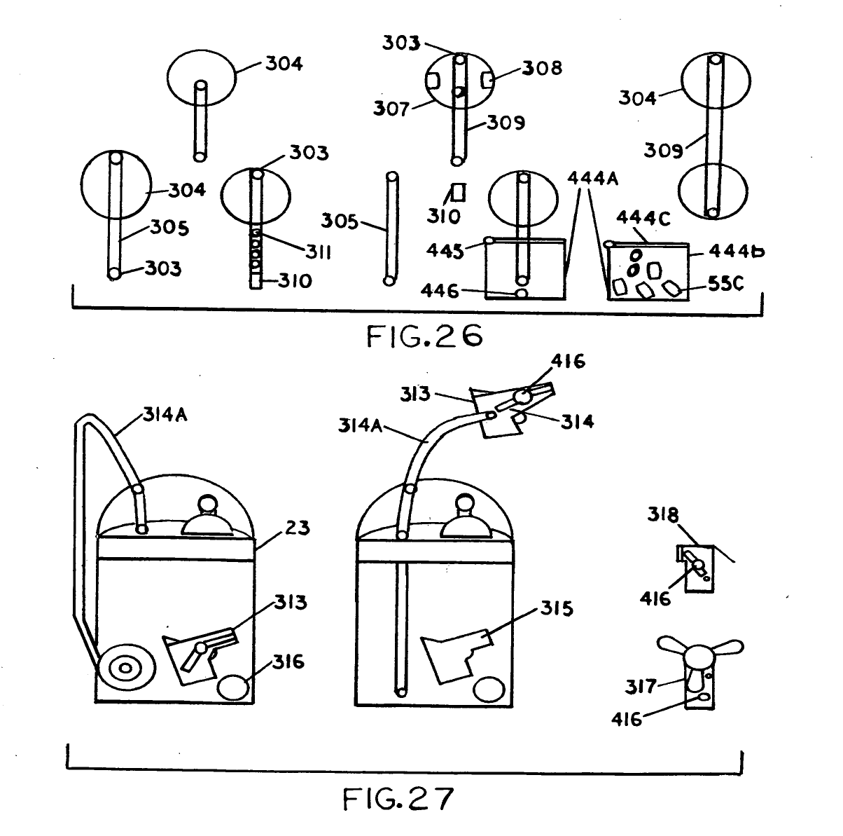

FIG. 26 shows the shows the different kinds of design edible suckers products.

FIG. 27 shows how the water gun product, etc (or any product) can be for any container, on this fig said water gun product, etc shown on the bike container.

FIG. 28 shows the all holder container with PD, to use or not the touch tech and fig shows the backpack beverage bag container holder.

FIG. 29 shows a, etc container using a, etc new use sleeve or wrapper or label, etc use as a, etc new slide, etc up and down, etc door, etc.

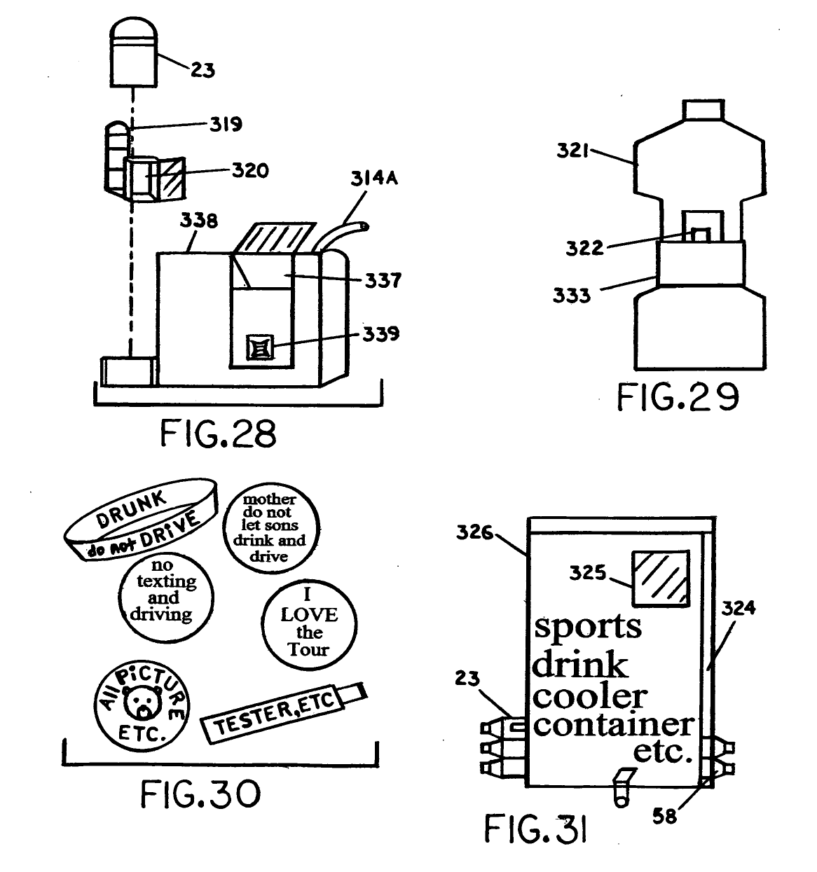

FIG. 30 shows product buttons and products for promoting; and for other needs, and reasons.

FIG. 31 shows the sports team cooler/worker container and can be any container with (can be not many PD'S and products, etc also) MULTI-PD'S and MULTI-PRODUCT'S, and container products, etc and display PD.

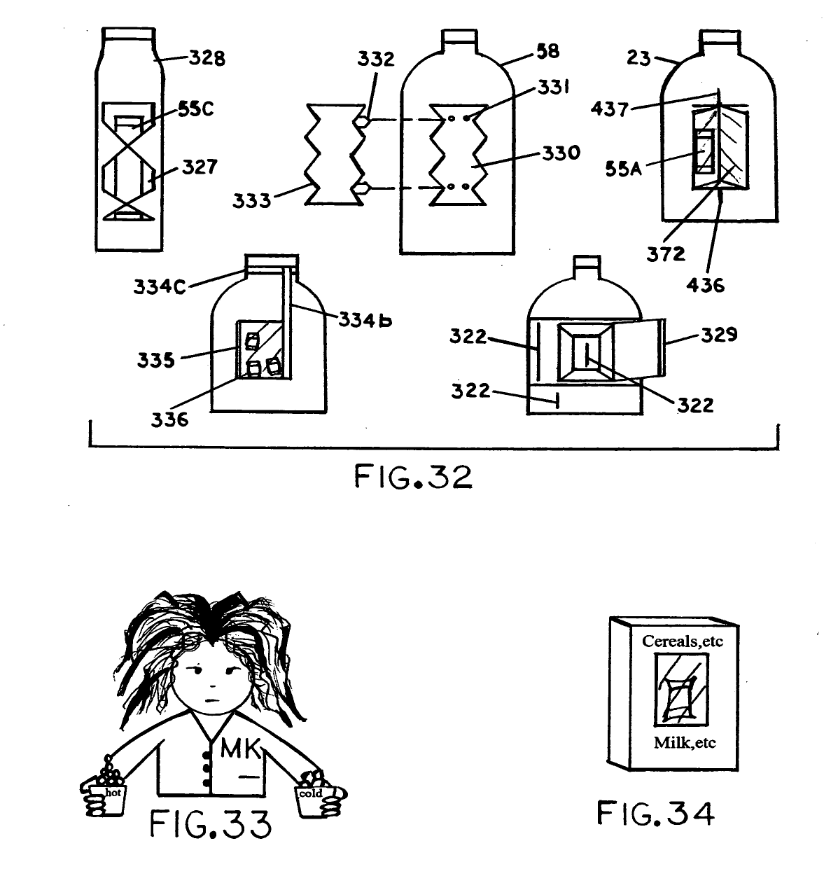

FIG. 32 shows the different kinds of containers with different uses PD, etc.

FIG. 33 shows the different touch tech's show held by model 121610.

FIG. 34 show the box container with display PD, etc, and can be any container content in, etc said container in, etc said PD.

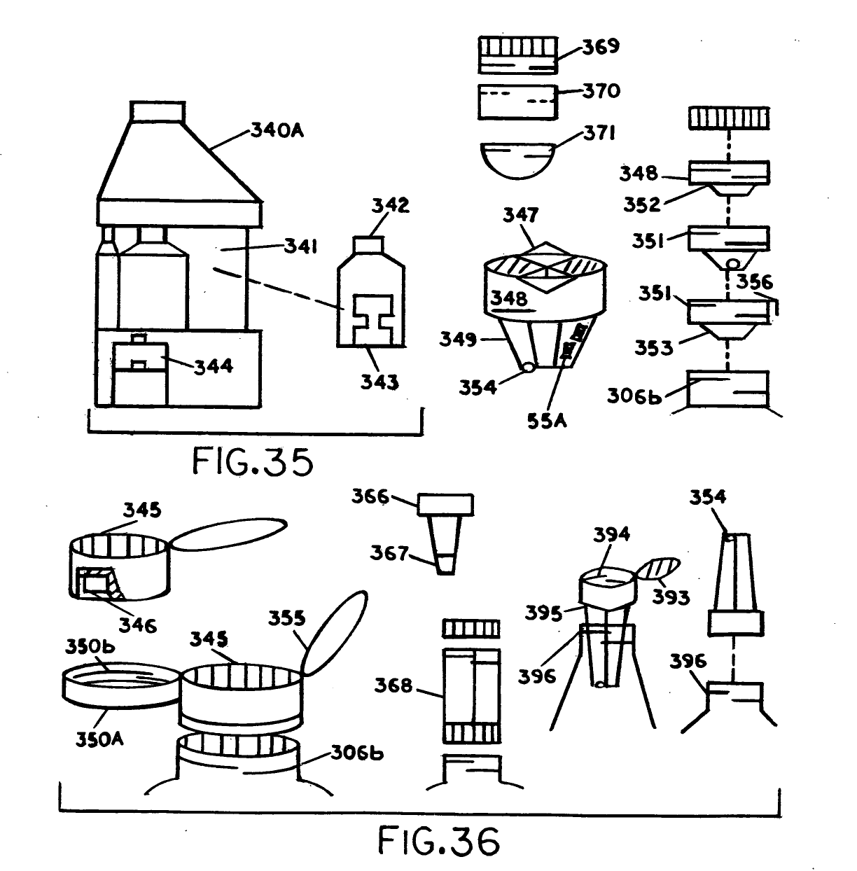

FIG. 35 shows MULTI-PD'S container with MULTI-PRODUCT'S and product, etc (main container, etc can also be stack-able, etc) shows with Pd and with products, and fig shown also stack-able, etc product container (the smaller container, etc), etc with PD.

FIG. 36 shows the different types of cap top that can be use together, etc or use apart.

FIG. 37 shows the already made store, etc product connect to container PD the same, etc shape, etc.

FIG. 38 shows family, etc sizes containers, etc with PD'S, etc and shows the family, etc container with stack-able cups, etc.

FIG. 39 shows the BNF MULTI-PD'S containers, etc in different kinds.

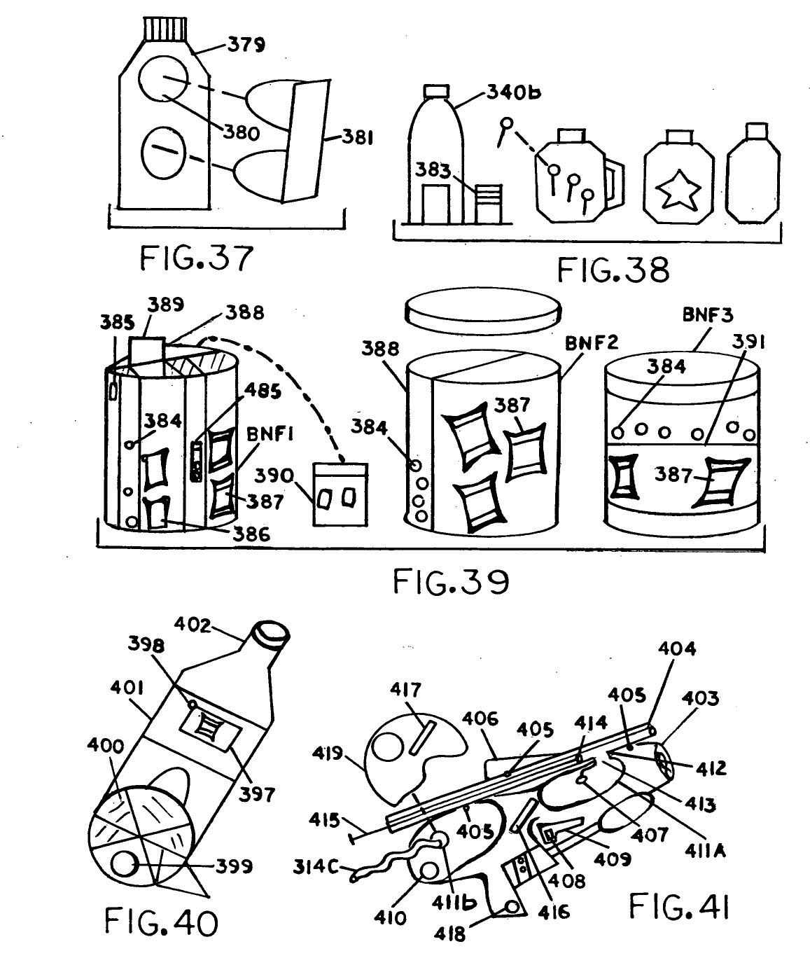

FIG. 40 shows the under MULTI-PD'S container made under the container, etc and shown with the zip, etc lock wrapper, etc, and product in its PD.

FIG. 41 shows the design water gun product, etc.

FIG. 42 shows different kinds of moving trays.

FIG. 43 shows containers and products connecting to containers and products without the need for PD.

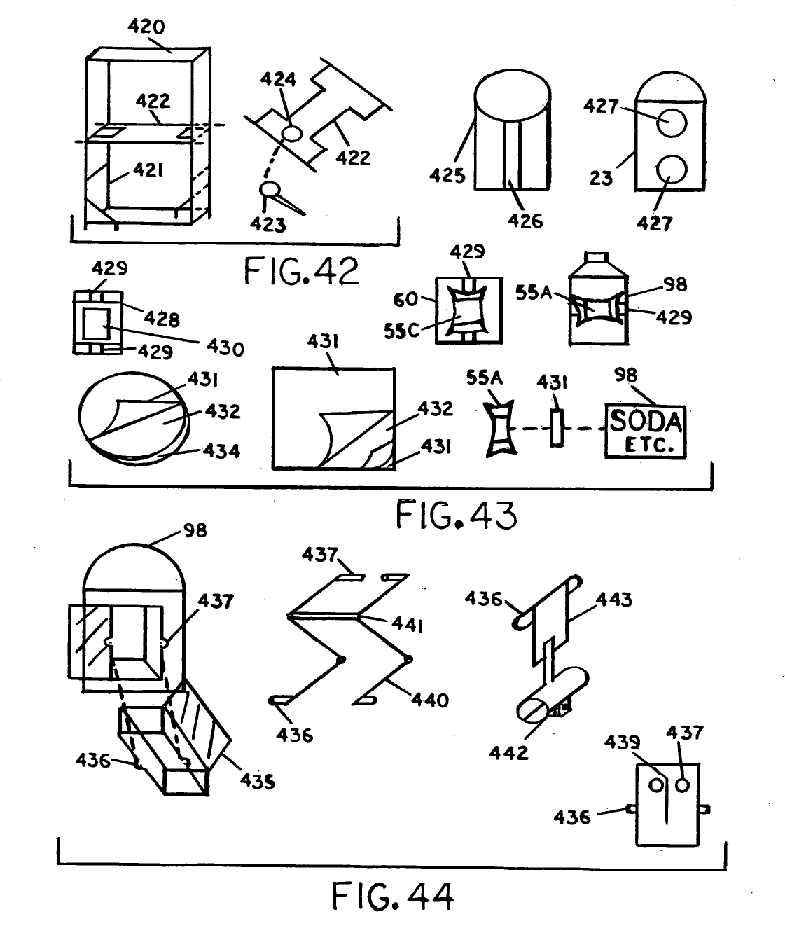

FIG. 44 shows container with one of many kinds that can be of removable PD and shown with adjustable PD, etc.

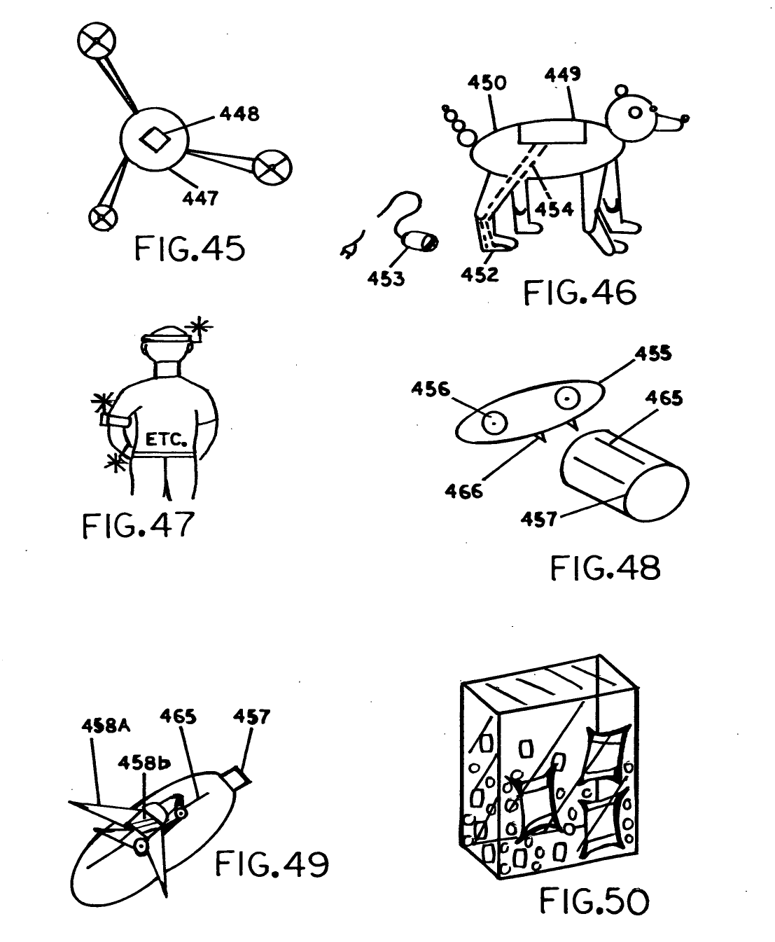

FIG. 45 shows the drone product with, etc pocket department for product, etc.

FIG. 46 shows the robot product with, etc pocket department for product, etc.

FIG. 47 shows wearable pocket departments, etc and product, etc.

FIG. 48 shows the container with flying PD, etc (other of the present invention will fly, etc also some not seen, etc).

FIG. 49 shows the container with roll-able PD.

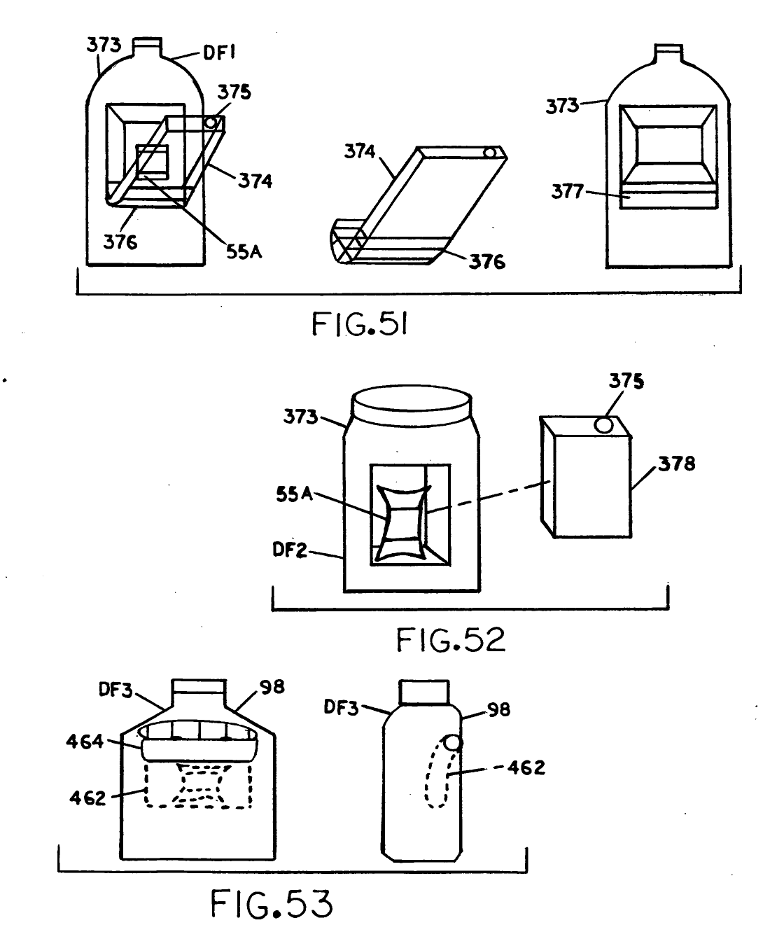

FIG. 50 shows the clear, etc alternative container without PD, etc but same, etc content in, etc main (alternative) container and in, etc product package, etc without, etc said main container having (but can have) PD.

FIG. 51 (DF1) shows the (defender 1,2,3, etc) chamber PD'S, etc display and surrounding product, etc 100%, etc.

FIG. 52 shows (DF2) with the chamber container surrounding product, etc 100%.

FIG. 53 shows (DF3) with angle PD, etc with insulting door, etc (made with also insulting materials known in the arts, etc); which also shows how also the container, etc PD, etc made all designs, etc.

### DESCRIPTION

### Preferred Embodiments

Which are illustrated in figures which are FIG. 1 and FIG. 2 (sport bottle or bike bottle containers), FIG. 3(the thermal container), FIG. 4(the cooler bottle container), FIG. 5(the cooler container), FIG. 6 is alternative embodiment pocket department, etc, FIG. 7(the coffee cup mug container), FIG. 8 (the cup container), FIG. 9(the wine bottle container or wine container; note of importance this is a closely fitted description that also is on the land of the present invention in the container, etc; is the wine in the container and chocolate, etc; cigar, etc in the pd, etc aging, etc together, etc and, pair together, etc combine health benefit, etc and also note that if you go to the store and ask for wine they would point you or lead you to the wine alleys, etc and not the beer alleys, etc; note if you are inventing something important to you, will mention it, so prior art text, had to be important to them; this is another reason for the present invention mention pairing wine, etc and its benefits, etc.). Note all name, etc products, etc and PD'S, etc are also define as just PD with and without reference numerals; and all name, etc product's are also define as just product with and with out reference numerals, etc. Note a tip for reader of PI with the PI parentheses, etc and when etc is said read said PI without viewing or reading parentheses and etc, it was necessary to use parentheses and etc to show the utility and novelty and UN-obviousness of said PI, but another tip also use your find menu in PI, but also note to fully under PI you must read and understand it all.

FIG. 10(the carton container), FIG. 11(the beverage bottle container), FIGS. 12 and 13(the beverage can container), FIGS. 14 and 15(the medicine bottle or product bottle container), FIG. 16(the bag container for food and beverages), FIG. 17,18,19,20 (the oval containers), FIG. 21,22 (the I representation products, etc and containers, etc), and FIG. 23(the cap top lid container pocket department). Note help hint for when view the present invention a suggestion that the reader use the find menu to fine the text you wish to view. More fig's from 24 to 51 will be also illustrated in description; and preferred is the housing, casing, the body, etc of products, etc which also define as container, etc, and also preferred is the new uses, etc and the new process, etc that will be said all preferred because of many reasons which will be said and seen through out the present invention text and drawing's, etc;

and the present invention we use all packing and beverage and food and product materials when suitable to make the present invention containers, etc and pocket department, etc. the present invention also preferred MULTI-PRODUCT'S, etc and MULTI-POCKET DEPARTMENT (PD), etc and product and pd, etc (and note the present invention do not have to use it product, etc it have the option to use them, etc or not; and note that all of the present invention product, etc can be made miniaturize, etc or not; and note if product, etc or pd, etc do not have a reference #, etc it should be seen also as (not shown, etc) or shown as I represent container, etc and its drawings, etc).

Note to the reader, etc this present invention (PI) have a new process of backward and forward PD'S, etc and products, etc this PI is also founded and base on this, which is also a closely fitted description, etc and this PI continuous reinvent, etc within it's self, follow the PI teaching through-out the PI, etc. Note all the PI containers, etc can also come with container products, etc or have, etc (or not) contents, etc and its pd, etc having or not contents, etc. Note to the reader that the best, etc way to made the present invention is also by computer machining, etc because the present invention uses, etc all design, etc; and note falling on the present invention land is the PD, etc and product, etc and all of the present invention parts and all of the closely fitted description and all ways and all materials of new uses and all news uses container and pd and pd, etc; and, note that all the present invention products, etc can also be phantom products, etc and be suggestion for the customer, etc use, etc and the company, etc uses, etc to help keep cost, etc down, etc; so therefore the present invention pd, etc is meant for, etc also products, etc that is not associate, with the present invention, etc.

Noticeable importance text product, etc and pocket department (pi), etc filled with content or not, etc said pd, etc or product, etc can stack, etc within it self or within each-other none stop or not in, etc pd, etc, which also means pd, etc product, etc can be 100% surround to also use the touch tech, etc see fig. Df2. A importance closely fitted description pd, etc and product, etc can be and will also be in, etc and made on, etc container, etc and all over said container, etc and product, etc and can also be made and all (angle pd, etc shows also advantages; quick ex a angle pd with hand held TV product angle in its container allow you to see it better, its many more advantages could be said) angles, etc and inside of said container, etc and on, etc the inside of said container, etc so therefore pd, etc and product, etc can also display, etc pd, etc and product, etc also in all angles, etc (not all angles are shown in drawings). note you the reader must plug in etc products, etc into, etc PD'S, etc; you will notice that some of them will stand out as beautiful like the fiber optics product display, etc in the cooler container, etc or in the sport container, etc. Note the PI will also be made (not shown) to curl, etc inward inside, etc the container, etc so the container itself, etc with PD, etc can stack within each other, etc.

The preferred embodiment in FIGS. 1 and 2 the sport bottle container 23 (this container can be call the water bottle container also, etc.), because of also the aluminum or stainless steel, (note all suitable materials also can be use for all of the present invention products, etc and use all non-toxic beverage, etc and food, etc materials know in the arts to make said container, etc) etc,

pocket department (PD) which can (or not) use the touch tech; note materials could be the same materials as container, etc materials, etc if plastic, etc said PD can also just be plastic, etc, always remember the present invention (PI) materials, etc can be change, etc (buyer rights given companies, etc the rights, etc also to pick, etc chose, etc from cheap materials, etc to high cost materials, etc and much more on buyers rights will be given, this PI allows major buyers rights, more will be said through-out the PI). The touch tech. is define as using heat or cold from container content, etc. to heat or cool, etc, PD content, etc., therefore the PI touch tech. Also harvest the container content of heat or cold, etc., to heat or cool product, etc. (product, could be a doughnut, etc in, etc PD, etc, heated by container content, etc., or in the case of this said container 23, product can be a candy bar, etc in, etc PD, etc, cool by container content, etc.).

Furthermore, said aluminum, etc., conducts also cold or heat, etc. with container contents, etc, of ice or cold or hot liquid or contents, etc., to cool or heat or to keep fresh food product, etc., in PD, etc. (PD etc., said because the touch tech works with and without pd; a touch tech example you can do yourself, by holding a glass of ice cold water in one hand and a really hot glass of water in your other hand, this is the touch tech, more example said later in this patent text, when said hot glass shows that the touch tech. works even without said aluminum, etc.). the present invention is highly into uses the touch tech and like to use said tech on any objects, etc also like none edible product like on cell phones, etc on games, etc even use said tech on human, etc skin, etc the touch tech just makes things feel better to the present invention, etc and the present invention is use to cool down etc hot, etc electric, etc (the present invention make itself clear what its product are and its use are unlike other patents),

when said games, etc the present invention allows away to play your game, etc and have a drink, etc at the same time, etc by combining the game, etc and food, etc. Pd also carry and stores said products and pd are made all sizes, shapes, structures, and dimensions and place anywhere on container, in container, and for container, because of the touch tech, (pd door, etc also holds, etc product, etc against, etc container to use TT better etc). pd is removable. Further, pd use the touch tech. (the touch tech. is also define as T. Tech. Which also define as TT).

The present invention (PI) pocket department (PD), etc will be made all sizes, etc shapes, etc and thickness, etc and thinness, etc and some time made to prevent the touch tech but it, thickness, etc by a, etc PD, etc within a, etc PD, etc or by its materials, etc but always remember also that the PI will use display PD, etc and benefits, etc and newness, etc as you will see and read, etc.

FIG. 1 shows 23 the sport bottle container preferred because of the one unit aluminum or stainless steel, etc. pd, which is not parts, this pd have more then, one reference number to show the areas of pd, because of the grooves which will be said later. The right side of pd 24a which is aluminum, etc made or aluminum, etc pd place in container (container can be all plastic, etc. and use the t tech. or plastic with aluminum pd, etc. and use the t tech.). The top part of pd 24b, the bottom part of pd 24c, the left side of pd 24d, the center of pd 24e, which is the whole aluminum, etc. pocket department. When said aluminum, etc. also means pd will be made out of ice replacement material, etc. FIG. 1 also shows the sliding tray 26a with hidden pin like edges 26b to slide in grooves, etc is the front right groove 25f for said pin right front edge, the back right groove 25g is for back right pin edge, the front left groove 25h is for the front left pin edge, the back left groove 25i is for the back left pin edge. FIG. 2 shows in-bedded, etc aluminum 35, etc in pocket department door 34a, is the pull top 31 is to drink from the container, and fig shows the cover spill proof dome 32,

the value cover 34b with hole in it, which turn open, etc. to hole in door 34c to let out air, etc. from pd. The PI can also come with and with out Product already load, etc in, etc it PD, etc like candy bars, etc TV, etc watch, etc tools, etc lights tech, etc reflectors, etc which can also stick to the bike, etc because of the magnetic product, etc, and can come with already product like radio device, etc, laser device, etc bikes kits, etc tire kits, etc fix kits, etc towels, etc maps, etc and electrical product, etc and maps, etc organizers, etc fans and power fans, etc, computers, etc combs, etc power bars, etc any products, etc and note other patents do not mention already load product like the PI music device, etc (remember this PI can make it products permanent or removable, etc), and the PI product can all have PD, etc and products, etc themselves and be wear-able and float-able, etc or not, etc the will teach this more, etc; fig also shows inter parts which could be form of same made as container materials, etc or said inter parts aluminum/stainless steel, etc 27 and 28 which can be form in, etc said container, etc of any materials suitably, etc chosen by buyer, which said aluminum, etc 27 and 28, etc (which is really one part # is just to show areas) shows advantages even when container contents, etc with ice, etc is low transfers cool, etc (or heat when contents is hot, etc) to PD and it contents, etc; but note the whole can can be also form from stainless steel, etc.

FIG. 3 shows thermal container 36 preferred because of the said pocket department 24a to 24e, etc, and fig shows the flip up top 41 to drink form container, the slide out plate door 38 (which is also use as alternative pd door see alternative for more information), and fig shows the phantom doughnut 40, etc which will represent any food, etc., further this product can be sold with this container in coffee shops etc. FIG. 4 shows cooler bottle container 42 preferred also, because of the said pocket department 24a to 24e. FIG. 5 shows the cooler container 43 preferred also, because of the pd which is not made of aluminum, etc. but this pd can be made with said aluminum, etc. (I chose to change this container, etc. reference numbers to show how this patent container will use any material. Fig shows the right side of pocket department 50a made out of the same material as container material which could be also bio-plastic, etc; and the bottom of this pd 50b, and the left side of this pd 50c, and fig shows the center of this pd 50d, and shows the top of this said pd 50e, and fig shows pocket department clear door 50f, which 50a to 50f is the pocket department made out the same material, etc as the container material, etc. FIG. 6 is alternative pocket department, etc. see alternative section. FIG. 7 shows coffee cup or mug container 51 with said PD 50a to 50e. FIG. 8 shows cup container 52 (also reference number change to show different in material) with said PD 24a to 24e.

FIG. 9 shows wine bottle container 53 (this said 53 bottle can also use the t. tech for said product) with real wine 67 content shown in bottle container also with PD 50a to 50f, and product/food product 55a (product 55a paired for or with wine container contents also etc. can be product chocolate in PD etc. pair with wine etc.; or said wine pair with product cheese etc; or with product cigar, etc.). Furthermore, this wine bottle container etc. can and will also have a aluminum, etc. pd by placing a fully made stainless steel, etc. PD in the glass, etc. pd, etc. also these said pairing of wine and dark chocolates etc. provides health benefits, etc. (not prove by PI but by others look it up; this patent do not make health claims), so therefore PD, etc also can pair health benefit together, etc; and fig shows wine top cork 56. When said product paired for or with also mean product come with and without product so you can chose your own product (a quick ex. You buy a wine container with contents inside of it with a empty PD, so you can buy your own product which may be crackers and cheese, etc. or this wine bottle container can come with a product chocolate, etc.). When you hear the words, “or not”, etc and words like it these said words are also said to give companies, etc of the present invention the rights, to keep cost down, etc; and some product, etc may not have a product, etc itself and product may be a product, etc which is not for more then one, etc person, etc use, etc.

FIG. 10 shows carton container 57 with beverage 78 content, etc (which can be content of milk, wine, juice, candy, chips, any product, etc.) in container also preferred because of the PD 50a to 50e made out of the same material, etc as container material, etc (which in this case container pd can be made out of carton material etc. and said container PD also can or not made with a, etc layer foil etc. because of the said aluminum, etc text). This container PD shows said 55a, for said PD 57 this product can be cookies, cake, doughnut etc. FIG. 11 shows bottle container 58 with drink, etc content 59 (which could be content of soda, juice, beverages; diet beverages, etc and diet health food, etc and diet video, etc and/or not, etc diet literature, etc pair together as same contents, etc; water, beer, alcoholic beverages and alcoholic mix; s to make different drinks, etc, even food, etc.) in, etc container, etc and in PD, etc. FIG. 11 also shows PD 50a to 50f with (this container PD etc. and all said containers in said texts come with and without said product, etc. for said reasons). FIG. 11 also shows said food product, 55a etc. which in this case can be and will be in, etc said bottle 58 PD candy, candy bars, energy bar, protein bar, energy power food to use with drinks and alcoholic drinks (benefit providing food to slow down alcoholic in the body, etc; and providing candy bars, etc with your soda, etc to provide away to help your thirst and hunger, etc. at the same time, this container PD also come empty or not to provide a place for your own product candy bar, etc. see product arguments, etc.).

Every product, etc and every PD, etc and every container, etc and every parts, etc in the present invention can be multiply into many, or not, because company, etc may not wish to invest so much in there product line, etc; and product, etc can be sold without the product or sold with it (this is also the another reason for the with and without statement, etc); or sold next, etc to the container or not, (because product are sold around the store, etc) or the container, etc or PD, etc or product, etc can be sold on-line because some products, etc cost more, etc and some products, etc can be made special for you or you can buy them later, etc; and many other reason like customer choice you do not see thew product you want at the store, etc then just buy the container, etc the container, etc can come with on-line information, etc to buy the product you didn't see in the store, etc.

FIG. 12 shows can container 60 with drink 59, etc content; with same text said for FIG. 11, but can have also 24a to 24e PD (note that all containers said in this patent text uses each other pocket department, etc.). FIG. 13 shows clear can 79 (see through bio-plastic, etc., but the PD can be or not aluminum, etc., this can look like can container 60, but because this can container look different it have a different reference number, further more this can container come about because of firsthand account, the PI have seen aluminum cans, etc. not being recycle in our environment, the owner of the PI know this because said owner was apart of pick them (can containers) up and got inside of large metal trash bin in order to pay for this PI; so this is how these bio-containers was born by said PI because PI know that metal cans are being throw away and pawl up in our environment but these said bio-cans, etc. with PD and bio-wrappers, etc. for product that uses said wrappers (because some pd provide a place for said product it no need for said wrapper, etc) by combine the use of drinks and food products, etc. with the bio-container with bio-pocket departments, which will lead to total breakdown in our environment equal to almost or no trash in the environment when you use bio-can with bio-PD (bio-PD also define as bio-wrappers, etc), furthermore clear can 79 use 50a to 50f PD.

THE PRODUCT SECTION DESCRIPTION, etc and more argument for patent-ability; and it's necessary to show argument with product, etc to show product, etc utility, etc; UN-obviousness, etc novelty, etc. When said 55a product; and any said products, etc; besides the present invention product shows that it can be any product, etc its can be the same contents, etc as the container contents, etc. A note to coming up, etc product which is about to be said some of the UN-obvious product will be said because they are UN-obvious and can be the present invention (or not); when the present invention say all product, etc it's means it's by also saying some of UN-obvious product, etc and once they are design (or not) into, etc the present invention container, etc and product, etc they will appear beautiful. The present invention product section, etc may appear long, but is needed to show what the invention is all about, etc; and is also said to show how wide product, etc will or can be for the present invention; etc is also said to show how wide product, etc will or can be (if you wish read without saying etc; note, etc is not limited to just product text) and some product, etc are said in more detail then others, you will notice this for arguments reason, etc and also can show arguments, benefits, advantages, etc. and can also be products which are: all food products cook and UN-cooked, etc.

An example is given for UN-cooked food, container as breakfast drink content, etc. with this said container pd having, etc. microwave breakfast food, etc, and hotdogs, etc and burgers, etc providing another way of bring cold drink and hot food together and/or not hot food, etc and hot drinks, etc together or cold food, etc and cold drink, etc together, etc and furthermore when microwave drink, etc in the container and microwave food, etc in pd, etc said microwave also define as all microwaveable containers, etc and packages, etc and all cooking products besides microwavable products and (the present invention container, etc when suitable can use to make its container, etc out of all, etc known in the arts, etc microwavable materials, etc like, etc microwave shielding material, metallic material; etc container, etc and all materials like PET, etc,) said microwave products will be also popcorn products, breakfast, dinner, lunch, drinks, etc products; products will also be: all nuts, all fruits, all chewing gums, all food chips and potato chips, fruit bars which provides health benefits, breakfast bars, lunch bars, etc, vegetable and vegetable sticks which provides health benefits, all vitamins, all drugs, all snacks, all pretzels, pocket department and product will also be many on container like cracker, etc. in one pd and cheese, etc. in, etc another, etc PD all, etc on one container, or cheese and crackers in the same PD, etc,

when said micro-products, etc can be also place in the microwave, etc allow hot drinks, etc and food at the same time or not because the container and its PD packages, etc can be made with micro-materials, etc known in the arts, etc, but note the PI will use more then food and drinks for the said micro products, etc it will also use any product, etc like warm, etc towel, etc to wipe your face, etc; product define as all portable, etc cooling and heating appliance device, etc with and without its body, etc or box, etc or said as its shell, etc because PD can be the body etc housing, etc so therefore the present invention will also be made with all suitable materials, etc of fire proof, etc heat proof, etc and safe materials, etc;

all known in the arts, etc; and the PI will use all known in the arts materials, etc in many PI products, etc. The present invention will uses all phase changing materials suitable in a PD shell, etc and seal, etc Product in pd shows advantage and benefits (benefit also define as the t. tech) by using no extra space on racks, or shelves, or beverages machines, etc. some of these combination products which are drinks in container, etc. and foods in pd, etc., are: fruits drink in container, and soybeans product in pd, etc which also show health benefits, etc.; blackberries juice, etc. in container and blue berries, etc. in pd also a combine health benefit; beverages and snacks like peanuts, candy, mints, chips, candy bars, ice cream, dips for all said chips which as benefits because pd provide away to dip your chip and eat your chip at the same time on need for a 3^{rd} hand, smoke meats like beef, etc., toys, vitamins drinks and vitamins bars, wine etc in container and blackberries etc in pd providing combination benefits also a new scientific studies done by others not my study shows some alcohol and another study shows some color fruits can help prevent some diseases pd combine these products in one container this patent do not make health claims; wine, etc and party stuff like horns, flags, etc; wine in container and cigars, cheese, etc,

in pd providing away for these product to age together; soda in container, etc and ice cream, etc in a said removable pd to be freeze proving away to have a ice cream float in the same can etc container; beer etc and beef, nuts etc; beverages and protein bars, peanuts bars, pizza, pizza bars, breads, cinnamon and bars proving some benefit help lows blood sugar; water in container and powder nutriment flavors or red tea and tea's (benefit) in pd providing nutriment to the not enough nutriment plain water another problem pd has solve. To show how wide product can be product also define as bike tools, butter, margarine, peanut butter, jelly, or other spreadable, salt, peppers, and products, etc all said, etc can also be same content, etc in container, etc and in, etc pd, etc. Product also define as pouch, and define workers trucks holders, etc and all holders, etc, product, etc also define as deodorant, etc in the container and deodorant etc in the pd, etc; UN-obvious, etc container, etc for bike, etc holder, etc the milk container, etc having a display pd etc allowing the rider on said bike, etc to reach down while on bike and grab, etc milk, etc and cookies, etc with out screwing and UN-screwing' etc because, this, etc display, etc,

pd, etc can come without, etc a, etc door, etc and the pd, etc can come with a top product closure a new use top which kids use which prevent spill of container contents know in the arts, to prevent your milk, etc from spilling, etc, these top will be uses different for said bike container, etc now should be seen as a new use product, for said bike container, etc and for any of the present invention container.

Product also define as all microwavable products and some of these said products can be removable from its container pd to be microwavable, etc or the microwavable container, etc. pd, etc and microwavable product, etc can be (or not) microwavable together at the same time, etc (or not); so there fore the present invention container can also be made of suitable microwavable materials. Product and container, etc also define as all insulated, etc and ice replacement, etc container, etc and pd, etc. Product also define as hot tea, etc, and donuts, etc and hot chocolate drinks, etc, and breakfast sandwich, etc, in said pd, etc and or in said container, etc. Furthermore, some, etc of the present invention pd, etc will be made also hermetically like products with foodstuff; and some of the present invention containers, etc come with and without content (product) in them. To show even more product wideness, etc product also define as motor oil, etc in the container, etc and/or oil, etc, and or not oil, etc cleaning, etc wipes, etc in pd etc (or not), and/or not oil squeeze tube container, etc in pd, showing how the present invention will or can have also the same content as container contents in the same container type or different containers types, or in the same or (all sizes, all shapes, etc) smaller, etc sizes, etc containers, etc in said pd, etc, (or not).

Product also define as all 3D games products, etc, and all 3D video games products, etc and all the likes, etc and UN-likes, etc; so yes the (not shown) laser gun product, etc can have said 3D products, etc in PD, etc play with laser gun, etc and use said 3D products, etc, which could be also on screen video, etc or on a, etc video game screen device, etc in, etc PD, etc; or a, etc projection device product, etc, which show on your wall, etc; on your friend body, etc; on the robot product, etc; on etc the drone product, etc, which also can have any suitable sensors, etc to receives, etc or read, etc lasers, etc; (said sensors, etc can also be wearable, etc remember this PI teaching, etc always, etc) or said projection can also project, etc on your pet, etc; on the ground, etc video game, etc; why because your said laser gun, etc can have also a projection PD, etc for said laser gun, etc and a, etc trigger, etc with a, etc remote controller, etc or a, etc game remote, etc controller, etc, and then shoot laser, etc and play at the same time play 3D video games, etc; and more UN-obviousness is given, so yes the water gun, etc product can have a, etc camera product, etc and on its trigger, etc a, etc remote controller, benefit take pictures, etc video, etc as you play water sports, etc, this said trigger can have a, etc PD, etc yes a, etc PD for said remote, and remember PD, etc can be place any where and product, etc can be made all sizes, etc, so when place any where also means said remote can be place even next to said trigger, etc;

and remember products, can also be made permanent, etc (or not, etc) in said PD, etc this PI also allows you to use your own camera, etc and remotes, etc; remember the PI teaching, etc; so also when said trigger allows you to shoot, etc said gun, etc and film, etc at the same time or not; more will be said about trigger PD, etc and trigger products, in up coming text said later, etc; but for now remember and do all these teachings, etc place every product in every PD, etc and the PI containers, etc products, etc PD'S, etc are also design, etc made, etc also to use-each-others, etc PD, etc product, etc parts, etc materials, etc; and the PI is design, etc made, etc to be a, etc backward, etc and forward, etc with its PD, etc products, etc, which also means a, etc container, etc product, etc can have none, etc or one, etc or many, etc products, etc or PD, etc, a example out of many; so therefore a company of the PI can have one month three PD, etc on there container, etc then the next month, etc have none, etc because of budget reason, etc; and there are many more reasons, etc for the backward and forward text, etc some will be said the PI; like also friends, etc family can share form the same container, etc and not germ up each-other food, etc; and also learn that all the PI products, etc and PD, etc can be also (or not) wearable, etc float-able, etc; and learn the with and without PD, etc and products, etc; and learn the same contents, etc as container, etc contents, etc;

and learn that the PD, etc and products, etc and containers, etc will be made all shapes, etc sizes, etc designs, etc and can be place any where on said container, etc (which said trigger text just given showed), and lean that the display PD, etc and product, etc shows advantages, etc; and learn that said product, etc can also have a, etc PD, etc or even a, etc product, etc it self, etc (or not to all said, etc for company, etc and customer, etc rights, etc and reasons, etc) and learn that the container, etc can have, etc (or not) MULTI-PD'S, etc or MULTI-PRODUCTS, etc; and many more learns, etc is given through-out the PI. Furthermore said oil, etc wipes, etc packages, etc can be (or not, because the pd, etc can also be the package, etc to contain the wipes, etc) molded, etc or sealed, etc or bonded, etc, into, etc pd, etc (by machine, etc), so said wipes, etc pop out, etc without package, etc coming out when pulling out, etc said wipes, etc.

Product also define as reconstituting food, etc product, etc. and instant and already-cook foods, etc. Product also define as health products in the container and health products in pd, etc like UN salted or low salt peanut, etc in the defender pd, etc which also define as pd, etc. Product also define as wearable products, etc which means the present invention (pi) can connect to you or any thing, etc to any product, etc (more ex, connect to bikes; cars; boats; containers; shoes; outfits; etc not shown), let the present invention give you even more UN-obvious text, what this (pi) rights also does (not shown), the robot, etc product can have product cooler, etc in its chest, etc is a, etc pd, etc said cooler, etc, pd, etc can be place any where, this may have being UN-obvious to the reader, but not to the (pi); these said robot, etc will also do what robot do which is what humans want them to do like bring the a candy bar from, etc there pd, etc or a drink etc from there other, etc pd, etc, (teaching the present invention can use or not, each-other pd, etc products, etc); so there this robot product, etc can or will be in the sport container, etc pd, etc; and yes this means the robot, etc pd can have peanut butter container, etc in its pd, etc, yes this is true, they use each-other, etc product, etc.

Furthermore when said wearable product shows more UN-obvious text, etc example a car, etc mechanic, etc have oil on his hand said mechanic home or shop kitchen soap container is for dish, etc but this mechanic has a wearable soap dispenser, etc to wash his hand, but remember another problem is about to be solve remember the present invention product can have a, etc product within a, etc product, so this said wearable product soap dispenser, etc in this case have a water dispenser, etc in said soap dispenser, etc or a reusable water, etc container, etc to wash said mechanic, etc hands, etc and to take this even further the said water, etc container, etc can have a towel, pd, etc; this just said text also shows why more then one pd, etc product, etc is usefully, etc. Product also define as all appliance; yes this mean that the robot, etc product can have appliance products, etc in its pd, etc.

When said drones, etc also means all products, etc associate to use, etc with drones product, etc like cameras, etc video devices, etc, sounds device, etc receivers, etc (or not); when using the drone, etc and all robotic, etc products, etc is to be use the way they are already use, etc and to use them to sever you a example, if a drone etc have a, etc PD, etc, with a food product, etc, use said food product for yourself, etc to eat, etc or use drone, etc PD, etc to take food, etc or drink, etc to someone trap in a cave, etc many more PI unlimited usefully can be also said, note when a, etc drone, etc robotic, etc have etc a pd, etc, (teaching) once again you must in the PI plug, etc all products, etc into, etc said drone, etc and robotic, etc PD, etc, for many more uses, etc can be seen, etc like the fact that this drone product, etc, pd, etc can also (or not) come with a computer product, etc; or; display TV screen, or a build in radio, etc because some product are not removable, etc, so yes, if you do what PI told you to do, place every product, etc in, etc every pd, etc you should have already known this text I am about to say; yes the drone product (not shown) can have, etc a, etc robot, etc product, etc in, etc it, etc pd, etc and (still teaching) yes a pd, etc can even be in said robot eye (define as pd, etc and be place anywhere on said container, etc and can be even hidden) ears, etc back, etc anywhere; this said eye, etc PD can, etc hold your diamonds ring, etc.

Note the dictionary robot, is define as automatic man like device; and the word toy is define as things to play with; and games is define as amusement or sports with competing players, etc the present is showing this point to the reader, etc to show difference, etc. Product also can have a, etc container, etc within, a container, etc, a ex, (not shown) the sport bottle container, etc pd can have in the same, etc shape, etc of a soda, etc can container to hold, etc in, etc said sport bottle pd, etc. Products, etc can also be interchangeable, etc (or not) a example a, etc radio product in a, etc cooler, etc container, etc in PD one and the next day, etc have a, etc lunch box product, etc and so no and so no, etc, did the present invention made it self clear, and the present invention will or can others invention products, etc also; which the present invention allows away to do business with other inventors, etc and the present invent display products, etc to gain, etc buyers or users, etc or give notice to said buyer that it is different and they should buy it, etc, and the present invention can infuse product into said container, etc. Product also define as tools for your yard and tools for your kids, etc, to play with and defines all ovens (compact, etc), all stoves, microwaves, freezers, etc cooking devices, etc and all thermoelectric devices, etc and define as all arm straps and handles food, etc and shoulder straps, etc;

and drink, etc containers, etc, and when said product can stay in PD (not removable or removable, etc) the body of the casing or the surrounding of the product, etc can be left out the and the PD will take its place, etc of said body, etc; and product define as canteens, etc; and all recreational, etc car, etc vehicles, etc containers, etc and product defines as refrigerator products and heating unit products, etc (connect to PD or removable, etc) product merging with the present invention once product is merge with said invention (merge is define as combine so as to lose identity; define in the real dictionary), PD, etc its use, etc is now different, and said product, etc can merge, etc with all its products, etc; and product also define as thermal packages, etc and product define as toasters, etc; and product define as all PELTIER effect products, etc such as thermoelectric device, etc; and define as all self refrigerator devices, etc also known in the arts, etc, and contents define as product, etc and the present invention can have a none food product with a food, etc product, etc or drink products, etc.

SAME CONTENTS, etc; Some more same pd contents as container contents; product (a closely fitted description and all of the PI should be seen as closely fit description, etc) also define as sugar, etc in the container, etc and sugar, etc in, etc in the pd, etc in, etc tear package, etc in containers, etc.; disk-washing liquid, etc in the container, etc and antibacterial, etc in pd, etc benefit pd, etc allows away to take to your office, etc school, etc a package, etc of dish, etc soap, etc; or antibacterial, etc soap, etc, so therefore its away to not take the whole main, etc container, etc. Product also define alcoholic testers products, etc with, etc alcoholic, etc in container, etc, or hangover cures, etc in pd (or not). Product also define as all, etc, dips, etc condiments, etc in, etc container, etc and all, etc condiments, etc in, etc pd, etc in, etc tear packages, etc in, etc pd, etc of any type, etc and any suitable type etc container etc in, etc pd, condiments like and unlike: pepper's, mustard's, ketchup's, salt's, food oils, etc and already-measure cooking, etc oils, packages, and with and without cooking flower, etc in pd; (benefit said oil pd can have also a empty bio-recycle container, etc to recycle leftover old oil to be recyclable, etc) etc all products; giving buyers, etc away to take there flavor mustard, etc to work, etc without, etc taking the whole container, etc note they can take whole container if buyer, etc wish customer, etc choice patent. (also note contents can be the same or not in this invention).

Spray bottle, etc Stain, etc removable content in the container, etc and squeeze, etc package, etc in PD, etc for, etc stain removable, etc on your outfit, etc on the go, etc; some more same content, etc mustard, etc in the container, etc and mustard, etc in the PD, etc use on your sandwich, etc at home, etc or on the go, etc or take with you to use later, at work, etc our use at your flavor fast food because your on the go and your said flavor fast food place do not have your brand of mustard, etc which happen to be the best in the world, etc and said food place do not carry said best mustard, etc, so use your tear packages, etc squeeze packages, etc any where, etc; note etc in this case can also be tiny, etc which look like the main bigger container, etc (but said PD product, etc is not limit to small, etc) and remember a, etc PD, etc can be place anywhere on said container, etc even on spray top closures, etc; and the PI PD, etc works also with containers, etc and products, etc which have enter moving parts, etc moving parts, etc by being place on the container, etc tops, etc on the product, etc outside, etc, by being place in the container but not the way of the container, etc product, etc moving, etc parts, etc

More same contents, etc product also define as already made (filled) tea, etc in the container, etc and tea, etc and tea packages of all kind, etc, or tea container cups, etc in pd, etc or not, etc; to be use separate, etc (or not) from, etc the container, etc contents, etc or to (or not) add more flavor to the already made tea, etc (not, etc water, etc in the main, etc container, etc); furthermore the bigger, etc main already filled tea, etc container Pd's, etc can (or not) also have, etc already filled, etc (or not) tea, etc containers, etc; and when said tea packages, etc you can (the reader) use your own home, etc cup, etc and place your own sink, etc water in it to made tea, etc or not its your choice. Product also define as rubbing, etc alcohol, etc in the container, etc and cotton balls, etc in the pd, etc remember same content can also be contents, etc that relates, to each-other, etc. Same contents will also be dry, etc detergent, etc in, etc container, etc or wet detergent, etc in pd, etc; (once again etc could also be any of the present invention, etc product, etc); product milk in the container, etc and chocolate, etc milk, etc in, etc the pd, etc or syrup, etc in pd, etc; benefit allows the milk company, etc to stay (or not) in its own field, etc or not. Product also define as milk substitute, etc foamed milk etc and define as dry milk, etc powder milk, etc; and product define as cereal, etc;

in the container and cereal bar, etc in pd. A closely fitted statement same content, etc as container and pd content, etc can also, etc prevent double dipping, etc from a germ mouth licking, etc a dirt spoon, etc then place it back in the main, etc bigger, etc container, etc and the pd, etc by having tear package, etc in pd stop double dipping, etc even at home, etc some more advantages, etc a family can not afford, etc a container of jelly, etc and a container of peanut butter and one kid, etc can not eat peanuts, etc but with this invention no problem both, etc in, etc the same container, etc apart, etc. Product also define more UN obvious product, etc milk, etc in the container and hot pepper, etc horseradish, etc, in pd, etc. Product also define as tooth paste, etc in the container, etc and tooth paste, etc and tooth brush, etc tooth picks, etc and tooth floss, etc in pd; or not, etc. More example of same content or related to content to container and pd content, etc, macaroni, etc and cheese, etc in the container, etc and macaroni, etc allowing away to take your meal to work, etc to school, etc. Note please in-order and to list all the same content, etc you must walk down the alleys, etc of your super market, etc and product store, etc to see, product, etc like drugs, etc food, etc, drink, etc cleaning product, etc animals product, etc plant product, etc. cheese, etc in pd benefit.

Product also define as kids, etc baby, etc drinks, etc food, etc in container, etc and in PD, food, etc drinks, etc toys, etc. Product define as mouth wash in the container and mouth wash, etc or mints, etc or gum, etc in pd, etc in squeeze, etc or tear package, etc in pd and pd also define (c) tooth brush casing or body, etc with pd, etc; and define as tooth pastes pump container, etc. Product also define as fruits, etc and vegetables, etc which can be in air tight, etc bag, etc and vacuum, etc and pressurized, etc container, etc. Product also define as white rice, etc in the container etc and brown rice etc in, etc pd etc. Product also define as powered milk, etc in the pd and milk, etc in the container, etc. Coffee, etc in the container and coffee packages, etc in pd, etc or/or not creamers, etc in pd, etc. Product also define as diaper, etc in the container, etc and wipes, etc in the pd, this pd, etc can be place on the out, etc side, etc also of the container, etc so said diaper, etc stack without a problem the outside pd do not interfere with the inside contents, etc or moving parts, etc or part, etc; all of the (pi) can have this outside, etc pd define as pd; and this said diaper, etc product how the same content as container contents can be, relate to content also which mean it can be use with that product like diapers, etc and wipes, etc.

Product also define as all cast irons products, etc. Some more same content text chip, etc in, etc the main bigger container, etc and chip, etc in pd, etc allowing away to take a small, etc bag of chip, etc to work, etc and leave, the bigger main container bag, etc at home, etc. Product also define as dry laundry detergent etc in the container, etc and wet, etc laundry detergent, etc in pd, etc (or, /or not) laundry sheet, etc in pd, etc (this text is not for reconstitution of cleaners product or said as add water to solution to re make it). and product define as ice cream, etc in the container and ice cream bars etc in the pd, or pies, etc, cakes, etc in pd, etc.

Product can also be spray bottle, etc in the main container, etc and smaller, etc spray bottle, etc in pd, etc or aerosol container, etc in the smaller bottle, etc allowing on the go stain remover, etc; or allowing odors eliminate, etc, and so on and so on. Product also define as all food, etc oils, etc in the container, etc and cheese, etc dry breads, etc dry meats, pickles, etc in pd, etc or not; all products can come or not in pd, etc. Alcohol, etc in the container and rice, etc in pd, etc. Product also define as bionics products, etc and define as all robots, etc drones, etc container, etc products, etc and product define as all combine (combination) and none combine products, etc and combine heating and cooling, etc devices, etc products, etc containers, etc; and product define as all radio controlled products, etc and devices, etc and all which function like it and unlike it, etc and said radio controlled products, etc can be the ones with also infrared, etc and product define as weight loss, etc products, etc and information products on it, etc and videos, etc DVD, etc downloads, etc on weights loss, etc or any inform, etc. Product also define as store, etc display coolers, etc with display PD, etc and said PD, etc can hold, etc chips, etc candy, etc radio, etc TV, etc computer, etc recording device products, etc sensors products, etc of all kinds, etc, and remember the PI PD, etc and product, etc together or apart can be angle, etc in, etc said PD, etc said product or product can be connect, etc to said container, etc without, etc said PD, etc or mold, etc or adhesive, etc or weld, etc (known in the arts, etc said welds, etc) or made into, said PD, etc or container, etc by ways said through-out the PI and said PD, etc can even be place on said display cooler lid, etc. Note the PI once again is for humans, etc plants, etc animals, etc pets, etc bugs, etc, always remember PI teachings, etc. Product also define as all bicycles, etc coolers, etc backpacks, etc and said PI bike backpack, etc and bike cooler, etc, UN-obvious also can hold, etc the water gun, etc product, etc, remember teachings, etc learn that you the reader must place every product in, etc every products, etc containers, etc. Product define as all movies, etc music, etc downloads, etc, websites, etc on, etc driving, etc and drinking, etc and texting, etc and driving, etc, and further movies, etc on any subject matters, etc like on, etc fun, etc jokes, etc healing, etc health, etc peaceful sounds, etc pictures, etc video, etc all types, etc (for music, etc videos, etc websites, etc downloads, etc).

More product define on robot, etc product, etc which said robot can also have, etc (or not, etc) a, etc cooler, etc or toy chest, etc PD, etc or its PD, etc can be the cooler, etc or toy chest, etc; and yes this means the toy gun, etc can have a, etc toy chest, etc PD, etc learn PI, to help you learn PI even more the robot, etc dog, etc PD, etc can hold, etc solar products, etc which can charges, etc in, etc its, etc PD, etc learn PI, etc and remember PI teachings, etc through-out the whole PI texts, etc. Product also define as thermos containers, etc. Product also define as all RFID products, etc; and product define as all edibles, etc bowls, etc which can also have or not said plugs, etc molds, etc to them to also, etc connect (or not) to said PI containers, etc for humans, etc pets, etc. The present invention can use each other pd, each other products etc use each other container's etc the wine contents, etc in a box (cardboard container, etc) container, etc and the its pd can have cheese, timers, holiday products gift, cigar, radio, TV, devices, etc. Product can also be tissue, etc in the container, etc and cough medicine, etc in pd. Product also define as peanut butter, etc in, etc the container, etc and peanut butter, etc in, etc pd, etc, benefit allow away to not have to eat from a double dip container, etc, because the tear, etc package, etc can be (or not) for present use, etc; and prevent double dip, etc of two or more product which you do not what to mix, etc ex peanut and jelly some people like them together but some people can not eat both;

so product also define as jelly in the container and peanuts, etc in pd allowing benefits for those do not like peanut butter, etc or who can not eat it, but only, etc the jelly tear, etc package, etc in pd, etc. Product define as oatmeal, etc in the container, etc and oatmeal, etc in pd, etc, benefit take a health meal, etc to work, etc, to school, etc. (teaching, etc when said etc can also mean pd, etc can pop off, etc of said container to become a plate, etc a bowl, etc or a container to cook in, etc or to eat from, etc a ex this said pd, etc can be place on the stove, etc and cook with or place in the microwave or use as a dish or use as a cup, etc and so and so, etc. Product also define as coupons, etc book, etc. Product define also as baby/kids containers, etc which can have a, etc radio, etc PD, etc or a, etc toy PD, etc or a, etc monitor, etc PD, etc all in one, etc or not; PI line can be one product or none stop product line, etc container, etc products, etc; and not infringe because PI, PD, etc or product, etc can be removable, etc and said product can have a, etc products, etc or said product can have a, etc wearable, etc or not PD, etc, or a, etc product, etc inside its, PD, etc are you following and learning PI,

its not easy, this PI do not infringe because of this way of the PI, etc; and if the PI was not done this way, this PI would have unlimited drawing, etc and texts, etc, to teach more about this I would have to drawn one drawn with a, etc PD, etc then that same drawn again with another different PD, etc and so no and so on; to show each product, etc in each, etc container, etc or many or in many PD'S, etc; and once again the PI will not infringe because its PD, etc products, etc can have PD, etc products, etc in, etc them also, etc or not. Remember anybody can sell a normal, etc product or normal, etc container, this is another reason for PI product, etc come with and without PD, etc, etc because said PI can also sell products without PD, etc and products, etc which can also be place in its PD. Product also define as all product holders, etc like, etc for also cups, etc candy, etc drinks, etc any products, etc, which said holders, etc can (or not) also connect, etc (not shown) to PD, etc or in, etc PD, etc or to products, etc this prevent product, etc from (be can be made to move, etc) moving, etc like said PI trays, etc do, prevent also moving of product in, etc PD, etc, which is advantages to keep product, etc from being damage, etc, this another reason (go see and find another reasons, etc) for some products, etc can be sealed into, etc PD, etc or made in its, etc PD not removable, etc. (but also made removable, etc); when said given companies, etc the rights, etc to design, etc this PI allows this sealing, etc in product, etc or not, etc.

Product define as all wear product, etc and pd, etc you wear on your self or products, etc like and unlike rings, etc clip on, etc and wear on your neck, etc, and which connect to other products, etc; and also known in the arts, etc (note the products just said or not the present invention products, but will use them in this invention, but the present invention products, etc does this also, or can or not, etc, more will be said about wearable and float-able products, etc later). Furthermore, product will be also made all shape, sizes, etc like its pocket departments (pd), etc; and there can be many Pd's, etc and many products, etc (or not) on one, etc container, etc, there can be even more then 3, etc or 10, etc 25, etc, or less then said or none because of said touch tech.; etc; and product can and will (or not) be also hide behind the logo, etc and still, etc be display, etc;

and some logo will be doors, etc and product package, etc, (all size, shapes, etc) which can be also made out of different (or not) materials then its container, etc which said door, etc shields product from the sun, etc or from heat or cool, etc to also prevent the lost, etc of heat, etc or cold, etc using suitable heat, etc changing materials, etc known in the arts, etc, and using suitable, etc insulting materials, etc known in the arts, etc and other said prevention materials, etc in this patent text, etc in the invention, etc; these logo packages, etc will make product look like its not there, etc. product also define as medical, etc in the container and dark chocolate, etc in pocket department (pd), etc, and product define as milk, etc in the container, etc and cheese, etc in the pd, etc product define as beef sticks, etc and all the likes, etc. Product also define as butter in the container and (benefits) butter, etc packages, etc, containers, etc in the pd., allowing you to take your flavor butter, etc to work, etc with you (or not). product also define as sauces, etc in the container, etc and sauces, etc in the pd, etc allowing you to away to take your sauces, etc to school, etc with you, etc by taking the smaller, etc packages, etc and leaving the main bigger container, etc at home, etc.

Product also define as all seasons and all spices, etc; season shakes, packages, container, and product define as display, etc and dispensing, etc packages, container, etc. Product also define as all tops and lids and closures, design to fit beverage containers, etc and food, container, like soda container, etc cups, etc. Note sometime the way container content is use is the way pd, etc content is use, etc so try to use your common sense when reviewing this invention, etc; use, etc. Product also define drug, etc in the container, etc and drug, etc in pd, etc in, etc tear package, etc; allowing you to leave, etc the main bigger, etc container at home, etc and still take the lifesaving said tear package, etc (or any type of suitable, etc container, etc) with you, etc; and shows even more advantages, etc by allowing a sick person to take the tear package, etc out of the pd, etc instead or reaching, etc into the container, etc with there sick germ hands, etc Note the same content, etc as container, etc and pd, etc content, etc can also have other contents, etc in, etc combination, etc (or not) package, etc with different content, etc like and unlike a solid, etc and a liquid, etc (these combination packages, etc are known in the art, etc); so therefore when said same content as container and pd content also could mean they, etc can have (or not) helpers products, etc a ex's food, etc and drink, etc or pills, etc and juice, etc a solid and a liquid, etc. these said combination products will also be made all size, etc.

Product Buttons text, etc; said product button, etc could (or not) have every word and text, etc and groups of words, etc that exits, etc, and every pictures, etc and videos, etc that exist and could exist, and sentence, etc, and on every electronic button, etc on every button; on every outfit, every product, etc for advertisement, etc for the present invention: now some examples for the beer company (drink, responsible line for responsible drinkers) for responsible people, etc who want to show other people to drink responsible like them, etc! buttons, etc (note etc in this case can be bears, etc toys, etc any product, etc even drink and food packages, etc with drink responsible text, etc on them, etc and to also support no drinking and driving and no texting and drive messages, etc; and the present invention and/or the companies who is the owner of this patent rights, etc or the inventor can donate, if they wish to do so to, nonprofit which are against driving intoxicate and to family, etc) so therefore this away for beer companies, etc to promote responsible, etc driving, etc; by using these responsible people as walking, etc advertisement to show that they are responsible and they should be also; without being in there face to drink responsible with buttons, etc the present invention at least and hope to change or impact at least one person to drive responsible; furthermore the present invention (note these buttons can be also any text, etc for any of the present invention products and containers, etc not limited to this text said responsible, etc) want to advertisement to those who are responsible!

ex. the present invention buttons, etc advertisement like the people who like to show they are drive hybrid car so to influence the ones who do not. Now some more button, etc text, etc could also say: help I may be drunk; moms and dads do not let each other drive drunk, etc; stop to use your cell phone; and buttons, etc which light up flash, etc do not drive drunk, etc; I love bikes, etc; baby kids stuff; alcohol taste better at home; one is to many go home! and drunk! or go to jail!; logo's and trademark's; picture's; story; s; electronic buttons and the likes, etc; name buttons; no texting and driving; if I look drunk call me a cab, etc milk is good for the soul; I love sports; football fever; I love ball; etc none stop suggestion, etc or terms to be use, etc. Product also define as magnetic buttons, etc and magnetic product, etc

Product for Animals, etc; product also define as pet food and pet beverages, etc and pet toys and edible, and chew products and toys, etc which can also be place in the humans, etc coolers, etc pd, etc because your pet goes the park, etc also (or any of the present invention container, etc and said pet pd, etc also define as pd) a pet, etc pd on your cooler, etc or on your pet cooler, etc allows away for you and your pet, etc to play and eat, drink, etc at the same time (note on the pet cooler can be a pd for your drink etc also or not; note or not is for all products, etc and pd, etc can be on containers, etc because of said reasons through out present invention). Furthermore the pet pd can have product heater, etc in it air cooling products in it, etc (note some products, etc are removable, are not, and come with and without products, etc and Pd's, etc just like all of the present invention containers, etc products, etc). An ex of a UN-obvious pet pd, etc the sports bike bottle container, etc could also have if it wish a pet, etc pd on it with, etc net hole doors, etc to hold, etc your pet butterfly, or bugs, etc, or your pet gold fish, etc in pd; or in a product fish bowl in the case for your pet fish (allowing your pet butterfly, etc to go on a bike, etc trip, etc with you, etc) which you can remove this said bowl product (are not) and sit it on your, etc desk, etc or on your kids, etc desk, etc (once again the present invention is UN obvious, and its products, etc its pd, etc and its uses, etc is and can be UN obvious, etc).

Furthermore the said containers, etc can also have a pet, etc a so called bathroom pd (for dogs, etc at the park, etc dropping waste, etc pick it up put it in pd or place pet in pd to do it said waste, etc). Furthermore, the pet pd on your cooler, etc can have, etc pd, etc in the shape, etc of can goods, etc products, etc to place your human food, etc or your pet food, etc or different Pd's for them, etc (note all pet, etc pd, etc and human, etc pd, etc made by machine, etc); furthermore some of these said pet, etc pd, etc will or can, etc have slide out, etc pull out, etc beds, etc cage, etc, products, etc on, etc said human cooler, etc pd, etc. So therefore product is also a pet cooler, etc that means that the human cooler can (or not) have a pet cooler product, etc was that UN obvious or did you lean from the present invention teaching (place, etc every, etc product, etc in, etc every, etc pd, etc; no matter how UN obvious it may be). For human and pet UN obvious edible product, etc Like how a candy bar product, etc can have a pd, etc its self mold, etc into said candy, etc by machine, etc and said pd having peanuts product sitting, etc in said pd, etc, but not, etc (or mix) mix in with the candy, etc; product can also be pet food, etc with mold pd, etc. (note that some product will be mix by the consumer, etc mix product, etc the way they normally (by hand, etc); ex milk, etc and cereal, etc; or mix pet food, etc; remember this invention is for human and animals, etc this just said text shows this to be true).

Product also define as dog food, etc, drink, etc in the container and cat food, etc in pd; or pet medicals, etc or pet supply, etc or pet container, etc in pd, etc (or not, etc to all that was just said because of customer and companies rights not to have because of cost, etc). Product also define as soil-dirt. Furthermore, Product Which Are Not Just Food, etc are not just food products, (product also define as content). Product also define as all bionics products, etc; and product defines as all nano products, etc; and define as all self charging product, etc. Products also define as all combination products which also cools, etc and heats, etc food, etc and drinks, etc. Product also define as tooth paste, etc in the container, etc and tooth paste, etc in the PD, etc in, etc squeeze containers, etc packages, etc. Product define also as anything like: all movies disk, TV in a cooler pd, radio, (so therefore do not just see pd as a empty box or just a place for something, or for just food and drinks, you will be wrong,) etc, in pocket department, and wine etc in container and music disk or player etc in pd advantage music, etc shown by others study shows health benefit, pd combines wine benefit with music benefits; liquid allergy medicine etc in container and pills medicine etc in pd; shaving cream in container and razors etc in pd; peroxide in container and bin aid in pd; fabric softener in container and fabric softener sheets in pd; mouth washer etc in container and mints; floss packages, etc which are build in pd or connect to pd,

(to prevent loss of said package, this shows how pd will also be one unit, etc; (this way will also be use for all or this patent pd products also). like and UN like shown in said medicine bottle container; tooth pick or brush or tiny mouth washes etc in pd; washing liquid in container and dish washing tabs, etc for dish washing machine, etc, or sponge (which provide away to change your old germ sponge, others study shows that they carry germs and should be change so when wash liquid runs out you get a new sponge in pd, this is a benefit which also define as advantages and argument) dish pad or brush in pd; etc more dish washing text said wash in the container and dish washing tear package, etc, or dish pads, etc in pd, etc, allowing customer to take said tear package, etc to work, etc to clean work lunch, etc dish, etc without taking the whole main container bottle, etc.

Product also define as all scanner and all portable scanner's, etc. Product can also be all cookware, etc remember pd, etc will also be (not shown) cookware, etc said pd, etc come off, etc mounted to container, etc by grooves male and females, etc by plugs female and male, etc or by suitable adhesive materials, etc and by interlocking etc with container, etc and pd extra pd, etc or hollow part in container, etc, and by connect, etc to another product, etc, and by magnetic, etc and by bands, and by fastens, etc like screws, etc nuts, etc; and by clip on, etc, (or not), company, etc choice, etc. A product container not shown (or see I representation container) will be also a divider PD with one, etc PD have a food, etc or drink, etc PD'S, etc and the other divider side having PD which press against the other PD said first and in this food, etc PD can be made of stainless steel, etc because the PD which press against the said food PD, said press against PD can hold a, etc exothermic product, etc, so said press PD can be also called a exothermic PD which is a TT use PD, etc, and this said container can have also a salt water, etc or water PD, etc. Product also define as heat pads, etc heat body bottle, etc use for the Pd content, etc and for the content, etc, a example the sport bottle container, etc PD have a, etc heating, etc or cooling, etc pad product, etc or heating, etc cooling, etc devices, etc which you use for the container, and PD content; and you can use said pads, etc for your hurting legs, etc,

or use for your cold hands from riding your bike in the winter time, etc UN-obvious yes but real. Product, etc also can be all product which can be power by water (like and unlike the clocks, etc which power by water, etc), by wind, by solar, by air, by electricity, by battery, by light, by fuel cell, etc (or not) and all the likes, etc and UN likes, etc. Product also define as all wireless product, etc; and define as tiny, etc size, etc product of all kind like and UN like copier, etc, cameras, etc printers, etc scanners, etc, also made all size, etc. Product also define as camcorder, etc; and electronic bile, etc; product define as all product cables, etc and; digital turn table, etc and micro stereo system, etc; and product define as charger station, etc; and MULTI-band scanner, etc; and all touch screen product, etc; and blue-ray, etc product. Product also (remember product come with and without pd, etc) define as sphere that grows, etc. Product also define as all solar, etc power warmer, etc and coolers, etc; and units, etc and product define as all thermodynamically packs, etc and products, etc. Product define as all charged products, etc.

Product also define as lid bread product to be use for more then for bread use pd, etc use for any product, etc; product will also be chairs; burner cooking plates; all cookers; bread makers; window canister; recording device; stove top products; griddle; waffle and toaster makers; electrical fireplace heaters; now a UN obvious ex, a photo, etc video, etc screen product, etc shows etc a burning wooden fire like your home fire place; benefit see a fire place etc, on your cup product, etc on a cold nite, etc an another UN obvious ex for those who do not want to do the present invention teaching; place the video screen product on the flower pot container pd etc see a video, etc of a bug, etc fighter, etc, this text, etc shows UN obvious, etc, but you the reader would have seen, etc this product screen, etc in the flower pot container if you would have place this product, etc in this pd no matter how unlike obvious its seem; do it to teach yourself this invention; but the invention will keep trying to teach you this patent way and to do what the invention does, etc.

Product also define as hand held, etc video games etc and all hand held product, etc, and games, etc benefit shows advantages, etc the sport bottle, etc (can be any container, etc in this invention) container come with (or not) video game product, etc with a pd within a pd which is a nylon, etc or rubber, etc or water proof materiel, etc (the “pi” will also use suitable materials and waterproof suitable materiel and suitable shock proof material, etc known in the art,) pd, etc made by machine, etc. Product also defines as all portable Product also define as microchip, etc product, etc; and product define as all voice control product, etc and define as video eye screen glasses, etc and personal media viewers product, etc. Product define as all solar devices, etc and products, etc to charger any product, etc and all compact solar devices, etc like refrigerators, etc oven, etc; and product define as all plug into motor, etc vehicles, etc to power your products, etc. Product also all compacts, etc mini-refrigerators, etc and oven, etc and all the likes, etc define as all waterproof package, etc container, etc and materials, etc. Product define as perfume, etc in the container, etc and sniff smells product in, etc the PD, etc. Product also define as edible food, etc container, etc and all the likes, etc known in the arts, etc. Product define as a, etc beverage, etc, food, etc candy, etc toy, etc venting machines, etc and PI will be made to drop, etc product even with out said venting, etc by PD slot PD, etc this product, etc said venting will also be good for the cooler container, etc sport bottle, etc.

Product define as so called e books, etc; and to show more wideness define as juice extractor, etc ice cream maker machine, etc Product, etc; and pine pantry, etc and; mechanical oven, etc; and blender; wine glasses, etc; and window bread box product, etc to also use for any product, etc. Product define as study assistant laptops, etc; and light curio; and hourglass; and grand, etc farther clock, etc; and media cabinets, etc; and artwork, etc; and all fountains not just water fountains, etc. Product also define as Product also defines drinking water, etc tanks, etc and the big, etc drop off at your home, etc or office, etc water bottle cooler, etc and container. Product also define as backpack; backpack drinking device, etc and all drink etc hose, etc and product define as all sounds and special effects products, etc and; sound and lights, etc and; define as all hologram product, etc and define as all paints gun and laser's gun product and define as all talking Product a ex talking cards; and talking devices, etc product also define as all amplifies and personal amplifies, etc. note a removable pd can be use also to hold other. Product also define as Product also define as m3p players, etc and mp3 video players, etc benefit allows the bike container etc pd, etc to ride with music, etc video, etc or use your amp, etc ear phones, etc product, etc to hear cars, etc better etc;

(note “etc” can be (or not) any of the present invention product, etc so what the present invention is teaching, once again you must 100% place every product, etc in, etc one, etc or 10, etc into each present invention pd, etc or Pd's, etc). Example of a MULTI-PD'S, etc is given a double seat bike, etc with a present invention bike, etc container pd, s etc have a m3p players Pd's but the back rider can hear music so you take one, etc a give it to said back rider but the said back rider can not hold it do worry all of the (pi) present invention product, etc Pd's, etc can connect to you or other products by said groove, etc and by bands, etc, so there fore the said container, etc can be sold with one with two with three with four, etc pd, etc; and so there fore you can also wear your candy bar, etc on yourself, etc on your bike, etc very UN obvious is it! Product also define as all cards, holiday cards, etc and gift cards and DVD and CD, etc cards, etc, and gift gifts cards, etc to buy downloads, etc allowing a way to have, etc or give, etc a card, etc with your beverage, etc or food, etc, or allow away for a company, etc to give a card, etc to there customer, etc. Product also define as; all infrared control products like: cars, boats, plane, etc and all product which double, etc as controllers, etc.

More products, etc fiber optics product, etc; and two, etc way radios, etc; and led, etc flashlight, etc; and define as all product which need no battery to power it, etc; and define as crank, etc products, etc and crank flashlight, etc; and product define as digital, etc photo products and cubes, etc and product can be all radio controlled indoors/outdoors product, etc like and UN like helicopter, cars, etc; once again remember even the present invention products, etc can have PD'S, etc or products, etc, so this means that the just said helicopter product can (or not) have a pd and a product, etc (teaching); a UN obvious ex fly, etc a candy bar, etc over to your lazy couch potato dad, etc; or said helicopter can have a pop off, etc radio, etc or laser light, etc, any product, etc even slide off, etc pd, etc (not shown once again product, etc and pd, etc without reference number, etc should be seen also as I represent, etc).

Product also define as, all weather-resistant product, etc and weather-resistant speakers, etc; and bass techs, etc and disco balls, etc tech, etc; and product can be surround sounds speakers and receivers, etc and receivers, etc; and product can be microlights, etc and micro-products, etc; and lithium, etc microlights, etc. Product also define as to show more wideness define as sleeping bag etc tents, etc camping, etc and hiking, etc supply's, etc. Product also define as all virtual, etc video, etc game system, etc; and all projection product, etc like clocks, etc TV, etc; and product define as air pots, etc. Product and container, etc also define as all crystal's product, etc and containers, etc; and define as watch, etc timers, etc all temperature readers, etc Product also define as products which are jokes, etc and thing, etc which makes you laugh, etc while eating, etc or drinking, etc said jokes, etc allows benefit known in the arts, etc causes better health, etc. Product define as housing, etc container, product air pump, etc bike pump etc with, etc pd, etc with, etc tire fit kits, etc in pd, etc; remember pd can be made on the outside, etc of its, etc container also which have moving, etc inside parts, etc made on the said pd can be a pd, etc glue or weld, etc to said out said container which also define as housing, etc. Product define as trays and arrangement basket, etc to hold product, etc in PD, etc also product define as fruits, etc vegetables, etc storage, etc container, etc also made to be (or not) removable, etc.

Product define as balloons and define as life saving products, etc and life vest, etc.; and product define as all floating gas tanks, etc and define as air pumps, etc water pump, etc. Product also define as ash tray, etc and the present invention will use all know in the art suitable fire proof materiel, etc when suitable because remember product can be anything, etc and product define as all smokeless, etc humidor, etc and tobacco, etc cigar cutter, etc kits to make your own cigar, etc and nicotine gum, etc or even candy cigarette, etc spoons and forks; napkins, gums, mints, all supplements; pd will also have game in pd; product for bigger (because pd will be made all sizes and shapes etc) containers with pd (benefit) provides away to chill your wine glasses, etc. The can container etc. will also have corn etc in the container and peas etc in the pd. Pd containers will also be for, baby and kid's cups and containers. Products, etc also define as so called green products and organic products, etc, etc and products can be Product also define as air fans, etc and power air fans, etc and all cooling, etc devices, etc and heating devices products, etc and solar tech devices products, etc and all solar panel, etc like and UN like photovoltaic, etc and generators tech products, etc, and wind power device, etc to also power your product. Product also define as recording device, etc and monitors device, etc, Product also as greeting cards, etc electronic food, etc toaster, etc (note etc could be other product, etc).

Product also define as all machines, etc vending candy, etc toys, etc stickers, etc like and UN like the ones, etc in stores, etc. Product also define as personal satellite product, etc and all cable products, etc and product define alarms, etc; and all sensors, etc like all noise sensors product, etc and light sensor product, and water sensors product, etc; and all temperature sensors product, etc. Product also define as credit cards; gift cards; debit cards; store card, etc on-line cards, etc, and all likes, etc. Product also define as computer, etc animated, etc product, etc screens, etc. Product also define as robots, etc and drones, etc come out of the laser gun, etc PD etc, (or not) for you, etc to shoot at, etc; which also shows how the present invention uses each other products, etc PD, etc also within each-other like said robot and drone come be coming out of said laser gun product, etc. Product define as lock safe, etc in, etc pd, etc and use for any product and in, etc any product and in, etc any container, etc, remember the teaching this said lock safe product, etc can also be in the robot product, etc; and you can have in your robot, etc pd, etc a, etc said robot, etc or a, etc water gun, etc or a, etc laser gun, etc, and so on and so on; and (or not to all said) your water gun pd can have a robot product or your robot pd, etc can have a, etc water gun, etc or (shown more connection of UN-obviousness, etc using each-other product, etc as this patent teaches to do),

your laser gun, etc pd can have a robot, etc (use in any way you wish or shoot at the robot, etc) product, etc or your water gun can have a laser gun, etc and; now greatness shell be seen, your water gun (follow the teaching) can have a drone product you can shoot at, etc; so what do this means (teaching) your bike container can have drones, etc robots, etc and removable, etc (or not) Pd's, etc and which can (or not) connect to you or your bike, etc; or to other product, etc; and said products can have (or not) products, etc or PD'S themselves, etc; and which can be sold with and without said bike, etc container, etc, because of company rights, etc and customer, rights, etc. When said robot the said reader, etc can also use said robot to bring you a drink, etc; and said robot, etc can be in a, etc cooler, etc container, etc pd, etc. The present invention robot can hold can, etc food, etc in its, pd, etc. Product also define as all pumps, etc and all mini pumps, etc; water pumps; etc 12, etc volt dc water pumps and hoses of all kinds, etc and siphoning pumps, etc and all MULTI-USES pumps; etc and all compact, etc pumps known in the arts, etc.

Product will also be, etc chips, etc or; dish washing soap, etc in the container, and dips, etc; or; hand soap, etc in PD, and product define as chips, etc in the container and dip dispenser in, etc pd or chill and cheese with or without removable microwavable PD, etc; or product define as corn, etc in the container and its PD having a, etc bio-plastic peas, etc in container in said PD, etc Product can be also insulated container, etc and define as all thermal portable, etc cooler, etc, and define all ovens, etc freeze materials, etc apparatus, etc Product also define as all kits product like and unlike kit with connectors switches, etc; male and female quick disconnects, etc and connectors, etc and; slide switch with on and off, etc; and power and power adapters, etc; and power adapters, etc; and off and on and off adapters, etc. product also can be hoses and tubing like and unlike clear vinyl tubing, etc, vinyl drip tubing, etc latex tubing, etc.

Product also define as Product as define as pressure cooker, etc for the outside and inside, etc; and product define as grills, etc; and food slicer, etc; olive oil and beverage dispensers, etc; and all food and drink wear, etc; and can opener, etc; and define as food and hot dog cooker maker, etc know in the arts, etc the kinds of hot dog makers, etc which also use stainless steel roller, etc; and product also define as toaster oven, etc and product define as to shows how wide product, can be product define as door cabinets, etc also use to hold other product, etc; and product define as revolving counter top, etc organizer, etc; and product define as chair pads, etc; and wine, etc cabinet, etc which some works by power, etc. Product also define as thermally insulated trays, etc and stack-able tray, etc; and product define as coin, etc holder, etc device, etc machine, etc banks, etc. Product define as snow cone machine, etc, and ex, the cooler container, etc have said machine in, etc pd, etc with the ice to use already in the cooler, etc. Product also define as all motion sensors, etc product, etc; and product can be all trash cans, etc and feet open trash can, etc which these said trash can will also be use to hold any product etc with and without being removable from it pd like (not shown) the motion lid, etc trash can, etc use different in pd and seal, etc (or not) into said pd because you can use it for ice, etc any product not just trash, etc;

and when said trash once again the PI will also have trash PD (not shown) which holds your trash and candy, etc wrappers, etc camp, etc trash, etc and said trash PD will be on any container cooler, etc soda bottle, etc robot, etc yes the said robot, etc can be a robot trash can, etc or drone trash can, etc or recycle PD for your recycle stuff, etc; and the PI can have many, etc (or not) products, etc or PD, etc which can be made in many colors, etc and have name tags, etc on them, etc or you can write on them using materials, etc known in the arts, etc to write on container, etc and some PD will be made in different shapes, etc to show the difference in uses, etc Product also define as all predetermine sizes, etc product, etc.

Product also define as all recyclable and reusable container, etc, and pd, etc benefit refilled them with food, etc or dog food, etc, said refill them etc with the bigger main container contents, etc Product also define as all health and diet product, etc. Product, etc and container, etc also define as canteen, etc and party and beer keg, etc and party pool supply like blow up toys, etc and all pool, etc supply's, etc. product define dry ice, etc and freezer packs cooling gel packet, etc and product define as hot and cool packs, etc and removable one, etc said pack containing thermal material, etc known in the arts, etc. Product also define as CD, etc DVD, etc racks, etc and DVD, etc and CD, etc providing music, etc with your food, etc and benefits combine health benefits music, etc is known by other, etc to help you, etc with your, etc wine, etc known health benefit, etc providing benefit entertainment, etc games, movie, books, etc and electronic books, etc, more benefit you, etc was, etc riding, etc your bike, etc and your bike, etc container, etc pd, etc has, a product learning device, etc and electronic book, etc after, etc stopping, etc you relax, etc at the park, etc and read, etc, (and view, text, video, etc and your play and learn, etc on said book, etc; note all product can mount, etc connect, etc to other product, etc or you, etc by groove, etc by strap, etc by bands, etc more will be said about this).

Product also define as video, camera, etc. Product also define as food and beverage cups, etc holder, etc, maker and devices, etc beverages brewing, etc devices products, etc and all drink, etc mixing, etc devices, etc and all dispensing product, etc, product define as all machines, etc and devices, etc, and cooking fryers, etc pots, cups, sleeves, and etc and temperature readers and devices, etc with and without PD, etc. Product also define as empty etc gas container, etc with and with out pd, etc (note all product of the present invention can have pd, etc and product, etc in, etc there, etc pd, etc or in, etc there, etc product, etc) and with and without a, etc door, etc for already store, etc bought fill oil container, etc which fits, etc the same shape, etc pd (this said gas container, etc can be a said business container able to do business with this said oil company container, etc), and these said containers, etc can have trash, etc pd on, etc them, etc. Product also define as plant pot container, etc and plant tools, etc and UN obvious product, etc in pd like radio, music tech, lights, etc clocks, etc in pd, etc; and product define as plant food, etc drinks, etc in the container, etc and seed, etc dirt, etc and different kinds of plant products, etc in pd, etc and smaller, etc pots etc in pd, etc. Product also define as all yard, etc and plant products etc.

Remember you must place all products, etc in all container, etc pd, etc and place all pd, etc in all products, etc to better understand this patent; (once again this is a company friendly, etc invention that allows, etc a company to plug in a, etc product, etc to see if, the said company wish to make that, etc product, etc; so the reader who want to do a container, etc product, etc (or not.) must do the same plug in products, etc you are doing yourself to see if its already done by the present invention, etc) the said company wish to make that, etc product; furthermore, one company may need four, etc pd, etc, but another company may need two or less pd, etc, the present invention is also made for this reason, etc, this is what this invention do, etc; this is also a closely fitted statement.

The present invention will or can have “bonus products or free or cheaper when sold together products” to influence the buyer of the container, etc or the product, etc (remember product can have pd also, etc) to buy its product, etc or container, etc (also remember they can be sold apart also; teaching) over others, etc. Product also define as disposable containers, etc; and define as all feeder containers, etc and all purification containers, etc and define as all wooden containers, etc. Note once a product, etc is said, etc it can be use in any pd, etc product, etc or container, etc; and note that a product, etc can be seal, etc made, etc into pd, etc or the container, etc and not removable, etc (or removable). Product also define as all frozen food dinner, etc and product define as all cooling, etc and heating, etc devices, etc and unit, etc and product define as all ceramic container, etc all resealable container, etc and all edible container, etc and define as all edible products, etc and edible flowers, etc and none flowers, etc; said edible products, etc can also help with waste, etc and product define as (wine, etc and flowers, etc show her, etc you love her, etc) and vines, roots, seed, etc and define as dirt, bugs, etc Product also define as candy, etc box, etc (with and without candy, etc), packages, etc containers, etc, and product do not need a container, etc because pd can the package, etc for said candy, etc;

and product define as all candy, etc machines product, etc and candy, etc dispenser products, etc removable or not removable form said pd can be glue, etc or mold, etc into said pd, to help product from moving out of pd when it be using ways where it need not to come out, etc. more said text in present invention about product which is made to not come out of pd, etc; and this will be done for some product also products, etc which are not removable a ex. is given the cooler, etc container pd, etc have a microwave, etc build in it, etc. And teaching this invention more product, etc come with and without pd, etc, because of reason of giving buyer the choice to buy there own product, etc, so product, etc will be sold apart from its container, etc. Product define as all adapters, etc and beverage adapter, etc and cartridge for beverage, etc preparation, etc and define as all squeezable bottles, etc. Product also define as all remote control planes, etc cars, the boats, etc trains, etc and all the like, etc; and show even more wideness product also define as baby, etc video camera, etc and all laser tech, etc product, etc and any water gun, etc product, etc. Product also define as cards Cd's, etc and card DVD, etc and players, etc for teams. Product also define as all fragrance in the container, etc and all fragrance, etc in pd, etc or/or not scent oils, etc perfumes, etc in pd, etc.

Product also define as cigar, etc and cigar, etc you make your own, etc and all the like, etc, product chocolate cigars, etc and electronic, etc cigars, etc and all electronic products, etc. Product also define all sand clock, etc. Product also define as all computer devices, etc and DVD, etc and CD, etc players, etc. Product define as help you stop smoking products and help stop alcohol, etc drinking product, etc. Product also define as all devices, etc which cook, etc food, etc; so therefore a cooler container, etc have a pop corn machine product, etc (or not); teaching remember you must place every product, etc in, etc every container pd, etc. Product also define as telescope, etc for, etc nite, etc bike rides, etc; so therefore a bike container, etc pd can have telescope, etc; more product utensils, etc, all clothes, blanket, shoes, sports products, etc all hobby products, etc remote control cars, trains, planes, drones, robot, all remote control products and all the likes, etc; and remote controlled drones, etc and all product to work them, etc. Product also define as roller coaster toy, etc. Product define also as all products devices holder and device which connect to other devices, etc. More UN-obvious text when said shoes product, etc will also be for toy dolls product, etc, ex the sport bottle pd, etc have doll for little, etc girl, etc ride her bike, etc with her doll, etc.

Product also define as paint in the container and paint brushes, etc supply's, etc in pd. Product define as a, etc container, etc within a, etc container, etc. Products will also be molds products and cookie cutter, etc; a ex cookies, cake, etc mix, etc in the box, etc container and cookies, etc cutter, etc molder, etc birth-day product, etc, anniversary product, etc in pd, etc. The PI container and product container packages, etc will also be made with biodegradable materials, etc known in the arts, etc made by machine, etc. Product also define as all instruments product which should also be see as a, etc housing, etc or body, etc product, etc so this product can also have a PD, etc (made and adhesive to product t) and product, etc. Product also define as grater, a UN-obvious ex of the grater product a; a block of cheese, etc or chocolate, etc have a mold, etc pd, etc in it with said grater, etc its product, etc. Product also define as pop corn devices, etc and candy machine, etc and cotton candy machine, etc.; Product also define as family, etc size, etc container, etc; furthermore others patents shows low oz, etc container, but the present invention is for single size container, etc and family size, etc containers, etc and products, etc, and remember the present invention can have ten, etc (or not) or more or less PD'S, etc with many different uses, etc one can be for napkins, etc and one can be for trash, etc and one can be for any product, etc; which can also be MULTI-display products, etc and PD'S, etc;

a example is given your passenger can grab a, etc drink, etc; or a, etc drink and food, etc container from your container pd this also show how UN-obvious, etc MULTI-PD, etc and MULTI-PRODUCT, etc can be, which is obvious but can be use in family size, etc Pd's, etc ex the cooler container, etc have family size pd, etc (or not). And works great for party, etc and for your family MULTI-USES, etc show advantages, etc and PD'S, etc can have family sizes product's etc or meals, etc. The present invention will take on the shape, etc size, etc, design, etc of any thing, etc which mean also other soda container, etc, and even take on the shape of shoes, etc which can be cool, etc down, etc benefit, etc your hot shoe, etc after running, etc place your hot shoes, etc in a cool, etc pd, etc this pd can also be (or not) a universal pd, etc (not shown) which can also be in the shape, etc of etc which fit most, etc or all shoes, etc this just said UN-obvious pd work also in the cooler container, etc; but do not, etc do not, etc take the cooler as being the only way to use this just said shoe, etc pd; a UN-obvious ex said shoe pd a baby bottle, etc pd have toy, etc shoe etc to cool, etc her, etc baby shoes, etc, like her mother the baby mom cools her shoes (the real baby) in the cooler pd, etc.

Product also define as insulin and needle, syringe, and medicine and medical supply' and band aid, etc benefit have your said supply's with your beverage, etc food, etc, your container, etc pd, etc, so you do not get sick; another UN obvious ex. is given your sport bottle have, etc a pd with insulin device, etc allow your medicines, etc when you working out, biking, hiking, etc. Product define as gluten free, etc product, etc and gluten fee diet product, etc. Diabetes drink, etc content, etc in, etc the container and diabetes food, etc bars, etc in pd, etc providing benefits, etc or for even more UN obvious text pd on your, etc cooler container, etc pet pd for your pet medical supply. Product also define as haircare, etc products in the container, etc like shampoo, etc and all the likes, etc (like combs, brushes, and the likes, etc and/or hair gel packages, etc shampoo packages, etc and conditioner containers, etc (or not) in pd, etc). Hair cutter device housing container and is pd have, etc scissor, etc comb, etc. More housing, or can be said as casing, etc body container product, etc will be all electronic devices, etc another ex the TV, etc product casing have pd with remote pd or a removable, etc radio, etc or pd with, etc a computer, etc product, etc (or not), etc or a radio product housing have a pd, etc (or no), these said housing product can be anything, etc.

Product also define as boomerang, etc yes the boomerang, etc can be wearable (by said grooves, etc by said plug, etc by said magnetic, etc by said bands, etc) and yes the boomerang, etc can be with a, etc PD, etc and can have product, etc, remember teaching, UN-obvious uses throw your boomerang product, etc and if you catch it eat PD snack, etc or throw said boomerang and if your pet (dog, etc) catch it your pet get the PD snack, etc; and Product, etc the container, etc can be made with materiel of all precious gems, etc and metal, etc so the present invention container, etc so can be sold to people who like expensive thing, etc. Product also define as new touch tech; define as all holders and define as all holders for bikers, etc for truck workers, etc; product, also define as all maps, etc all electronic maps, etc, GPS devices, etc clocks, etc video devices etc radio devices, etc. Product also define as all light, etc and blue lights, etc and all light tech, etc and bike, etc reflector's, etc, yes the said reflector can be wearable, etc and can be connect to you or your bike UN-obvious how by magnetic connect to said reflector, etc is magnetic PD on reflector allows its to connect to you, etc or other products, etc, more said later in text.

Product define as all endothermic and exothermic package and food, etc and drink, etc products and containers, etc and package, etc.; and the present invention define as all food and drink, etc containers; package; etc cooling, etc and heating, etc container, etc. Further more to show how two, etc unlikely product, etc or container, etc and product, etc can come together and work together; this is another UN-obvious working together text a cup, etc and a cellphone, etc with and without pd; its is known that some, etc cell phone, etc heat up, etc so using the cooperation, etc of the cup having ice, etc to cool, etc the cell phone, etc in the pd, etc, so therefore the present invention goes beyond using (TT) for just food, etc its, a new use, etc; so the present invention cool, etc your hot cell phone product, etc also, the present invention (TT, etc) is not just for food, etc drink, etc; I know I repeat myself (this just said text), I want really you the reader to really know this, also new use of TT.

Product (c) also define as bio-containers, etc and bio-gradable, etc packages, games and products and said bio-products, etc can be made removable or made to be permanent with said container (for said reason, etc), etc, remember the present invention product, etc come with and without said container, etc and the present invention containers, etc can be made with these materials said bio-materials, etc (known in the arts, etc) when suitable like for the bio-games, etc the bio-safe water gun product, etc so safe you can drink out of it and will also be made to do so. Some bio, etc games will be but not all: pin ball games, puzzle, etc beverage and games, etc chips and games, etc products and games, etc and none electronic and electronic games, etc. Product, etc and its food and drink containers, etc can be or will (or not) also be made all shapes, etc like stars, etc octagon, etc all shapes, etc. Product also define as bar code and radio wave, etc devices, etc products, etc. Note any product, etc can be (or not) in, etc any container and in, etc any product and in, etc any pd, etc. Product also define as peanut butter, etc, jelly, etc in, etc the container, etc and all the likes, etc and peanut from the same fields, etc they was grow in, etc; and chocolates, etc, cracker's, etc and all the like, etc in pd., etc (or not), and define as peanut butter in the container and peanut butter in pd, etc and/or not, etc jelly, etc in pd, etc or/or not jelly and peanut butter, etc

Furthermore, (c) the present invention, etc can come with product, etc or not because also of companies, etc, or a company, etc who owns a food, (or stay in there own fields, etc) etc and/or a beverage, etc company, etc, which the present invention allows the owner of one, etc or two or more company's, etc to design, etc there product, etc to fit, etc each other, etc product, etc so therefore (or sold together) said products, etc do not need to be sold together, (a ex. is given out of many; a beverage company container, etc with pd fits, etc its chips company container, etc both, etc container, etc own by the same company, etc but others company's, etc products do not fit the owner of the present invention containers, etc). Note that a company, etc that do not owns two, etc, or more companies, etc can also do business with other company, etc to fit, etc there product, etc together, etc; the present invention allows this also. furthermore when said products, etc fit, etc together, etc further allows company, etc to design, etc there product, etc to fit, etc each other pd in order to (and without totally changing there companies way of productions, etc) stop other companies, etc without these ability from placing there article, etc in there interlocking pocket department, etc, or customer (buyer of beverage, etc container, etc, because the present invention is much more the beverage and food container) from placing others article which is not the present invention (pi) interlocking product, etc,

so companies, etc (a ex. a beverage company, etc and candy, etc company interlock product but other candy do not interlock with them, etc or do, giving said companies away to work together, etc) of the present invention can do business together to fit, etc or interlock, etc there products only, etc (or not) together, etc. (companies of the pi do not worry, the pi also come with universal pd and the pi interlocking pd, etc made all deign, etc even design, etc which can hold, etc any product, etc even product, etc not meant for pi and product, etc in different shapes, etc from the interlocking pd; (not shown) pd, etc define as pd, etc made all designs, etc), even companies, etc and patents, etc which article, etc fit together with its recess; the present invention (pi) ability's and pd, etc shapes, etc will be different to stop them also, so as you can see the present invention interlocking, etc is more then holding, etc a product.

The display pd have allow product, etc to be seen better, etc on store rack, etc, and sold apart in-till buyer, etc customer place them (and making there own choice, etc to buy the product they want) together, etc so production, etc of product, etc can be cheaper, etc. The present invention is not without, etc for no reason it without, etc product, etc to give companies, etc and customer, etc advantages, etc. When said interlocking, etc or fitting, etc (note fit do not have to interlock) is not limited to shapes, etc it can also be one, etc company, etc pd and the other company etc product sizes, etc are the same, etc to fit, etc, together, etc and the present invention can also provide away to promote, etc and/or not display, etc other companies, etc products, etc. Furthermore, the touch tech (TT), etc also define as product, etc and define as no, etc pd is needed but also uses the pd, etc or also works with the pd, etc and with TT, etc which also can use the new, etc labels, etc, the new, etc hand covers, etc, the new, etc wrappers, etc and the new, etc pd, etc and can use, etc (said etc, can also be, or not, etc) stick tape, etc and/or materials, and all the likes, etc a place for product, etc, to store, etc to hold, etc to mount, etc product, etc (ex given products, cell phone, etc drinks, etc candy bar, etc any product, etc) to container, etc, to pd, etc, to you, etc.

Product also define as all binoculars, etc. Product also define as all dispenser and soap, etc dispenser, etc containers, etc and it's pd have, etc soap bar's, etc soap packages' etc; and define as all dispensing container and candy dispensing container, etc note when said a closely fitted statement, etc; that statement, etc was not said in other patent and its noticeable that its was not said, etc. and closely fitted description etc also define as product, etc which was not said, etc and should be concede as a closely fitted description, etc and claim as product, etc; and furthermore, if a product, etc was said in others patents, etc the present invention will use them base on new use's etc, which will be seen in drawings, etc; and remember the present invention product can (or not) use the TT and the new TT surround product, etc 100%; and use the display pd, (which also do define as pd, etc) etc. More product text to show how wide product, etc can be, etc and to show how the same, etc content, etc can be in container, etc and in pd, etc. Product also defines baby, etc training cups, etc Product also define as finger nail polish, etc polish remover, etc and all the likes, etc in container, etc and said polish, etc and said remover, etc and finger nails tools, etc or cotton balls, etc and/or all the likes, etc in pd, etc (or not) in tear packages, etc, in containers, etc of any kind suitable, etc.

Furthermore product also define as all oven and freezer and refrigerators, etc products and packages, etc and containers, etc and define as all boiling packages and container, etc. More benefits of product also define as beer, etc in the container, etc and seasons, etc and/or not recipes, etc, for to cooking, etc with beer, wine, etc and all the likes, etc in pd product also define as all charger for said products, etc and define as all portable electronic, etc. Product also define as aerosol spray can, etc with, etc shaving cream, etc in the container and razors, etc in pd; more ex of the aerosol content etc whip cream in the container and fruit, etc in pd; even more container aerosol is dog, etc spray for ticks, etc container and a brush, etc in pd, etc an the ex can go on and on none stop uses, etc, so therefore you must allow some use to come with the buyer container, etc.

Product also define as whistles, etc and dog whistles, etc for the bike, etc container, etc to stop dogs, etc from running, etc out of you; or while you are jogging, waking, etc with your sport bottle container, etc. Product also define as all artificial product, etc; and all electronic compact refrigerator products, etc; and remote control air plane; and all solar powered portable food, etc product, etc; and all compact food cookers and all the ones which uses adopter, etc to connect to power them, etc; and product define as all heating and cooling containers, etc and products for food and drink, etc; and define as all electrical units products, etc; and define as all phase changing materials fill, etc packs, etc and products, etc; and define as periscope product, etc and define as thermoelectric cooling and heating food and drink appliance, etc; and define as all self heating, etc hydrating pouch product, etc; and all compressor, etc having product, etc; and product define as all stainless steel and rubber material, etc containers, etc and packages, etc for also to help preventing condensation from forming, etc.

The present invention container will also have PD for products, etc for all exothermic and pressure generating reaction package, etc and product, etc (not shown) this container PD (have a PD, etc inside, etc of a PD, etc) just said PD can be made out of stainless steel, etc; and can hold said exothermic package, etc in one PD the bottom inside (inside, etc of its main PD which is the container) of the maid PD and have it's own door of stainless steel, etc and inside, etc of this said container PD is said exothermic package, etc in it's PD, etc and the other PD which surround said PD with said exothermic package, etc; this said other PD can hold, etc heat, etc food, etc product, etc not easy seen but real. Product also define as darts; arrows; bubble solution, etc in the container, etc and bubble solution guns, etc (not the present invention design water gun in this case any water gun, etc) and all toy guns and water gun, etc in pd remember; with the present invention can also use each other, etc products, etc use each others contents, etc use each other pd, etc and the present invention product, etc can have Pd's, etc themselves, etc; a quick ex. the water gun (not the present invention design water gun,) product have, etc (or not) a, etc bubble, etc solution, etc guns, etc in its Pd's, etc; benefit; after getting your hair wet, etc when using the water gun product, etc (this said water gun product, etc should also be seen as said body, said casing product, etc in first paragraph of said detail being) use your, said water gun, etc pd, etc comb product, etc to fix your hair, etc;

benefit, etc (to show even more UN-obviousness, etc use said comb product, etc to comb, etc your pet hair, etc (remember there can be many pd, etc (or not) or many products, etc (or not) so therefore you do not need to use your comb to comb, etc your pet hair use your pet pd, product, etc (not shown or seen as I represent) on said water gun product, etc (or not, because of rights to choose if this product, etc or any of the present invention products, etc will use this pd, etc or product, etc, because of budgets, etc; more will be said later.) to comb your pet, etc or dog, etc hair, etc, you wet with your water gun product, etc when play, etc) Some of the placement of products, etc is place by (or by the invention) the consumer, like placement of free dirt, etc and worms, etc in the container, etc and fishing gear, etc in pd. (note when said etc could also be (or not) said to include more products, etc).

Product also define as all robots, etc and all drones, etc and remember all product, etc can also have pd etc and product, etc themselves, etc and can use each-other content, etc and product, etc; yes hard to understand but true; and more UN obvious text, said robot product, etc can have cleaning products (or not) in its, arm pd, etc. Remember the present invention use each-other products, etc materials, etc PD'S, etc (or not) so therefore wearable and float-able products can also be combine, etc (or not) a example out of many the wearable PD'S, etc have wearable band, etc connect to said wearable PD'S, etc (which can hold your power bar for when on a jog, etc) but this wearable PD is also made hollow, etc or out of float-able, etc materials, etc or waterproof materials, etc because you are in a IRON-MAN contest, etc. All wearable, etc and float-able, etc and drones, etc and robot, etc products, etc all define as product; because a product is a product, and all products can come with or without pd, etc; and not just because they can be a (customer, etc) suggestion, etc to come with a empty cheap container, etc or pd, etc and to help keep cost down for the companies, etc and customer, etc and can be also phantom products, etc (or not; all products, etc can come with the present invention container, etc or pd, etc or sold apart from said container or pd to also keep cost down, etc; ex, a robot with, etc just, etc a, etc pd, etc, with, etc no, etc product, etc).

The present invention pd, etc and product, etc will also be made out of all known in the arts, etc edible materials, etc for pets, etc and for humans, etc. Product also define all USB product, etc; and all wireless product; all blue-tooth products; etc; all mobile devices product; all adapter; all printers; all WI-FI products. Remember (teaching) product, etc can have (or not) many Pd's, etc or many product's, etc or not, etc; note let the invention give the reader a ex, of this, so you can known this is real and can be done, the robot product, etc have (or not) a cup product, etc with a pd, etc with or without water, etc and food, etc to bring to you, etc; to take this even further, in-order for the reader to understand even more this robot product, etc can (or not) even wear, etc its product's, etc or Pd's, etc. Products also define as all products, etc for drone, etc and all products, etc for robot, etc for to power them and for them, etc. Another UN-obvious bike, etc container pd and Product, so said pd, etc can be in one shape, etc of the shape, etc of a candy bar, etc which will also allows the shape of TV, etc a radio, etc a light, etc in the same, etc shape, etc as the candy bar, etc, so therefore only the present invention product line, (all just said product) can fit said candy bar MULTI-PRODUCT'S pd. Note this invention will also be made to fit any product, etc that not the present invention product.

Some More Product Argument Description, etc; product also define as ring, etc jewelry, etc in pd, etc and perfume, etc cologne, etc in the container, etc (or not can be any product,) pd, etc allowing benefit, etc to ask to be marry, etc or away to give jewelry, etc with or without its box, etc because pd can be the said box, etc; and combine jewelry, etc with perfume, etc or cologne, etc in the container, etc; and perfume, etc in pd and cologne, etc in container, etc; benefit allowing a women, etc and man, etc cologne, etc to be sold in the same container, etc; and perfume, etc in, etc the container, etc and perfume, or a different, etc perfume, etc in, etc pd, etc. Allowing benefits a women, etc smell different for her, etc man, etc every day, etc; and perfume, etc cologne, etc in container, etc and a company, etc can give samples, etc. Product also define as exercise products, etc; ride your bike, etc and get off and jump rope product, etc in pd, etc. Product also define as picture, etc video, etc sound, etc devices, etc benefit a picture, etc or a video picture, etc, or frame products, etc display, etc in your container pd, etc. Some more UN-obvious text etc, the sport container allows benefit you ride your bike and exercises, etc your body, etc and to relax you reach down to grab form your sport bottle, etc container pd, etc on it bike, etc holder, etc you grab from pd your electronic cigarette, because you are trying to be 100% health.

The winners lotto pd every (benefit) so offer a without, etc product pd come with a free product, a ex may be a free candy bar, etc in the sport, etc container, etc. Furthermore, the kids, etc pd if your kids, etc drink, etc all there juice, etc they get the pd cookie, etc or toy, etc (this just said text not said in other patent about toy in pd and anyway this toy product can be in the pd defender the new pd, etc). more UN obvious new text new product, etc the floating, etc dish, etc product pd, etc which become a bowl, cup plate, etc which can also be use as a candle holder, etc which floats, etc (this one not shown) made of a hollow, etc air tight walls, etc or, etc (made with suitable float-able materials product, etc known, etc in the arts, etc) or made of a blow up materiel product, etc and seal plug, etc by you, etc (like, etc and UN like blow up balls with plug) or float-able product, etc pd, etc package, etc container, etc made by machine, etc and for superiors float-able ability, etc made by computer machining, etc. Said float-able products, etc can also be use to eat out of, etc, drink out of, etc and this said, etc product, etc can pop off, etc slide off, etc by said grooves, etc and said float-able product, etc can be sold apart, etc from it main, etc container, etc; because product, etc come with and without pd, etc and said pd, etc can be with and without product, etc and with and without its, etc container, etc, because all is removable, etc (or not) for said reason, etc of company rights, etc (to also make a cheap, etc new, etc container, etc for companies, etc) and customer, rights etc (may not be able to affordable some product); so therefore have a ice cream float, etc while you float in your pool, etc.

Product also define as float-able soap, etc pd, etc or product, etc. The four, etc food, etc group, etc puzzle pd and product, etc for kids, etc and adult, etc (not shown) said product, etc connects, etc to each other like puzzle, etc, (and by said grooves, etc) have fun to eat and drink, etc all group, etc said groups, etc can also be picture, etc toys, etc words, etc to teach kids, etc to eat, etc better, etc; so therefore for this is also a puzzle, etc, container, etc already fill with food, etc or not, etc and said pd, etc have, etc pull out, etc food, etc group, etc connection to each-other, etc (note this is a kids safe invention so all none edible products, etc will be made kids safe in size and use kids safe materials, etc known in the arts, etc). The present invention can also provide your drink, etc and a place for your news, etc the container, etc pd can hold etc a computer device product carrying news, etc. The present invention can also provide stress, etc release products like stress balls, etc benefits, use ball, etc to with over, etc eat, etc or drinking, etc stead of over smoking, etc use said stress, etc ball, etc to squeeze, etc stress away, note product will be all stress, etc release product. Product also define as train, etc and race car, etc and tracks, etc so there pd, etc can also etc be like tunnel, etc (not shown) and run all the way around, etc the container, etc, like and unlike trains, etc which run through mountain, etc and around mountains, etc these train track, etc product etc and trains, etc and cars, etc are also removable, etc and remember product, etc can hold, etc product, etc;

and some of these said track, etc can connect and connect, etc to its container, etc and to other containers, etc to understand UN-obvious, this text, etc better the track, etc and the train, etc should be seen as using the touch etc (TT), etc (now teaching) said track connect to cooler, etc said train, etc run from cooler, etc to your lazy chair, etc or around your party, etc and said train product, etc bring you a cold, etc drink, etc food, etc from its container cold, etc pd; remember the present invention use all remote control product, etc so said train etc can move to you and bring drink, etc and remember said track product is not need if company, etc do not include it but said train, etc can still bring you your drink etc without product track, etc. The present invention also use all voice control product, etc. Product also define as (not shown) mail package, etc and container, etc which also define as container, etc benefit, take your two, etc boxes, etc and combine them by pd and place in container and pd, etc different, etc package, etc after, etc (or before, etc) your two stamp, etc and send them to your two, etc family member at the same place, etc and at the same time, etc some examples, etc to show advantages, etc one box with pd get there on time together, which two, etc boxes one, etc could get lost, etc but with pd there get together, etc; and can be UN wrap by two, etc people ex, a kids get gift from grandmother, said kids, etc can UN wrap there gifts apart because they are wrap in different package, etc but place in pd and place in the main box, etc in different gift wraps, etc, but note this invention shows advantages, etc for the post mail company also prevent help the lost of a packages going to the same place and they can still place stamps, etc on both, etc package, etc one, etc on main box, etc and one, etc on pd box, etc which benefits the post company and the customer because they get both, etc gifts, etc at the same time and on time and said mail company can place stamps, etc on both, etc box, etc and get both box, etc there at the same time save money on trying to find the lost box, etc; this pd, etc and other paper, etc container, etc can be made with a already made mail box, etc but with a cut out pd shape then seal with a already made paper, etc or plastic, etc pd in the shape of a box, etc with or without a seal on or a already made door on said box shape, etc pd, or without on door because the gift wrap paper, etc can be the door, etc; then seal, etc in said pd by glue, etc or pd etc made by computer machine, etc; said pd, etc can also come with and without product gift wrap paper, etc; tape product, etc, stamps, etc, pens, etc to help the mail company, etc to make more money when selling this in empty, etc container, etc (or not).

Product define as hearing aid product, etc for the bike container, etc and for the robot pd, etc and for the mug container, etc and so on and so on. Product define as two, etc way radio, etc device, etc which allows you talk to some on other, etc talking device, etc for all bike container, etc (not just the one, etc shown in present invention, etc) and said radio, etc product is for the robot, etc pd and so on and so on; ex, use your said radio while riding bike, etc and you are riding around the street and your mom or sister, etc is calling you back home, etc on there two, etc way radio, etc; MULTI-PD'S and products, etc shows why more then one pd, etc can be advantages you etc can have a product etc, your friend, etc can have one, etc and your brother etc can have one, etc; and all of your are talking to each other all pull off, etc from MULTI-PD'S, etc, and so on and so on, etc; many more ex, can be given; and remember all of the (pi) product, etc and pd, etc can become wearable product, etc a quick, etc wear your candy bar, etc or wear your candy bar in, etc a wear-able pd, etc.

Remember also that product, etc of (pi,); etc can be sold also with or without container, etc; or with and without product, etc or even with and without pd, etc to help keep cost down for the customer, and for the customer rights to choice there own product, etc and for company right, to choose the product they want to sell, etc to also help to keep cost down, etc. When said sold apart, etc also means you can buy one, etc and come back later if you wish and buy the other. Product also define as amusement flying saucer (not shown) with, etc pd, etc may or not come with a computer, etc product to take score or came with and without game broads, etc or power games, etc the present invention said saucer, etc is use different from other saucer; and can also be use to hold your snakes, etc food, etc (teaching) and can have other, etc saucers, etc in its pd, etc anew use product, etc define as product, etc a, good ex use the winner, the one who do not drop said saucers get to eat the said snack, etc.

Another UN obvious reason not to why the pd, etc and product, etc should not be limited, the water gun product, etc having a dog food, etc pd, etc and product, etc benefit, play water sports, etc with your dog, etc and feed him, etc or even feed yourself, etc (remember teaching product, etc can have also MULTI-PD'S, etc) with a pd, etc for your food, etc also; note every product, etc can have (or not) MULTI-PD'S, etc or MULTI, etc product, etc within the main container, etc or product, etc or pd, etc a example the water gun product, etc can have water gun, etc within water gun, etc within said water gun, etc can even be laser gun, etc and all toy guns, etc and all projectiles gun, etc; (or not) and within the laser gun can be a drinking container for you, etc this a product, etc within product, etc and said water gun product, etc can also have pd, etc all over said water gun, etc (or not, etc or none, etc) this what this (pi) also does, etc; an example (teaching) of this within text for those who believe this is done for no reason you got the main water gun, etc and your buddy's, etc got the others ones, etc you all have a water, etc gun, etc fight, etc all made etc by machine, etc.

Product water gun, etc shows more advantages, etc ex. Water gun, etc with video game device product, etc pd, etc benefit, etc play in reality and play in the game world; which could be a game, etc water war, etc video game, etc; once again you must place every product, etc (teaching) in, etc every pd, etc; and sometime, etc multiply them, etc within, etc the pd, etc within, etc themselves, etc and multiply, etc the pd, etc because they come off and can be use as bowls, etc and wearable etc (or not; to all said because of company rights, etc and customer, etc rights, etc remember teaching). Note of importance; to this just said text, etc show that the present invention may not use its products, etc all (or not at all) of the time, etc; or may use them in any ways, it wish etc; also note that you can not force some one to use there knowledge, its there choice to use it or not just like it the present invention companies, etc choice and customer choice to use them said pd, etc or product, etc. Another UN-obvious example, why would a cup full with ice, etc be connect to a electronic device, the present invention do not, do not, just use transfer (TT) cool, etc heat, etc to cool, etc food, etc and drink, etc; it also uses it said TT newly to heat, etc and cool, etc any product like and UN like clothes, etc, quick ex, place your hot working glove in the works cooler pd or place your glove, etc in a hot container pd, etc or uses the (TT) to cool, etc your hot cell phone, etc and so on and so on of new uses example, etc.

More UN-obvious text when said use each-other also means each-other containers, etc (because also a container, etc can have a, etc container, etc); a ex, the cooler container, etc can have (or not for already said reasons), mug, etc pd, etc a soda container pd, etc a wine pd, etc (note also when said none means anybody can sell a normal container without a pd and the present invention will do the same also sell normal products; and said none pd, etc means the present invention can use sleeve, etc wrappers, etc label, etc to hold product against, the with and without pd on the container to use TT remember most of all the present invention containers, etc are new with the pd display, etc all but the already fill beverage bottle a ex, soda but the present invention have fig defender, etc for it, etc and the new use sleeve allows the present invention to also do pd, etc soda, etc container, etc.).

The new use product within a, etc product a example, etc in a pd, etc is a, etc chip container product, etc with a, etc candy, etc pd and a candy product and which can have a mint product, etc in its pd, etc; remember this said chip container, in this case is a product itself and can be heated, etc and cooled, etc by TT, etc in its main container, etc). The new use heat, etc reflector, etc sleeve, etc. The present invention is this also in fact, the present invention works with its said benefits, etc can work with the container, etc and its content, etc; and product works with the pd, etc; and works as a place for what ever the customer wish to place in it, there choice, so if they wish to place a bug in there pd its there rights to do so, etc and a company rights to do so; an example when said (product bug) bug, etc in pd; why and how is it also UN-obvious cooperate, etc; the present invention container can also be use as a survivor, etc container, etc using creek water to drink in container, etc and a pd for bug, etc to eat, etc; so you see no matter how UN-obvious they are they cooperate, etc functional, etc for said survivor container, etc; which can also have a sandwich pd, etc and a pd with container with a pd its self for your friend if they need help also; so you see how MULTI-PD'S, etc and multi-products also shows advantage, etc.

Remember this invention is base also on the backward and forward PD'S, etc and products, etc and backward and forward MULTI-PD'S, etc and MULTI-PRODUCTS, etc, which all define as pd and product; For said company uses, etc and for said customer, etc uses, etc. These said product, etc are use when suitable also, but do not, do not limited product, etc to just suitable uses e.g., the sport bottle container, etc can have a suitable product candy bar, etc; but as seen in the product section text the sport bottle container, etc can also have a butter fly pet PD, etc with butter fly pet products, etc in, etc said PD, etc UN-obvious, etc but a real part of the present invention. Note of importance all said MULTI-PD'S etc and all said PD, etc define as pocket department and all said MULTI-PRODUCT'S, etc and all said product, etc define as just product, etc; because the present invention products, etc and PD'S, etc goes backward and forward, etc this is what this invention also do. The end of only this said some more argument section. Product will also be drinks, and containers with food, drinks, etc. and products not mention in this patent and because of the t. tech etc product come with and without pd. And this patent containers is also a place for something like money, candy, condiment etc, and not always a given product will be in pd not just a predetermine pd.

Note that a family size, etc or single size soda etc, can come (or not) with cups, etc mugs, etc plates, etc bowls, etc. Product define as food, etc on a stick, etc and product define as all frozen beverage, etc also on a stick, etc; and product define as all substitute, etc cigarettes, etc. And product define as female, etc pads, etc in the container, etc and female, etc tampons, etc in pd. And to show even more wideness product define as product define as MULTI-VITAMIN'S, etc beverage, etc in the container and food, etc, pills, etc in pd, etc.; and product, etc and pd, etc can have calorie pd, etc can be text, etc on them or on door, etc. Product also define as all glow, etc in the dark, etc product, etc Product define as tear package, etc and tear off closure package, etc and product define as content and define as product and all the likes. Note this patent containers was not made to reuse, (but containers can be made Eco-friendly) which are the containers which you normally throw away like bottles etc, but you can reuse them (no' where in this patent talks about and claims about that this said patent container was made to be reuse) on your own like many people do. Furthermore this patent pocket department finds ways to reduce waste in our land fields by said text and combing product which means less shipment boxes, etc. and PD is a new article of manufacturing.

This patent uses pocket department containers for food, drinks, and the touch tech and storage, etc and other said text in this patent. When said health benefits in this patent means products have combine benefits, etc with already said (others studies; not this patent studies) products benefits and health benefits. See arguments, etc. for more support of benefits, etc. Pocket department and product, etc. made, by machining, and by computer, and by computer machining, etc. note that a product, etc place in, etc a pd, etc said product package if it is a peel-able (or snap on, or slide on lids, etc use as pd, etc door, etc) package to open to have access to its content the present invention will use this said peel-able, etc and pull tab, etc as a door, etc and also acting as a door, this another reason for product will also be seal by glue, etc by weld, etc (interconnecting) into or made not removable from said container pd, etc. All product, etc for the present invention define as all the likes, etc and unlike, etc. All product, etc can be made float able, etc with and without being wearable (not shown) connect, etc by said grooves, etc straps, etc bands, etc to said float-able, etc. Product will also interconnect to said container, etc by pocket department, etc or said touch tech, etc (TT), or by said benefit, etc; and product, etc and pd, etc also define as all newly said not said in other patent, etc and product define as design product. The UN-obvious product, etc note many of the present invention uses, etc is can be UN-obvious but cooperated with and into the invention beyond the invention drawings and its text, etc and is UN-obvious;

an example is given the water gun, etc product, etc have, etc (not shown) dirt pd and dirt, etc product (or not), using the water gun to wet the said dirt product (or you can use your own dirt, etc or product to cooperated with said water gun, etc), to make a mud man and then shoot it; or use said dirt to give yourself advantage over (the player if its one you can play by yourself and shoot the mud man), the other player of the water gun (remember the present invention can have product within it product, etc) by throw dirt up in the air (at your own risk to any product in this invention), so therefore you see how UN-obvious the present invention products, etc and pd, etc can be; but cooperate with each-other through-out the entire present invention (pi) uses, etc (in this case etc, will also be seen as UN obvious) but will cooperate with each-other and connect with one another; so once again (teaching) you must place every product, etc in every pd, etc no matter how UN-obvious it is they will cooperate and connect with one, etc another the invention is just not easy to understand, etc.

Product also define as ice cream in container and ice cream in pd and, all wrapper, etc also define as pd, etc door, etc; and product define as ice cream, etc in the container, etc and soda, etc in pd, etc. Product is so mass that it must be shown as 55a,55b,85, etc to not have none stop drawings, etc; and product, etc and pd, etc can also have many Pd's, etc made, etc in them, etc; a ex. you can also in some cases reach into one, etc pd, etc which will have many Pd's build in it (not shown because of to many drawings, etc or seen as I represent, etc) this text define as pd made all design, etc; and product and its packages, etc and pd is also made (or not) to interlock, etc fit, etc (not shown or seen as I resent, etc) to each-other, etc, and all and container come with and without pd and product etc because pd, etc is also (or not) removable, etc by said grooves, etc or by said (or not) interlocking, etc like said product (or not for the present invention pd, etc and product, etc can also made permanent to said container, etc, a closely fitted statement, etc so therefore either one can be done by company etc so you will be infringe against there rights if either one, etc is done, etc. by others which is not this patent; if you only want to do one, etc of them this is want this patent do for said company, etc for said reason, etc) will also be made all sizes, etc all shapes, etc all designs, etc and pd, etc contents, etc can be equal, etc or less, etc or more then its container, etc content, etc made by machine, etc.

The PI states that each container in the PI can use each-other contents, use each other benefits, use each other PD, etc no matter how UN-obvious it may appear, a ex is given the bike container, etc may have wine contents, etc in the container and a comb, etc in PD, etc to use said comb for when hair mess up from riding said bike on a wind day, etc, so therefore you must place every contents, etc and every products, etc in each of the PI container, etc and PD, etc, and product, etc (note they can use each-other, etc or not according to the PI text, etc); and furthermore there can be one, etc or more, etc or none, etc products, etc and pd, etc on said PI containers, etc, because the PI come with and without said container, etc (because the product with PD, etc can be only sold, etc) because of said texts and because to (benefits) give customer of the PI containers, etc the rights to choice there own brands, etc flavors, etc or discount rights, etc and because of said TT and benefits, etc and said TT works with and without PD, etc; and to give companies rights, etc and the customer rights, etc. The present invention (PI) could make a list from here to all the way around the world of containers, etc and product, etc and combination of products, etc and container, etc and the present invention still would be able to list them all, so therefore you must realize the list and combination are endless and UN obvious, etc but you can walk down your super market and product market alleys each product you see can be the present invention product, etc,

the present invention concede to this. (Note some containers, etc and products will come with a how to use text on, etc container, etc). The present invention could have (or not) 20, etc or more or less or none product, etc in one or many pd, etc or products etc, The present invention is made to be a closely fitted description which is used to help define and separate it self from other patents; how can a invention be if you do not known what you are defining as the invention, guessing and something add is guessing; to invent is to know, what you are inventing, this is what this patent does; it define itself clearly, and is to the point. All the present invention products, etc defines as all there likes and UN-like, etc. PD also define as made out of the same materials as the container materials, etc, so therefore the container materials is made out of insulating materials then the PD can be made out of said materials, etc (or not can be a molded same shape PD, etc place in said PD also, etc or a insulate PD can be molded or place removable or not; etc or, made by machining, etc into a none insulate container, etc).

The PI uses also container content to cool or heat, etc PD content, etc and the PI uses a, etc hot, etc or cold, etc PD product, etc in PD to heat, etc or cold, etc (note of importance you must understand this as well, a closely fitted statement, etc) container contents, or product uses its own heat or coolness, etc to keep cooler, etc or hot longer, etc by PD having new insulating wrapper, etc or insulating doors, etc (note use only, etc insulating door, etc when you want to use PD content to cool etc container content with transfer energy, etc); and PD inside, etc can also made with known in the arts, etc said insulating materials, etc or PD can have a already made insulating container in, etc, or made in, etc said PD; so when said product, etc heat, etc container content, etc this means that this invention is using, etc, now the (also define as TT) reverse touch tech, etc (a example text, container content, (now reverse use PD in the place of said container) of cold, etc or hot, etc uses to heat, etc or cool, etc PD content, etc and container content, etc);

further saying the inside of the PD will also be made with stay cool, etc and neutral materials, etc known in the arts, etc; and the PI PD, etc will not be for just food, etc it will also be for cooling, etc and heating device, etc (some not shown). All said product, etc define as product and all the likes and product, etc define as all accessories for all products said in the PI and all the like for them as well, etc; an example a, etc laser, etc gun, etc product, etc its, etc likes products, etc also define as laser, etc gun, etc vest, etc and parts and products, etc for the likes, etc and unlike, etc (note in this case of laser gun product, etc place all products in its place to understand this texts fully, so therefore in this case replace, etc with all others said, etc products in the PI, etc). The End of This Description Product Section.

FIG. 14 to 15 shows medicine bottle container 61 with medicine 80, etc. (liquid medicine, cold medicine, cough medicine, allergy medicine, medicines, mouth wash, rinses, tooth pastes, etc.) In container. Preferred also because of PD which holds, stores, medicine, etc. in PD; with said 50a to 50e PD, etc; and shows child safety top 62, screw on to container and show pin 63 with spring 64. Which both are made inside, etc of container material and FIG. 14 shows how with PD hinge door, which shows the back part of the medicine package, etc product 82, etc with foil side to pop out medicine, etc from package; and show how medicine package 82, etc. (etc. will be any product package like floss package, etc.) can be hinge on or build on, or build in, etc, PD, etc; with the see through clear pocket department hinge door 81 and the medicine package 82, etc can be more then one package product, etc inside of PD; said product can be with container by product touch container by wrapper, by label, (which will also be a PD door said label, etc) etc. because of the t. tech. Furthermore, FIG. 15 said container shows child safety top 62 is screw off container which shows pin 63 with spring 64, and fig shows how pin 63 release out of hole in PD 65b and raise out of the see though clear PD hinge door 81 and its hole 65c in hinge door, and through container hole 65a which is where container, child safety top 62 can screw on and off of container and when said top 62 is off of container, this UN lock the PD and give access to said 82 inside of PD; and fig shows plastic bubble domes 84 made on the front part of said medicine package 82, etc; and fig shows pills product 85, etc which could also be medicine; cough drops; capsule; caplets; tabs vitamins; mints; gums; gummy pills, etc for pocket department, etc and fig shows said 85 pop out of said dome 84, and fig shows open to contents 83; Always remember product section teaching.

FIG. 16 shows the bag container 86 (will also be a pouch for drink, etc known in the arts, etc which can have a adhesive same material, etc as said pouch known in the arts attach to it, but the top part of said same material can be made to resealable materiel, etc to remove, etc or place product in it, etc made by machine, etc product come with is optional can be candy bar, fruit bar, etc) for chips 55c, etc. (like carrot, salad, fruit, vegetables, food product, etc.) in container, etc. Preferred also because the storage PD 87, etc with dips 55b, etc, like salad dressing, food product, product etc. in PD, etc; this PD also can be made out of the same material, etc as container; PD are also made on the inside, outside, etc and with said containers and all designs, etc will be used to make PD, product, and PD doors, etc. by machining, etc; this said bag container also provides away to hold bag and dip at the same time (which is a benefit), additional, FIG. 16 shows the connector removable pd 88; and FIG. 16 also shows hole slot 95b (later, will be said about slide up and down handle rod 95a made on said 88 but seen in FIG. 20); storage pocket department 87, etc is also preferred because of the ability to dip chips etc. and hold container at the same time and this PD can be made out of the same material, etc as bag and mold, etc into bag, or seal into bag, etc (all PD, etc are made by machine, etc.), this said PD and all PD will be used in many different ways beside as a dip fill PD to dip chips etc.

FIGS. 17 and 18 is the many ways made, the O-circle container 92 for chips 55c, etc (which could be also ice cream, soda, drinks, candy, etc) in container, etc, preferred also because of the lid top dipping pocket department 93, etc, which also allows you to hold container and dip chips, etc at the same time, and fig. shows how said PD 93 stores, holds, etc, dip's 55b, etc (salad dressing, candy, drink, ice cream, etc.), and fig shows said PD 93 arrows in; FIG. 17 and shows how said PD 93 open by pulling up, etc or by lifting up, etc and by turning, etc said PD 93, which is shown open in FIG. 18, this fig movements is accomplish with the pin rod trap bar 94a which is connected to said PD 93, which said PD 93 with it said bar 94a connect to tunnel slot hole 94b; and said bar 94a which show it parallel across bar, it is bigger, etc so it fits inside said hole 94b (but some fit so said PD 93 do not come off, etc of container), and fig shows said 94a, vertical part. FIG. 19 shows the also preferred pull out cup door pocket department 96, and this PD shows how all pocket department's, etc can change designs, etc; and can allow you to dip and hold container at the same time; fig also shows 55b and 55c.

FIG. 20 preferred also shows said container 92, which the design show some changes (remember pocket department, etc will be made all designs, shape, sizes, etc. and product and PD and wrappers, etc, will be made out of water proof materials, etc and wax, etc to also prevent and stop water build up, etc from container contents, etc) fig also shows the connector removable PD 88 (which this pd will be used by all containers in and for this patent) with its said handle rod 95a which slide down, etc and connects to hole slot 95b, so this allow you to hold container and dip, etc at the same time; and container shows dips 55b, etc and chips 55c etc; furthermore these O-circle containers, etc will also be beverage containers, etc made the same size, etc as cans, bottles, etc and not, etc the same size, etc of said containers, etc; so these said o-circle containers, etc can be sold in beverage machines, etc with soda etc in, etc the containers, etc and ice cream, etc in pd, etc; this process will also be new and unusual, because normally soda, etc is only sold in said machine, so this is a benefit (advantage). Always remember product section teaching.

FIG. 21 to 22 preferred also and shows the I representation container 98 which this container will represent all containers in this patent and for this patent and also shows how this patent and it claims can encompass future containers, and all containers out there now. This said container 98 keeps patent from having thousands or more of containers in patent drawings etc, FIG. 21 also shows extracted PD 231 this PD will be made all materials like paper, materials, etc glass, etc plastic, etc (which you can feel heat, etc or cold, etc through also paper cups, etc; said PD also materials can be and will be glass, plastic, all materials will be used, which can use the t. tech and do not use the t. tech), also fig shows this said PD, etc can just touching container and using the t. tech (PD using the t. tech, etc will also used all sealing materials for PD and sealing doors, etc which help keep PD hot or cold, etc; said PD 231 also shows said 55b, using t. tech this PD will also be for all containers and fig shows the UN-removable product 770, and fig shows; the hot, etc and cold, etc touch devices (off the shelf or known in the arts devices, etc which cools, etc and heats, etc food, etc drinks, etc but in this case will also be for PD contents, etc what ever PD content is to use said devices, etc because remember the PI is for more then just food, etc), etc CHT materials product 761, etc

(could be a combination of both, etc said cold or hot, etc devices, etc) and can be, etc ((Or not)) products which cooks, etc refrigerants food, etc drinks, etc products, etc for this PI (remember just touching, etc the container, etc with hot or cold contents, etc is using the touch tech); and FIG. 21 also shows cold liquid or ice 99, etc (which etc in this case, etc could be trash can, bottles, any product, etc etc) or anything of cold contents etc. FIG. 22 shows hot liquid 100, etc or anything of hot contents, etc in container, etc or any hot product contents, etc; additional FIGS. 21 and 22 also shows the representation wrapper/label, etc door 101; which also holds product to hot or cold container, or acts as door, and fig shows how even without PD product will still use the t. tech cooling and heating product with container contents of cold or heat, etc. Always remember product section teaching. Always remember product section teaching, (I no the PI repeated itself on purpose, etc lean the PI) which also stating keep PI from having thousand, etc of drawings, etc and text, etc.

FIG. 22 also shows structure PD 107a (this PD shown in a candy sucker design, but could be any design), this PD shows also how PD will be made any design, shape, structures, dimension, etc. see this fig PD shape, etc) and fig shows how PD do not have a door and shows how structure PD 107a, sizes, shapes, etc will hold PD contents even without a, etc door (see FIG. 22, structure product 107b shown in a candy sucker design product, etc which will also be any design product, etc) by designing PD door and it content together, etc, which will allow PD and it content to fit, snap, to pop, engineer-together, etc together without the need of a wrapper, etc (an ex product sucker fits container sucker shape pd, etc interlocking design, etc; no door; no wrapper, etc made by machine, etc); FIGS. 21 and 22 also shows representation deep PD 103, which have a deep pocket, this pd bottom part is shown deep with hidden lines this pd can also hold ice etc with and without product falling out of pd so, there for pd can also cool etc itself with and without container content falling out of said pd (pd cool etc itself with other said text said like said ice replacement, etc). And this said deep PD can also (or not) have net holes, etc (see 103 and imagine said holes, etc connected to said floor and connected tunnel, etc and to spouts, etc) like floor, etc and/or, etc ice replacement floors, etc, which is made by suitable; machining in the arts, etc, can also have tube tunnels PD, etc (said tube tunnel PD can be rigid or flexible materials, etc rubber, etc plastic, etc metal, etc, get the point any materials, etc) to drain melted ice, etc to said tunnels which can be connected to spouts, etc which can connected to containers, etc; or PD, etc or not can be also just connected to container, etc.

FIG. 22 also shows the split PD 650 which is so thin, etc you can almost not, etc see it, PD look like a thin, etc narrow, etc slot mold impression imprint, etc on a container, etc (see normal small or large drinking containers like soda bottle etc, not these PI containers; to see how this PD will appear on a patent container, UN-obvious) this PD stores product by push, etc product inside of said split or pulling product out of it, will also be done to remove product from said pd like squeezing container, etc (pd made all design etc and made by machining, etc this and this PD can have a, etc door molded, etc made, etc to it which flex-able and with a, etc slits slot as its open-end part to PD contents, etc). always remember product section teaching, etc. FIG. 21 can also be stuff animals, etc with PD or removable PD, etc also made with a, etc TV, etc candy, etc making a, etc candy belly bear, etc; or a, etc TV, etc belly, etc bear, etc, remember this PI teaching, etc.

The I representation container can also be containers, etc can be divide, which can disconnect and connected by thread, connection in half's, etc (which said divider parts, etc can also be pull apart, snap apart, etc said divider container, etc or PD, etc container now separated parts can have pull tabs or pull off, etc metal, lids etc or screw off tops, etc known in the arts, etc which will hold in said dividers disconnect containers, etc contents in divider parts, etc) in parts, etc with PD, etc or PD'S, etc on them, etc this said container, etc can hold in its, etc disconnected parts food, etc the top, etc of said divider disconnected part (said disconnected parts which also hold drinks, etc (can be reuse as home cup, etc because this container can be a soda, etc container, etc,) and in the bottom, etc part drinks, etc and in there PD'S, etc, can hold, etc products, etc other then food, etc or hold food, etc; all made by machining, etc; remember the PI teaching, etc. The representation shows also the I representation product 255, which shown as a wearable ring; but can be any wear product, etc float-able product, etc or any product, etc, it can also represent products, etc not seen in the PI;

but is apart of the PI, said 255 product shown can be also candy, etc or a, etc container connect to the band (by said adhesive, etc weld, etc grooves, etc) ring part shown which can also be a, etc container (or a, etc candy or food, etc connect to it, etc) can have flavor powers, etc drinks, etc foodstuff, etc candy, etc and product, etc which this said ring product, etc can have also a, etc same, etc shape as it PD, etc or not, this said candy connection said product can be also dip, etc into container contents, etc to suck contents off of it, etc, or said candy, etc can be eating, etc, and can have flavor agents (which can also be know as the soda ring, etc) add to it mix when made like other said products, etc in PI, etc

FIG. 23 shows preferred the cap top lid container pocket department 102a which can also holds, stores, also have dip ability, etc, and use t. tech also this PD hold (and packages, etc can be or will be build into this said PD, etc) packages like floss packages etc and this PD, etc and all PD will be made all sizes, shapes, etc and have related and different functions, etc, fig also shows the bubble storage dome container 102b of the cap top lid container PD with 85 pills, 85 etc (which can also be hard candy, cake, pie, etc) shown inside of 102b, and fig shows dome top door 102c, which snap, etc (which also shows easy access, etc to its contents, etc) close, etc, and can also be made to be a screw on cap, etc see part 102c (not shows) but can be a top closure with threads and said 102a can have threads to expect it, etc; all made by machine, etc, furthermore, some are made to not touch container contents, etc (but, some are made to touch container content, etc), and also made to store, hold etc. furthermore, some PD doors spins open and moves product to PD open part to remove said product out of said pocket department; this said movement is like the doors you use at hotels, with spinning doors which more then one person can be inside of, etc (PD also can have more then one product inside of pd). Pocket department will also be made out of all container materials, etc known in the arts, etc that is suitable to use, etc.

Pocket department also provide away for beverage companies, etc to enter into the food companies, etc business without having food etc; this is also the reason for the with and without statement in this patent text application, which also explain why also pocket department come empty, (which will be UN-obvious and UN-obvious because of the computer designs UN-obvious shapes; and the UN-obvious interlocking pocket departments and products, etc.) Always remember product section teaching, etc. More preferred embodiment will now be illustrated starting with FIG. 24 show the cooler container with different kinds of pocket departments, etc which shows the same shape CH-pocket department 300, which can also be a pop out ice replacement product shape PD; which can be the same shape of any product ex, soda bottle, etc cool, etc or heat any product, etc; and said PD can be made out suitable materials known in the arts, etc and any suitable materials know in the arts, etc to made the pop, etc out ice replacement, etc shape PD; and FIG. 24 shows the push door 301 on a display PD (said door can be made to pull out or slide out and can be made out of said replacement material, etc) connect to container by swing pins 302.

FIG. 25 shows the edible molded closure product which can be connect to any container or place in any PD, and fig shows suck hole 303 allow you to drink container content, etc out of any container (can also be plug with edible content, etc) also is shown is edible thread part 306a (hard candy, etc materiel which is suitable to use) shown thread on to bottle container 58, which could be made also to push on, etc to said any container; option is the closure helper thread cap 306c, said helper, help to eat, to lick, etc all of said edible (candy) off of said container easier said helper surface part smooth, etc made it easier to eat, etc candy, etc off container, etc; said helper can be made out of the same materiel as the container materiel, etc; or made out of suitable, safe plastic materiel or bio-gradable materiel, and can be also made to slip, etc over said edible thread part or can be mold on to said edible part, etc but said helper can be tread, etc to said container; fig shows also top edible (hard candy, etc) part 307 of said closure product, said top edible part can have add into the mix of the edible materiel soda flavor agent and beverage agents and trade secret agent, flavor agents, vitamins, energy agents, etc when the edible (candy, etc) materials is being made and molded by machine, etc when the candy batch, etc is being mix with ingredients add in flavors agents, etc or real beverages, etc,

and said top edible part can be made all designs, and shapes like shape, etc of beverage container, etc shape, etc of animals, etc (not shown) any shape, etc. When said flavor a, etc container content can be the same content like the soda sucker, etc or soda candy, etc or soda candy bar, etc or the beverage sucker, etc or the beverage candy, etc or the beverage edible product, etc which is made before, etc the candy, etc is made, etc and is molded. Always remember product section teaching.

FIG. 26 shows the different kinds of design edible sucker products, and fig also shows edible treat 304 (candy, etc) and shows connect or mold to said edible treat, totally edible straw 305 (candy, etc); which would made a 100% edible sucker or straw, etc; and said straw could just be a stick or a none edible straw place in a hollow mold hole in said edible treat when being mold, etc by machine, etc; also fig shows design edible (candy) PD 308 also mold in to edible product when being molded by machines, etc said PD hold nuts, etc other types of candy, etc powder candy, etc, mold close with candy, etc or use wrapper to seal this PD content in, etc; and fig shows none edible straw 309 use to drink from, etc by placing edible sucker, etc into content or use to suck content out of said none edible straw; and fig shows straw plug 310 use to close said none edible straw by adhesive paper, etc or plug just fitting together with said straw, etc; and fig show product x 311 in said straw could be any product like energy powder agents, pills, meats, crackers, bubble gum, dry fruits, etc candy, etc; and flavor agents to change, etc the flavor of the container content, etc it can be use with, etc all done by machines, etc and load into said straw, etc by said machine, etc; and fig shows double, etc side (candy, etc) edible product made with none edible straw, etc or edible straw, etc and made with said flavor agents, etc and can be even made with said drink holes, etc to drink from any container contents, etc. Always remember product section teaching.

FIG. 26 also shows content-ED zip lock, etc lock wrapper 444a, etc shown with, WP-hole optional 446 for sucker product, etc stick, etc part; and see ED-zipper 445, which closes and open said lock wrapper and can be also made to open, etc by known resealable snaps, etc and color changing snap, etc and close, etc by said zip, etc 444a, and fig shows without hole, etc the content ED-zip lock, etc lock wrapper 444b, can hold chips, etc for PD, etc, this product can be made like a zip lock bag but uses difference see sucker product, etc and can have a, etc hole, and place product in and out of it.

FIG. 27 shows the water gun product and shows how any product can be for any container, etc; fig shows the sport bottle container 23 (for this fig sport container shown clear also) and shows b-water, etc gun, etc 313 which is use to drink out of or spray (also made by machine, etc and made out of safe materials in the arts like safe materials you make cups, etc beverage container out of, etc) your self or other, etc use container, etc content, etc and water gun product, etc can come with or with out hose, etc and said gun can be any toy, etc gun, etc; and said water gun, etc shown connect to hose 314a which connect to water gun straw 314b which water suck through to shoot water out of said gun but now when said hose is connected to said gun straw and connect to container and its contents its now suck water, etc from said container, etc, fig also shows same, etc shape, etc water, etc gun, etc PD 315 which also hold said water gun, etc, and fig shows the extra stuff PD, and the fig shows the fan connector, etc 317 which connect said hose, etc said fan also can be a power fan a combination, etc fan light, etc, blow air and spray water, etc; and fig shows the nozzle connector, etc 318 which connect to said hose product, etc and spray, etc or pour water, etc; note hose hole (see where hose enter into gun) shown on said gun, can have a, etc (not shown) resealable plug to use said gun without said hose product; and said gun shows at the top a, etc hole for pouring, etc water, etc into said gun, etc and said hose, etc can be retractable, etc and can have a, etc hose PD;

and said gun, etc can connect to bike handle bar, etc (see bottom, etc of said water, etc gun, etc; and see product section for how any product can connect to you or any product, etc), so therefore the said cooler container, etc can have the same shape, etc for any container, etc like any beverage container, etc any product, etc shape, etc and some of these said same shapes, etc will or can have insulating materials, etc in the known in the arts, etc and remember the present invention teaching in product section, etc. FIG. 28 shows the all holder container, etc with PD to use or not the touch tech and fig shows the backpack beverage bag container holder and fig shows the all holder container 319 and shows the holder PD 320 (all made by machines, etc from type of suitable materials, etc like aluminum, but this materiel good for TT; etc stainless steel, but this materiel good for TT; etc plastics, etc), the present invention allows not just the uses of a, etc container with hot or cold, etc content with a, etc PD to cool, etc said PD content; it also allows the container content, etc to cool or heat, etc product with and with out PD;

because the TT works without PD see this fig container in this fig drawing it as no PD, but said the all holder do have PD to use said TT by using TT from said container without PD but this said container have content of cold, etc or hot, etc contents, etc, to cool, etc said holder PD. Fig also shows the backpack beverage bag container holder 338 and fig shows the hose 314 and shows the filler section PD 337 can be fill with beverage cans, etc ice, etc ice replacement package, etc see this fig how the join together PD using TT, this said join PD shown on said section PD,

FIG. 29 shows the container using a, etc new use sleeve, etc or wrapper, etc or label, etc and newly uses as a, etc slide, etc up and down, etc door, etc, and fig shows slider container 321; with beverage, etc like vitamins, etc soda, etc milk, etc; and fig shows the new use sleeves, etc 323 (the new use sleeve is the 60% post-consumer fiber, etc and all the like, etc the present invention will use different) shows slide up, etc and down, etc label, etc which can be also made smaller, etc save company, etc even more money, etc and made smaller, etc to slide up, etc to close PD and slide down, etc to open said PD; the can container, etc can also be made in this fig container shape, etc by molding, etc by machining, etc to also use the new sleeve the can container or any container even without this said shape, etc; and this said new sleeve materiel, etc can be made into any shape etc and place under container and said sleeve materiel uses as a, etc door, etc, adhesive to can, etc container, etc. Note the present invention container PD, etc container, etc are also design, etc made, etc in a way to not change the form of the container old design allowing package, to be place in machine, etc racks, etc the way they was always place said company can also save more because this, etc slider container PD do not change already machine in away which cause major changes, etc. FIG. 29 also shows adhesive SC 322 allowing you to place your own, etc candy bar, etc, your own food, etc your own drink, etc in PD.

FIG. 30 shows product buttons and products for promoting; and for other needs, and reasons, etc see drawing, etc and the product section, etc product buttons, etc can be button text, etc picture, etc video, etc video devices product, etc; text, etc picture, etc and can be place on your clothes, etc bands, etc hand bands, etc hats, etc toys, etc containers, etc all merchandise. And said drawings shows wrist band with any word, etc on it and drawings shows alcohol tester's product and any and all electronics tester, etc all tester pair with container with alcohol, etc note product will be more then what shown in drawn. (which could also come with a warn to drink at home, etc and drink and drive). Remember product can be for any container and remember product section, etc teaching, etc.

FIG. 31 shows the sport team/worker container 326 and shows display PD 325 for players, etc nuts, etc pickle juices, etc; and if container have hot, etc content (or not) PD content can be for workers, etc or sport football team, etc gloves, etc using touch tech, etc; and fig shows the section slot, etc/angle PD 324 a new use display pd in a slot MULTI-PD'S fig, design also shows MULTI-sport bottle 23 which can be any container like the bottle container 58 product, etc or any product like chips, etc candy, etc this said section slot pd can also use TT and can be angle into, etc said team container; remember product section teaching, etc. FIG. 32 shows the different kinds of container with different uses PD, etc fig shows the grip beverage, etc container 328 and the grip wrap PD 327 this wrap design PD shows how container content can wrap around product to use TT, etc, said 328 shows no PD door just slide, etc your product (can be chips, etc popcorn, etc chip, etc game boards, etc candy, etc) inside, etc from top, etc this PD and all PD are made by machine, etc and made all designs, etc. Remember product section teaching, etc. FIG. 32 also shows label door-on any container, etc 329 which can be resealable, some made with said heat re-flexing materiel and stay cool, etc and some door, etc will only be insulate and not, etc PD inside part, etc and said door shown ope4n with product inside of it, this fig also shows adhesive SC 322 stick tape, etc use to close said label door, etc and use to stick to any product suitable see fig how said 322 is in more then one location, etc to also use said TT.

FIG. 32 also shows the interlocking plug PD 330 can be made on any container, etc by machine, etc; said plug PD mold, etc in PD and plug, etc also molded, etc into container, etc and fig shows female plugs 331 connect to product male plugs 332 made on product or product package, etc which snap, etc interlock, etc with said 330 which can also interlock, etc with containers, etc chips, etc candy bar, etc game, etc cell phones, etc puzzle, etc and these package, etc can use the heat reflex materials 333, and this fig can a deep PD design (not shown) which is design where it also do not need a door, etc. FIG. 32 also shows the tear tab PD 334a which is a child, etc proof PD, etc (and help with dis-honest customers, etc when the container closure is turn, etc and the cap top tab 334c is broken then the PD tab 334b is also broken to allow access to container and PD contents, etc both PD and container content can be the same or not; and fig shows the plastic, etc hinge door 335 this fig also shows the tear package, etc 336 or any packages, etc or container or package that tear and open, etc. FIG. 32 also shows the spinning hotel door PD 372 (see drawing) said spinning door made like hotel doors drawing can be female and male pins, etc or shown as 436 and 437 top part connecting said door (not all is shown in drawings) and 436 and 437 bottom part connecting said hotel door to container, etc these parts are use for to spin, etc said door; then place in this PD made all designs, etc product of one kind or many kinds, etc move said door gain access to said PD content, etc all made by machine, etc

FIG. 33 shows the different touch tech's held by model 121610, see drawing, a test you can do yourself at your own risk, said model holds in one hand hot content in a container, and hold in the other hand ice, or cold content in a container. FIG. 34 shows the box container, etc with contents, etc in container, etc and contents, etc in PD, etc see drawing, fig shows cereal box, etc (could be other product besides cereal); and shows a clear display door PD, etc and in this said PD can be “on the go milk and cereal packages”, etc; or different cereals, etc; or new test brands packages, etc; or dry (or not dry) berry's, etc packages, etc in PD; uses with or not with container contents, etc or use said berry's, etc as a snack, etc; (note remember product section) the milk packages, can also be power milk, etc you can add water, etc to; or packages can be with add vitamins, etc or add brown sugar, etc; or honey packages, etc;

furthermore, milk package, etc allows away to have milk with your cereal even when you run out of liquid milk, etc do not need to run to the store, etc use plain water, etc and the present invention can provide free packages, etc of milk for when you have no money for liquid milk, etc or add vitamins, etc package dry, etc milk, etc to your already liquid milk, etc; so therefore display PD, etc will show advantages, etc then just placing product packages, etc in with box, etc container contents, etc; which do not allow you the reader (customer) to see said packages in said box, etc seeing product packages, etc influence buyer more to buy product; so therefore display PD, etc shows advantages, etc more advantages, etc will be said later, etc this FIG. 33 can be made also by placing, etc already made PD (said PD, etc could be plastic, etc or paper, etc materials or suit materials for box, etc containers, etc) with and without door made by machine, etc and sealing by adhesive, etc into said box container, etc or said box container, etc and said PD made by computer machine, etc.

FIG. 35 shows MULTI-PD'S container with MULTI-PRODUCTS and product shows PD and product, etc and fig shows stack-able products, etc container; and fig shows the same MULTI-content, etc family container 340a style, which contents can be cherry juice, etc milk, etc soda, etc any beverage, etc or not just beverage can be also dry and none dry fruits, etc and fig shows the MULTI-PRODUCT, 342 etc which also shows a, etc product, etc with a, etc product, etc and 342 shows how it can slide out, remove out, pop out, etc bigger main container said 340; and said MULTI-PRODUCT, etc can be the same contents, etc as said family container contents, etc (or not); and fig shows within product 343 which can have dry fruits, etc (or have peas, etc corn, etc and can be can goods, etc) and its container the MULTI-PRODUCT, 342 can have juice, etc (or can have pea, etc corn, etc remember the present invention product can be sold apart and its main container contents can be different from it PD, etc and these containers, etc can be also made of bio-materials, etc like bio-plastics, etc); and the fig shows the shape fit container PD 341 which connect to said 342 by slide out, etc or by removing out, or by pop out, etc; (all product, etc made by machine, etc to connect, etc interlock, etc to container, and PD, etc) and fig shows stack products 344, etc shown stack in 340, said stack product contents can be the same as said main container or can be juice, chips, etc nut, etc and said stack product, etc container can have a, etc PD, etc itself, etc. and said stack product, etc can be angle in any direction, etc and place anywhere on, etc said main container, etc.

FIG. 36 show the different cap top's, that can be use together or use apart, etc and fig shows the MULTI-PD top 348 which can also hold, etc many different products, etc and you can drink out of it, etc and you can drink, etc from the container it connect to without dis-connecting it from said container and top 348 shows easy access to it content, etc without removing it from its container; see the MULTI-flip doors, 347 made to (347 not shown can also be made screws, etc off, etc uses screw caps, etc or one screw cap which allows access to all said domes, etc) snap open, etc; or pull tabs, etc (all the present invention container, etc PD, etc and made all sizes, etc shape, etc and designs, etc and is also made by machine, etc); and the MULTI-PD top shows the MULTI-DOME PD 349, etc can be made long to use TT or can be made short to not use TT, etc; and the fig shows the dome hole 354 which (and said hole, etc do not need to be uses be made on said 349) can allow you to drink out of it or mix form it (remember all products, etc and all parts, etc and all PD, etc can be MULTIPLIES, etc and made all sizes, etc shapes, etc; and made all design, etc and placement of all parts, etc and product, etc and PD, etc can place any where, etc on container, etc).

FIG. 36 also shows the share caps 353 which allows you to pull, etc (could be twist off, etc) one off and give to your friend or family, etc or use them as shot drinks, etc or uses as one cap or company can have one cap on there container, etc or many caps, etc or uses said cap for new flavor drinks or food, etc from beverage, etc or food companies, etc and this fig shows the cap top cap 350a shown with the tamper tab seal; and said share caps shows flip cap 355 shows quick access and made to snap together, etc to close, etc which also you to use its content now and use the container content later this is also a new use, etc (always remember product section teaching this said 349, etc can also be for plants and animals product, etc) different from prior art;

also shows outside cap threads 351 to connect caps together, etc (note cap, etc can fit, etc or snap, etc together also) and see under threads 352 which also connect caps together and connect cap to container, etc see drawing, etc; and remember the cap top, etc and any of the present invention product, etc container, etc can come with and without product, etc, for to keep cost down, etc and for customer rights, etc; and fig shows clip on 356 (remember any product, etc can be wearable, etc) allows to wear your, etc (remember also for animals, etc; and remember and remember wearable product, etc can connect to any product, etc; and wearable products, etc can be bands connect by weld or by adhesive or made to product, etc or by magnetic connection, etc grooves connection, etc not just clip on's, etc) drink, etc or food, etc or pills, etc any product, etc. FIG. 36 also shows the float-product 345, etc shown as a top with no said dome (but can have, etc and can be made with cook-able materials, etc or from plastic, etc when not made to cook with, etc and made to place in the microwave, etc oven, etc or use as a, etc blow, etc or can be made to wearable, etc, or none of all said, etc this present invention can be or not a, etc MULTI-USE, etc invention, etc which can go backward and forward with its parts, etc products, etc PD, etc materials, etc remember teaching) use to drink from, etc eat from, etc or pour in to it, etc;

and fig shows the float pocket 346 shows a, etc air like pocket to float this product or any product (remember the present invention will also use all know in the arts, etc materials, etc and products which floats, etc also) and fig shows (see drawing, etc) thread ring 350b see threads inside, etc said ring to screw on to any container or screw on to its container allows you to eat, etc from it and drink from container, etc but said ring hold 345, etc to container, etc; and fig shows the wine stopper 366, with dome PD long or made short, etc; which can be connect to a wine cork (see drawing connect by plug, etc adhesive, etc) and shows the tip cork part 367 insert into container (note pull off 366 to use tool to UN-cork bottle, etc or said wine stopper can be made from one part all safe materiel suitable like safe plastic, etc to plug bottle, etc; not shown). Fig also shows the tube slice top PD 369 see drawings show with bottom seal option and shown with threads to connect to the middle tube part 370 with punch lid, etc you tear through, etc (could also be peel off lid, etc) to have access to said tube content, etc and bottom part of said middle tube can be also seal, etc and shows the slice tip 371 and drawing shows threads to connect to said middle tube bottom part, etc; and also show with said punch lid, etc; this tube slice top PD holds products, etc in different section, etc (or not, remember teaching this said slice top PD can be also one tube PD, etc).

FIG. 36 also shows the flip cap top straw 465 which now allows you to use said dome as a straw inside, etc or outside of container, etc; and fig shows the top cap screw threads 394 and without (peel off, etc can be more then a cover like a twist off top, etc a pull off tab, etc) seal cover 393, etc flip and connect said 465 to said threads 394 to bottle threads 396; or connect said 396 to threads under dome 395, when not using as a, etc straw; you can also use said cap with container content and said dome can be use for food product, etc; also note when you see one hole, etc part, etc it can be or not be MULTIPLY, etc, or not, or can be none, etc said parts, etc said PD'S, etc said products, etc and can use each-other parts, etc PD'S, etc, materials, etc so therefore said hole can come with a plug, etc; this way should also be seen as company choice to save money, etc remember or lean teaching, etc; in product section, etc.

FIG. 37 shows the fits anybody product container 379 which shows the fits anybody PD 380 this PD come with and without product, and is made to connect to the shapes, etc of already packages, etc an example already made product fig also shows the cup cake product 381, etc (could be any already made product to fit a PD made to fit, etc already made product). FIG. 38 shows family size container with PD'S, etc and shows stack cups 383, etc (which can also be plates, etc bowls, etc containers, etc filled or not with contents, etc); and fig shows said family size container 340b style and fig shows how said family container, etc, and said cups, etc can stack next, etc to each-other, etc on, etc store shelve, etc; and said cups, etc can come free, etc with said family size container, etc and also be place in said family PD or sold apart, etc this shows advantages, etc allow cups etc with your drink even if you do not have a cup, etc and these said stack-able product, etc can be place any where on said container, etc and can come with the ounce's, etc on them, etc and show how many cups, etc it would take to drink said family contents, etc; so the present invention allows you to go home, etc camping, etc to the park, etc and party without the need for cups the present invention have them for you, etc; and fig shows the family size container 340c jug styles, etc with star shape PD and the jug, etc with MULTI-PD'S and products, etc and the jug, etc with no PD which shows how the present invention will also use product with out PD this product can be place in the keg, etc PD (not shown).

FIG. 39 shows the BNF'S starting with BNF1, which shows MULTI-PD'S containers, etc in different kinds, etc and fig shows the MULTI container (main container) contents 385; and shows the MULTI-mouth PD 388; and shows the MULTI door 389 some shown open and could be pull tabs, etc or seal cover, not just a door, etc (note PD, etc can be place on the outside, etc of container, etc and remember any of the present invention PD, etc can be made water proof use all suitable, etc materials known in the arts, etc and can use all water proof packages, etc containers, etc wraps, etc bags, etc also remember teaching, etc); and fig shows loose product pills, etc PD 384, etc can be any product, etc when said loose tear packages, etc shows advantages over loose pills, etc said packages keeps dirt, etc germs, etc and if you place loose pill, etc in your pants pocket, etc pills, etc can be crush, etc or become dirt, etc and many more advantages can be give why tear packages, etc are better for on the go products, etc; and fig shows the reusable/resealable package 386 which allows you to reuse or re-fill, etc container, etc with main container, etc content, etc, and fig shows the on the go package 387 which can be also tear package, etc; and this container, etc can be all PD'S, etc with no main container (see the side with said main content),

etc; this said MULTI-mouth PD can be use for any product, etc, and can be use with any combination of products, etc this is another reason that the present invention preferred all materials, etc because the products, etc diversity, etc is unlimited, etc; furthermore FIG. 39 shows sold apart, etc same, etc contents packages 390, etc which content could be the same (or not) content in the container with many package, etc or tear package, etc in said container, with and without a, etc PD; and 390 shows the on the go packages, etc inside, etc of said 390; which said contents packages, etc can bought apart and use apart or use together with main container, etc this is also seen as buyer (customer, etc) choice to save money or also to make there your choice on what type of product they like, this shows how also to keep cost down, etc (390 shown without PD see drawing, etc, but can have PD also, etc). FIG. 39 also shows BNF2 shows also how PD'S can go backward and forward with PD'S, etc BNF2 only shows one mouth PD on the same main container see drawings, etc, and BNF2 shows a push, etc top safety cap on the container, etc or said (see product section, etc for more company text, etc) company, etc can add in as many PD'S, etc as they like, etc or take away as many as they like, etc; this goes for all the present invention containers, etc products, etc PD'S, etc.

FIG. 39 also shows BNF3 which shows also the divider push, etc child safety caps, 392 etc also already known in the arts, etc; and fig shows the flip sides divider container PD 391 which can open in both, etc direction, etc with said caps 392 and draws shows how one, etc side of said container hold, etc loose, etc product pills, etc any product, etc; and the other side, etc holds, etc tear packages, etc any product, etc any container, etc; remember the present invention teaching, etc. FIG. 40 shows the under MULTI-PD'S container made under the container, etc; and shown with the zip, etc lock wrapper, etc and show with a product, etc; fig and fig shows the fat mouth container 402 which allows container to sit, etc on table, etc up size down, etc and show the under MULTI-PD 400 shown with many PD'S under container, etc and shows under screw cap off 399 this cap, etc (and other present invention PD will also use screw off cap, etc as PD doors, etc and will also be sink into the container, etc so where said cap door is locate will be smooth in that area where container with cap, etc as a, etc door would not prevent said container, etc from be place in venting machines, etc, not shown, etc); is sink into the container, etc so it would not prevent container from siting up right, etc, and shows how the present invention will be made all design, etc and you can drink out of it eat out of, etc; and this fig shows the flip closure 401, etc could also be pull tab, etc any type of closure, etc place product, etc in its, etc PD; and fig shows zipper, etc (which also prevent product from slipping, etc from moving, etc from container and can hold many product in many zip lock PD'S, etc;

and other patents with wrap just use the wrapper to hold to container the present invention also use it as a door, etc) lock bag, etc wrapper sleeve closure 397 which can be use also as a, etc door for PD and use zipper 398 to open and close to place product in to use TT or not; this said sleeve closure can be also made by place already made zip lock bag, etc and adhesive it on to said sleeve or made by said machines, etc which is always the best way, etc. FIG. 41 shows the design-b water, etc gun, etc product (note this water gun product, etc will also for the cooler container, etc product, etc and can be in a, etc PD, etc) and said water gun product is also a design product define as the present invention will also be made all design, etc and remember the present invention products, etc can also connect to other product, etc and fig design water gun 403 and the fig shows the MULTI water gun product 408, etc, which can split into many water gun, etc with, etc pd in, etc (for prior art reader notice said new add into said water gun, etc PD, etc and notice, etc that PD can be empty, etc) them which there PD'S can hold food etc drinks, etc and toys mans, etc which you (the reader) can shoot at remember the teaching the splitting apart water (and remember PD and its Products can be and will be made all sizes, etc so therefore the PD product can be bigger, etc or smaller, etc then its main water gun, etc or not this also shows difference how because,

the present invention product, etc can be for a grown person have one, etc water gun, etc and his/her Little child have the smaller water gun, etc product, etc which my be could not hold the bigger said water gun product, etc, this is a advantages, but note said water guns, etc can also be the same size, etc because its in a pocket and because its can have a new pd its with a water proof radio, etc TV, etc and because this said split apart PD water gun, etc or any water fun product, etc with and without PD itself, can also come in the new combine cooler container, etc) gun can have in its PD a laser, etc or laser gun, etc (for any prior art this just said text, etc shows difference and will show even more with coming text); so therefore the water gun, etc (any water, etc toy, etc can have PD) product can have PD and its water gun, etc can have also a PD with product which can be a dog water, etc throw toy, etc; or a empty PD for your own toy or water gun you bought last year, etc the present invention provides a place for it, etc; now back to the fig which also shows pet, etc or human, etc PD 418 which can be for your food, etc or for your pet food, etc but remember you can have and your dog, etc have there own PD, this product always a new way to eat to play and to drink at the same time even with your pet remember plying at the park with your pet now play water gun and give your pet a, snack at the same time and remember the product can be a laser toy or gun play laser with your pet then give pet a snack or you and only you play video, etc game on the laser, etc toy and then shoot laser gun, etc,

once again you much place every product, etc pd, etc container, etc in every PD, etc to really try to understand this invention like every product can be wearable, etc and once you add the PD, etc, its become new over prior art and over these said, etc toy products, etc; now back to the fig which also shows the laser product 409, etc which can connect, etc to any product; remember all of the present invention product, etc can connect to you or other product, etc (or not; remember teaching, etc and see product section, etc) and fig shows the fill tank 411a which holds water, etc ice, etc and also allows water, etc to fill in also by the squirt product 412 which connect to tank hole 413 so juice, etc fills tank, etc by the pull and push squirt trigger 415, and fig shows connect to tank, is the toy plug 407, which close said tank when said squirt product is not connect to said tank by toy female and male plugs 405, and fig shows said squirt product suction plug 414, (see drawing at the in of squirt product show hole to let water, etc in to fill said squirt and said tank which said squirt will also have plug to seal hole in it and said squirt can have PD and product, etc) which when said trigger is pull sucks water, etc into said tank hole to have water, etc to shoot water gun, etc at other, etc or in your mouth, etc; and fig shows make up 416, which make up is all known in the arts toy guns, etc and water guns, etc make up's shown as box (and will also be made with safety materials and safe plastics, etc to eat from and drink from, etc known in the arts) make ups is the parts which makes water gun and toy gun work already known in the arts, etc and fig shows the electric product or PD 406, which angle product, etc or PD, etc (remember teaching PD and product can be wearable, etc float-able, etc waterproof, etc);

which angle product, etc to also (not just angle PD, etc to use TT better like said in early text) see and use product better (advantages) which hold, etc your game, etc or video game, etc; and fig shows the fill tank mouth 411b, which shows option straw to drink from said tank this said tank mouth also made to have place in it ice, etc ice replacement cubes, etc any product, etc and said mouth also made all sizes, etc; and fig shows the hollow filled ice replacement, etc mask 419, which fits over this drawings tank part, etc to cool, etc said tank, etc contents, etc and said mask can have mask candy, etc PD 417, and fig shows the water pump PD 410, etc which you can use to hold your quick to fill tank water, etc pumps, etc could also be air pump, etc for your other toys, etc and said water gun, etc can have soda, etc bottle, etc PD, etc; and the said toy gun, etc and products, etc can have the walk'ie-talk'ie products, etc and a water balloon PD, etc. When using with cooler, etc uses also melt cold water from said cooler container, etc fill said, etc water gun (remember the present invention can use any water gun, etc product not just the design water gun, etc) with the cooler, etc cold, etc melt ice, etc contents, etc with the cooler, etc pour spout, etc or by dipping, etc the water gun tip end, etc of said squirt into said cooler, etc to suck water out into water gun, etc or use pumps to pump water, etc into water gun, etc from cooler, etc.

Note of importance for the water gun product, etc, and toy guns, etc and products, etc when said PD can be place anywhere (this is also what this invention do), so therefore said water gun, etc trigger, etc (not shown) can also have a, etc PD, etc with, etc or without, etc a, etc remote control for video games, etc for TV, etc for radio, etc for toy cars, etc for toy plane, etc, and yes said gun, etc can have a, etc PD or PD'S, etc for them and you can use said water gun, etc to shoot at them and shoot at there sensors, etc of all kinds, etc; remember the present invention teachings, etc; example, said product, etc can be removable or not so therefore said remote can be made permanent because to use product better when its not necessary for it to be removable; so there for the present invention product, etc can be made permanent in its said PD and remember product, etc made all sizes, etc designs, etc so therefor said remote can fit any said trigger and note said remote, etc can be place any where even next to said trigger, etc and I ask reader to find other text in this invention which say on, why some time product, etc will be made to stay in PD and it will not be removable, but can be removable, etc also, etc; and use said toy gun, etc, (the water gun, etc any toy gun, etc) and control the toy gun, etc at the same time, etc, by once again placing remote control and games remote controls products, etc, on or next to the trigger and once you squeeze trigger, etc you squeeze remote control button, etc together or apart;

shown advantages theses said remote can be removable or not; if removable place a TV remote or nite, etc vision camera, etc remote, etc in said trigger pd and place a TV, etc in a angle PD any where on said toy gun, etc. And note of importance that this text, etc also falls also on the land of the PI the containers, etc and products, etc when suitable, etc can be coated or made with glow in the dark materials products; products which can be apply to are like also the water gun product, etc the bike holder, etc and container, etc the cooler, etc the PI products, etc, a closely fitted description. FIG. 42 shows the different kinds of moving trays; (this fig also shows how PD, etc will be made all designs, etc) which can be use in any PD; and fig shows the moving walls PD 420 and shows the gap shape tray 422 which slide up and down by groove female and male in said PD, to hold product or to be dividers for said product, etc, and can come out of said PD and can be use as a plate, etc or a sever tray, etc; and which allows side walls trays 421 to slide in said of gaps, etc in 422; when said walls tray need to hold etc or become smaller to hold smaller, etc product, etc; and there no limits on how many's trays, etc can be in said PD; not shown tray can also be made to slide into PD like food trays slide by pulling tray in and out not up and down, etc this also shows how PD, etc will be made all design, etc; and said 422, shows the female gap rotate hole 424

(which can be use by and product, etc PD, etc for the present invention wearable products, etc, remember teaching, etc) which connect to the pierce or flat stick male rotate ball 423, which connect to food product like and unlike (candy bars, etc), which allows you to eat said bar and any angle and without remove said bar from said PD by placing said bar on said pierce stick, etc. FIG. 43 shows the containers, etc and product, etc connecting to containers, etc and products, etc without the need for PD, etc; see fig shows container, etc in-bedded or with removable magnetic, etc product 427, etc (note can be also said grooves male and female connect; etc or said plugs connected, etc or adhesive permanent connection, etc or weld permanent connected, etc or VELCRO, connected, etc to wear band, etc), which connect to wearable band, etc 425, in-bedded or removable metal straps 426, (or said magnetic connect to magnetic, etc) etc; which all said help you to wear your product, etc your suitable container, etc your PD, etc; fig also shows any CP-product magnetic 434, (any containers, etc and product's, etc and PD'S, etc magnetic, etc) which also shows double, etc adhesive backed, etc panel 432, etc which stick to any product and wearable products, etc and sticks to product holder (which also define as product, etc)

and any product see also product section, etc for more examples like magnetic (or not) uses to connect product radio, etc to your bike, etc by magnetic, etc; see fig also to see how magnetic is not needed see how 432 and 431 is not connect to magnetic but connected to a, etc double adhesive backed panel and shows protected by two cover panels, etc. Now some more examples of UN-obvious magnetic products, etc cup, etc product, etc with a, etc magnetic products, etc connect to said cup PD, which now can be connect to your ice box, etc (once again you must place in every product, etc PD, etc container, etc said magnetic, etc remember teaching, etc); to understand the present invention even more and the magnetic product, etc can be place on any product, etc (or not) once you (the reader) do this place this product, etc on, etc other present invention containers, etc products, etc PD'S, etc then you will see what this invention also teach, etc and see the greatness it produce, etc; another example to help you to understand this invention more thew bike container have magnetic to connect to the wearable bands, etc (not shown) said bands made in a way where it do not cover your skin but allow said container to touch your skin to use TT on your skin, etc or said magnetic product made to connect or connect to your product PD like the reflector product, etc or the TV product, etc or the need pads product, etc elbow pads product etc helmet product, etc or the computer product, etc or the speed reader product, etc; and remember teaching these product, etc can have PD'S, etc and, etc Products, etc; see fig also shows anybody product 428, of any kind but shown as candy bar and see adhesive tape or bands or clips 429, which will connect to you or container, etc like bottle, etc or food chips bags, etc, and see how 428, can have PD called AB-PD 430, and fig shows 428 connect to containers, etc see drawings, etc.

FIG. 44 shows containers, etc with removable PD (or not) and with adjustable PD and fig shows the rotating plat form PD 435, etc which holds product, etc and fig shows MULTI-male plug 436, and shows MULTI-female plug 437, connecting said form PD, etc to container which allows said form PD, etc to rotates, etc allowing product to be use better by you, etc and this said form PD can be wearable, etc connecting to you or products, etc or PD etc (and remember if you do not see reference number or I representation drawings, etc or look at drawings, etc) and float-able, etc remember teaching, etc in product section, etc; fig also shows the platform product holder product 438, which also will connect to products, etc and PD'S, etc with male, etc or female plugs, etc or male and females grooves, etc see PF-male groove 439, etc (shown as male but can be female groove, etc which will connect to any product made to connect to; remember this product, etc can have bands, etc to hold product, etc also; not shown); and fig shows the product loader holder product 443, with adjustable parts not seen but known in the arts, etc; 443, shows MULTI-male plug 436, which said plugs, etc will connect to suitable, etc products, etc with female plug, etc or connect to any product even without said plug, etc or said grooves, etc because of said bands, etc; 443 also shows loader clip 442, which also like, etc a bike product holder, etc and said clip (clips will be clips of all kinds, etc known in the arts, etc to be able to clip on, etc) will connect to bike, etc; or any product, etc; fig also shows the joint rod product 440, made from any suitable rigid or flexible materials, etc which this said 440 shows its rods see drawings, etc; and see joints 441, which rotates, etc moving said rods inward, etc and outward, etc remember rods can flex, etc and can fold up into, etc PD, etc; and is made all designs, etc and sizes, etc and all shapes, etc and 440 shows said MULTI-male plug which can connect to container's, etc PD'S, etc;

product, etc with female plugs, etc; and 440 shows said MULTI-female plug, etc which will also connect to any container, etc product, etc PD'S, etc and can connect to said platform product holder product and connect to rotating plat form PD which holders product, etc and when connect to said container, etc can extend product out closer to you or display product, etc better a, etc example, etc the bike container on its bike holder, etc and this said joint rod product, etc allows your candy bar to be closer to grab, etc or allows your coffee cup, etc product donuts, etc or e book, etc to display or closer to you or able you to see display e book, etc screen, etc better even when and while you drink, etc and even with or without PD, etc. FIG. 45 shows the drone product with PD, etc and fig shows drone product 447 see drone PD 448, which can hold, etc any product, etc and see product section, etc; FIG. 46 shows robot with pocket department for products, etc see robotic dog/robot product 450, etc could be any robot shown as a, etc dog and fig shows robot PD 449, which can have a, etc miniaturize size, etc power, etc refrigerator, etc product, remember the present invention also define product as all power product power from all power sources like the sun, etc and define products as being able to use all adapters, etc and see product section, etc; and the robot product, etc PD can be made to be interchangeable, etc interlocking, etc product, etc so therefore this said robot PD, etc said miniaturize product can be (or not) change, etc replace, etc with another product or miniaturize product, etc like product ice cooler, etc and can have ice replacement package, etc food, etc or said dog product, etc or PD could also be empty for said reasons; (note product made all sizes, etc; and remember the teaching this said dog, etc can have or not a, etc PD with a cat robot, etc another dog robot, etc a, etc bug robot, etc a, drinking container, etc, a, etc remote container plane, etc and all of them can have a, etc PD, etc product, etc themselves in, etc said 449 PD, etc); and FIG. 46 shows charger PD 451, which can also hold, etc charger products, etc; and fig shows hidden, etc tunnel PD 454, etc which connect PD'S, etc to (or not) each-other; and can be use for products, etc or for product cords if any (remember the present invention use all charging products like sun product, etc batteries, etc rechargeable products, etc);

and said tunnel PD can be use as a, etc water drain hole, etc because said robot PD can be uses also as a ice chest, etc without a ice chest product its said robot PD, etc become the ice chest itself, etc; and 454 can be use to move one, etc product, etc to another PD, etc; and also remember remote control products, etc; and FIG. 46 shows also another place to put charger PD or product 452, which is shown (see drawing) in a good place to connect a charger product to charger station, etc product 453, and note the present invention products can use any type of power products power by the sun, etc by light, etc by wind, etc movement, etc by water, etc, by batteries, etc all power source the present invention wish to use, etc this is also what this invention do, etc. FIG. 47 shows wearable product and PD shown on person, etc see drawing, etc. FIG. 48 shows the container connector 457, etc which show on said container is FG female grooves 465, which is connect to the flying throw product 455, which connect to with flying PD 456, which connect to MG male grooves 466, etc (note said grooves, etc can be plug, etc magnetic, etc all said connection for the present invention, etc); and said 455, etc can also be made in the same shape as the PD shape (not shown on drawings);

and sink into the said container, etc or product, etc this will allow said 455, etc and its container, etc to also be place in beverage, etc machines, etc or stack better on racks, etc in boxes etc; this also define as product, etc container, etc PD, etc made all design, etc sizes, etc shapes, etc so always remember the teaching, etc even more then the drawings, etc fig also shows the fly throw product 455, etc; which is also made from safe materials known in the arts so you can also eat, etc out of flying Pd 456, etc; and UN-obvious play a game throw it and if you catch it you or your dog, etc get snack, etc, so said PD holds one, etc or many product, etc PD, etc or any product, etc remember teachings, etc; and said container, etc and said throw product, etc can be made with plastics, etc with glow materials, etc known in the arts, etc and made by machining, etc like the so call flying saucer, but with the new PD, etc and or product, etc, remember the present invention can be made also float-able etc; and said invention can or will also have remote planes, etc with and with out PD, etc.

FIG. 49 shows the container with roll-able PD, etc; and fig shows the said 457, connect this time, to the roll-able/float-able PD 458a, etc by connecting to said groove 465 and to said groove 466 which is not seen but under said 458a (shown as a car, etc) which could also be made with or without remote tech, etc, remember teaching, etc (not shown) or can be made only as a rolling, etc product but not a float-able product, etc or both, etc or fly, etc; and said 458 can be connect on (not shown) said container, etc where said 458a wheels, etc are touching the ground, etc but said 458 is still connect to said container (or not), by said groove, etc by said plugs, etc; which said grooves, etc is now connect on the top, etc of said shown as car 458a, etc to said container connector 457 which will also allow said container, etc to be roll-able, etc and float-able, also, etc; which this way move the whole container not just the 458a, etc. which said 458a, etc will be design, etc by machines, etc (made by plastic, etc paper, etc metal, etc remember the present invention will also use each-other materials, etc) can be made with paper, etc cardboard, etc also to throw like paper, etc air plane; and can be made totally different by being made remote controlled, etc cars, etc boats, etc plane, etc, any toy, etc all known in the arts, etc; and can be connect to any container, etc and any PD, etc product, etc; and can use spring, etc moving tech, etc and all the like, etc; known in the arts, etc to make car, etc move, etc; by rolling, etc backward, etc so car, etc springs forward, etc; and uses all the likes and UN-like, etc; and remember all of the present invention product, etc can have PD, etc. FIG. 50 shown as alternative go see alternative section, etc and product section.

FIG. 51-53 (DF1-DF3); and DF1 shows the chamber PD, etc display surrounding product, etc 100%, fig also shows container wdf 373 and shown connect to said wdf is the door chamber PD 374 and its chamber flexible, etc part 376 materials, etc or made flexible by grooves, or using all known in the arts, etc flexible materials, etc (plastics, etc, rubbers, etc all known materials, etc which can be suitable to also use, etc) which is suitable to use, etc (or made or formed flexible by Machine, etc) part allows said chamber, etc surrounds 100% said product, and to move back and forward to have access to display PD, etc (made by computer machine, etc said chamber, etc and container, etc can be made, etc or formed together, or can be made by said chamber being made then adhesive to any container that the PI wish to connect it to (like glass, etc metal, etc and said chamber can be different materiel from container and can be the same materiel as container and still connect and still be flexible by connecting said flexible part only to a glass, etc or metal, etc chamber then adhesive, etc, or suitable adhesive (remember teachings, etc other ways to connect) etc flexible part, etc to metal, etc container chamber slot hole then adhesive, etc said metal, etc chamber to said flexible part, etc), to said chamber or when suitable, etc said chamber can be weld, etc to said suitable container or by made also computer machine, etc made in, etc formed, etc one unit, etc by machine, etc; and fig shows chamber slot hole 377 to shows how container, etc contents, etc can fill contents in chamber, etc through said slot hole (chamber hole, etc made all sizes, etc shapes, etc) this said filling etc can also happened when said chamber is being fill, etc with contents its self by machine, etc; then can fill, etc said container, etc buyer rights, etc

and fig shows the option chamber drink hole 375 use to drink out of chamber and container, this said hole can be seal with a punch hole, (use straw, etc) or can be a screw off top, etc or no hole at all, etc; and said chamber fills with cold content, etc it surrounds product to use TT 100%, etc and said chamber can be made all shapes, etc sizes, etc designs, etc and place any where on container, etc. Fig also shows DF2 and shows without said 374 but with chamber container 378 which could be hinge (not shown) on to container, etc said 378 connect to main, etc container and fits, etc or interlock, etc to main, etc container PD, and locks in, etc product, etc to use the TT 100% and shows 375 which could be also (not show) screw off top, etc and then place into 378 drinks, etc ice, etc food, etc any product, etc or said 378 can come already filled with drink, etc food, etc and fig shows different placement of said chamber PD, and fig shows DF3 which shows how almost all of container PD product, etc, use said TT and how PD will also angle itself also into, etc the container, and will angle its in any position PD to use product better not just for use the TT; new fig's to come like the water gun product will show how angle product, etc and pd, etc also shows advantages, etc and shows how product uses said TT from all sides, etc; and this DF3 also shows the in, etc angle PD 462 which also shows the container PD using the TT (or not); and DF3 shows protect-p insulate door (or not) made with all suitable materials, etc known in the arts, etc to help prevent, etc the loss of the product heat, etc coolness, etc or prevent product, etc, pd, etc from the lose, etc of heat, etc; also see new use sleeves, etc and new use containers, etc with PD, etc and display PD, etc and new product, etc with PD, etc all are defender, etc; and remember all teaching, etc.

FIGS. 3 and 6 and FIG. 50—Alternative Embodiments

The alternative embodiments shows there are various possibilities with regard to the pocket department door, etc and how pocket departments is used and made (structure) in this invention; and also through-out this invention various possibilities are shown (note of importance the prevent invention use each-other PD, etc materials, etc containers, etc, so when it come to alternative embodiments, etc all is preferred because of this invention new way of using the said each-others, etc); in additional some more further from the rest, possibilities is now illustrated in FIG. 3, etc and FIG. 6, etc and FIG. 3 shows the slide out plate door 38, with its phantom doughnut 40, which provides a place for your own food, etc; and said 35 shows how said slide out plate door can also be made or in-bedded with aluminum, etc which can acts as a conductor of cold, etc or heat, etc for said doughnut, etc; and FIG. 6 shows the ice or hot door PD 44, which can be filled ice, etc or cold or hot liquids, etc (or any product, etc) to keep the PD also cool, etc or hot, etc for PD contents, etc; and said 44, provides another way to drink, etc a, etc different drink, etc from the container content its can be connect to (note you can also eat, etc out said 44 and even carry, etc money, etc any product, etc shows many advantages, etc) and fig shows the flip up, etc door top with gap 45 (open it to put ice, etc into said door); this said flip up, etc door is also made with gap hole for straw 46 to drink, etc from said door, and is shown is plug top 47, use to close and open said straw; and additional;

FIG. 6 also shows the right side of pocket department 24a, and shows the (hidden) top of PD 24b, and shows the bottom of PD 24c, and shows the left side of PD 24d, and shows the center of PD 24e, and this fig, etc shows how PD inside, etc can be made also not level (see drawings, etc PD, etc made all designs, etc) then the PD door, fig shows 24b higher then door level; remember PD will be made all designs, etc, all sizes, etc all shapes, etc all structures, etc and all dimensions, etc and place any where on, etc container, etc; and this fig shows aluminum 35, etc in-bedded, etc into said ice or hot door, etc; these, etc alternative, etc PD doors, etc can be made also by machining, etc when container, etc is being made, etc and can be or will be use in all PD'S, etc for this invention.

Relative to how pocket department, etc (PD) is also made with out aluminum, etc is now illustrated, etc through this invention as PD which can be also made out of the same, etc material as the container, etc material, etc; see for a, etc example, the right side of PD 50a, made out of the same material, etc as container, etc, and shows the bottom of PD 50b made out of the same, etc materials, etc as container, etc, and shows the left side of PD 50c made out of the same, etc material, etc as container, etc and shows the center of the PD 50d made out of the same, etc material, etc as container; and shows PD clear door 50f, etc can be also made out of the same, etc material, etc as container, which all of these reference numbers 50a to 50f, etc, which are the one unit PD, which is not made of the aluminum, etc; and once again the present invention will or can use each-other PD, etc product, etc materials, etc parts, etc (which also define as PD, etc).

FIG. 50 container shown (could be also plastic, card board, etc) clear, and shows the alternative fig with packages (product), etc with the same content as container contents without no PD but product (but product, etc can have PD, etc or not) in container with container contents, etc; and fig shows the loose same contents product 459, which could also be cereal, etc or any product, etc (not shown as packages, see drawings shows loose product) loose but will be also the same content as tear packages, etc or any packages, etc (or not); note loose product can cause debris, (which means container loose content get on package which is place together but once again PD solve this product by separate the two, etc) etc on said package, etc with same content but PD with same contents prevent this problem but the present invention wish to do both, etc; this text also shows how also the PD works better then just placing packages, etc with loose product, etc; ex chips, etc cereal, etc; and the fig shows the every product same content package, etc which can be any suitable, etc product, etc cereal, etc pills, etc chips, etc any contents, etc see product section, etc and said packages, etc can be tear packages, etc of the same, etc content, etc as the container contents said as loose product; providing on the go, etc packages, etc without being place in a, etc PD, etc; but once again PD works better because of said debris, etc and placing your dirt hands, etc into container to get out of it said “on the go packages”, etc with the same, etc contents, etc as container contents, etc.

Furthermore the PI shows away to have a PD without losing oz, etc by not changing the sizes and width of a beverage container, etc that would cause the container to not fit, etc beverage machine, etc racks, etc, some beverage, etc container neck area or bottom (under container) areas, etc of said container can be made (upper and near the mouth part wider, etc) wider, etc causing the beverage, etc content, etc to remand the same; but the content, etc look lower inside the now change container, but the container size still fit, said rack, etc, and with the PD add into this said change container cause the beverage, etc to raise back or near the top of the drinking area, but the ounce remand the same, and note if you remove all the groove, etc and add in a, etc PD the ounces still can be lower depending on the size PD, etc you want or need; and furthermore, some time the container ounces, etc would be lose or lower, intentionally to off set the cost or help with the cost of add on product, etc; and product size, etc can also be reduce to set off cost; or PD, etc product come (yes in some case PD come off its, etc container) with or without its, etc container, etc or product, etc sold apart; and when said changing the container so content drop to give room for PD can be done also by removing container designs or grooves, etc in some container, if said remove so container body is flat and not groove, will drop container contents give room for PD and lower container ox's, etc and leaving container height, etc the same and raising container contents level back up to its normal level, etc,

all said are suggestion to maker of the PI. Further, suggestion shows the shows the cardboard, etc and paper container, etc and the likes, etc (like slat container, etc) PD will or can be also made out of card board, etc or paper, etc or plastic, etc made by machine, etc a molded, etc shape PD, etc with or without a hinge, etc door, etc then said PD can be adhesive into said salt container, etc all said way of making the PD'S container, etc should not be taken is the only way the PI will or can made a, etc PD, etc, which will be made all design's, etc by the super designs, etc computer machining, etc. When said paper container, etc some more suggestion text, etc when the paper container materiel has being cut in the size to be come a, etc cup, etc the PD, shape can be cut into the paper materiel, etc then before or (optional) after the bottom is place on the paper, etc container or before the (company decision when and how to cleaning and build there container) cleaning of the paper container, etc is done then a, etc made (by machining, etc) PD can (paper made or plastics molded, etc PD) be place in the cut out said shape and then said PD place and seal adhesive, etc into the cup, etc then said cleaning can be done. More suggestion for metal container, etc when the container materials is being cut to size to be the container body the PD shape can be also cut into the container body, and the extra cut out materials, etc or new materials, etc can be made into a PD, etc

(note the best suggestion way is for the PD to be mold into the container when the container body is being formed) shape then sealed or weld, etc into the same shape cut out on the container body, etc; and further more in more detail when the container body is being heat to sizes, etc by machining, etc the PD then can be stamp or molded or blow molded, etc into the container and some can have extra materials to add strength in to PD to stop pressure built up, etc from pushing the PD out of form, etc, etc note some PD come without Product if product is need add by machine, etc with adhesive, etc to product, etc then place in PD by machine, etc or product add by customer, etc and note both the (or not) can have adhesive on them, etc. When said metal container like beverage cans, etc is in its cup shape, etc to be molded, etc then said PD can be molded, etc into container, etc. Note that the PI will also be made with all waterproof materials suitable, etc for the PD and will use all water proof packages, etc and containers, etc and nylon and rubber packages, etc, and some will be made the same shapes, etc as electronic products, etc which will also be in water proof containers, etc and packages, etc and materials, etc and spray on materials, etc know in the arts, etc and these said product can be to interlock, etc in said PD, etc; more UN-obvious made PD, etc,

which can be within a PD, etc a, etc made by machine, etc an, example a mold chocolate PD, etc or a, etc mold flavor candy, etc molded, etc into a already made safe material suitable made like a, etc soda container, etc with a, etc PD which will allow away to use a, etc pretzel or cookie, etc use with a molded, etc PD by eating them together or apart, so this text just said shows how a, etc PD can be even eatable PD, etc made into a, etc none, etc edible PD, etc made and done by computer machining, etc; (note super, etc designs, etc computer machine, etc can made all of the PI product, etc and PD, etc and containers, etc) another suggestion of how to make a PD, etc container, etc a beverage company, etc can made a PD, etc container by using there already molding machine device which molds hand like grooves depression, etc to make the PI PD using said machine to make said hand grooves more deep to use as a PD this cheaply made PD can also use a cheaply made wrapper (or not to all said) because wrapper materials can be decrease, and then use the smaller wrapper to slide up and down, etc as a, etc door, etc giving access to the PD product, etc, also see FIG. 29, etc; and a for beverage company, etc a, etc PD without a, etc product allow them away to be not apart of a food company, etc (etc, in this can also be any companies not just food, etc and drink, etc companies, etc) or be apart of said food, etc company directly,

but if a, etc beverage company, etc do wish to be apart of the food company, etc they can be; this is a suggestion if the food company, etc do wish to be apart they can add to there fill line and station, etc a PD product line filling station to be add to the empty PD a, etc product, etc; or just send the without product container, etc to the store, etc without a, etc product, etc. The PI will or can be also made with a, etc air tight hermetically for PD and its product; made by machine, etc and made with vacuum type packages, etc which can also be seal into the already made PD, etc by weld, etc or by adhesive, etc and PD can be made with vacuum type doors, etc (doors like peel-able doors seal doors, etc not shown) made by machine, etc this is already done in the arts to packages, etc container, etc, and also done by machine, etc; pd will also use blister like door to also give more room for container content this PD door allow the PD content to not enter into the content area because (not shown) door hold it PD contents this said door can be connected to container by hinge, etc door done by machine, etc. The PI will also uses all know prior art tech to weld, etc to glue, etc to build the PI container, etc and product, etc, and container parts, etc and PD parts, etc which define as PD, etc,

will also use all said tech, which ones who are skilled in the arts know how to made and know how to apply these PI container, etc PD, etc and product, etc also made by machining etc; furthermore the PI container will use all beverage and food and product container material the maker of said PI container, etc will have option of materials, etc to be use a, example a Styrofoam container cooler, etc have a rigid plastic, etc PD glue, etc, suitable adhesive, etc into said Styrofoam container, etc, note PD can also be molded, etc in to said Styrofoam, etc container also when the container is being made, etc. When said suggestion are not experiments, etc they are ways, etc that also the companies, etc can made PD, etc. For the PI the TT, another example you can do yourself to show how the said TT works; (your own risk) place a very hot glass of water, etc or a very cold glass of water, etc on top of a honey bun, etc in a wrapper then wait and keep feeling the said honey bun wait feel the temperature change on said honey this is the touch tech, etc; the present invention (PI) also want its drink, etc food, etc content, etc any product, etc to cool, etc heat, etc and to not let this resource (of using also the container, etc contents, etc) goes to waste it would be shameful to do so. More suggestion text to help container company, etc to made a container, etc with PD, etc; after the molded glass, etc PD container is made (by machining molding, etc)

then a plastic, etc (by machining molding, etc) or clear rubber, etc; or even a, etc insulted material door PD, etc with a, etc hinge connected to said door and said door is (remember other said connection, etc in PI) connect to said container, etc by adhesive hinges, etc or by said hinge connect to said door and connected to said container and door have female, etc and male, etc plug to connect to each others, etc by said container and door having mold female or male plug, etc to connect to said hinge male, etc or female, etc plug, etc, furthermore etc the made door with hinge, etc can be (or not can be removable, etc) connected, etc by adhesive, etc to the already made glass container, etc PD; all done by machining, etc; this said rubber door, etc PD can be uses also as a waterproof PD, etc or give the glass, etc PD a door (without door use, etc, wrapper, etc label, etc can also be use as a, etc door it to have access, to its product, etc when said label can be adhesive on to the container over the PD sealing the product in which the user can tear through),

which can be also have a glass, etc door adhesive, etc, hinge connect, etc or said glass door, etc mold, etc or made to a, etc plastic, etc or metal frame, etc with said frame having hinges which can connect to molded (not shown) fastener holes molded in said glass, etc container, etc to match said metal frame, etc (etc could also be other suitable materials, etc the PI container, and PD also will use; remember teaching, etc) hinges to connect said door to said container, etc. PD made so it do not enter the container and change the container inside shape, etc a example a cup inside is a circle, etc this PD can be mold, etc or weld, etc or adhesive, etc to the outside, etc of said cup, etc without changing the inside of said cup, etc this PD made by machining, etc then place on said cup, etc by said ways, etc, this said outside PD also work great for containers, etc and products, etc which have inside moving parts, etc this said out said PD, etc shows advantages, etc. When said PD doors can also be pull tabs, etc and all the likes, etc use known in the arts ways also to make these said pull tabs, etc doors PD, etc which known the arts of scored, etc weakened, etc perforated line, etc.

The PI also define as aerosol, etc products, etc with PD, etc made by machine, etc which the PI suggest said PD could also be made or be a mold PD, etc (or made) or a, etc cut out shape into the container then said mold, etc PD can be weld, etc onto said container before, etc said container is filled, etc or adhesive PD (without cutting, etc said hole) to said container, etc; which a, etc already (by machining, etc) made PD with door, etc (said PD can be a metal, etc or plastic, etc PD, etc) can be seal, etc to the out side of said product container, etc which do not enter the container said (PD, etc also can weld to the out side, etc) outside made PD adhesive, etc to said container, etc; a, etc quick example on what this container and PD can have, etc cheese, etc or to show wideness cleaning spray, etc in the container and crackers, etc dry meats, etc in PD, etc; or to show wideness wipes, etc or gloves, etc in PD, etc; or always the best way for the PI is to use computer, etc designing, etc machining, etc to made PI containers, etc products, etc PD'S, etc, and all the likes, etc and UN-likes machines, etc to made the PI containers, etc PD, etc products, etc. Said display PD can also be place inside of the container, note that this display PD, etc not shown, but made all designs, etc, and can appear as a window display product but do not, etc open from the outside, etc (it can) of its container you only, etc have access to product by the inside, etc of the container, etc (can be on products, etc also) this PD, etc made by suitable clear, etc (plastic, etc glass, etc) materials, mold or weld, etc (which ever one is suitable to use to connect said suitable materials) or adhesive to suitable container with a, etc PD made in, etc or place in it said container,

but the door is (door is option even inside the PD can hold product without door, etc) inside, etc of side container. When said tunnel PD, etc can also be made or mold, etc into the container or suitable tubes, etc can be place inside the container walls, etc or molded or connect or adhesives, etc inside, etc or outside of said container, etc; there is many ways to made the PI because the PI is made all design, etc and the PI allows companies, etc to changes, etc there designs, etc this what this PI is also base on given companies of the PI the option of designs, etc products, etc PD, etc materials, etc, so the PI is must, etc must more then what you see and read, etc; other suitable similar prior art patent also shows highly suitable machine, etc which could be use to make said PI container, etc.

Operation—FIGS. 1 Thru 53

Starting with the operation of using FIG. 1 and FIG. 2 (also see product section, etc it was necessary to show operation there as well, to show usefulness, etc advantages, etc UN-obvious, etc and newness, etc) to operate FIG. 1, which shows the sport bottle container with its sliding tray 26, use container also by placing in it ice water, etc so container PD, etc become cold, etc or hot, etc, which creates the touch tech, etc then (note many other ways can be use for all of the present invention product, etc container, etc PD, etc do think that this the only use, etc; text could be none stop, uses, etc in-order to move forward you will be given some uses, etc if you have read this invention so for it is very long, etc this way help also to move forward) place your product candy bar, etc into said PD, etc to help, etc said candy bar product, etc to be come, etc cooler, etc and said PD is use to for carrying, etc to hold, etc to dip out of, etc to store, etc; the oration on how to use the sliding tray 26, which slides up, etc and down, etc (will be made all design, etc) inside, etc of PD grooves as shown in FIG. 1 also use this, etc sliding tray, etc a example is given a, etc power bar which you place in, etc PD to hold, etc or to keep, etc it cold, etc and from melting, etc or you ate some of said bar and from eating some of said bar it become smaller in size, etc, but with the said tray operation allows said tray to slide up and down, etc, and adjust, etc to the now smaller in size, etc said bar, etc (and remember teaching all PD can also have this, etc Pd define as use each-others, etc);

and said tray help said bar, etc from moving, etc in said PD, this also works great for when you on a bike, etc; and FIG. 1 shows (and can have a temperature reader, etc PD and product, which can touch the container content not seen the part which reader temperature, etc see product for product which come with any container, with any PD, etc) pull top 31, to drink from the container, and note with this present invention all container can come with content fill in them and fill in its PD, etc, and some operation will be UN-obvious but will be explain to the user with information on or for there product, etc; and said tray which also define as PD will be able to also push out its PD contents, etc (not shown) by changing the direction of the sliding grooves, etc which will also allow the product to extend out from the container, and; furthermore the PD door will (not shown) open in all direction, etc downward, etc so it also act as a plate, etc. FIG. 3 shows the operation of the thermal bottle container 36, etc and to also use this container, etc, is by place, etc cold, etc or hot contents, etc in to container, etc which can also create the TT for your PD product, etc you, etc place in said PD, etc,

and operation also shows how said PD can also carry's, etc hold, etc to store, etc and to cool, etc and heat, etc said product, and the operation of use said plate 38 is just slide out door from (not shown said door can also be made hinge, to stay connect to said container) container then place your food, etc on it then slide door back into container PD so food can become cold, etc or hot, etc or to store, etc (note a product is a product if you eat a product that a product you eat and if you use a TV, etc then that a product you watch people already known this was said to show some product people already no how to use them because the present invention product is long, etc); and fig shows the flip up top 41 to drink, etc from container.

The operation of FIG. 4 and FIG. 5 shows the cooler bottle container 42 and cooler container 43 the operation on how to use these PD'S, etc and place cold, etc or hot content, etc in container and use cooler, etc way you have always use it, etc, so therefore you can also use it also the same as FIG. 3, PD, etc also; but note any product for the present invention can use the TT not just food, etc drink, etc see product section for uses, etc. The operation of FIG. 6 which show said 44 use this door PD by open said door 45 then placing in it cold, etc or hot, etc contents, etc to create the TT to be use by the PD content, etc, and note all container, etc for the present invention can use both, etc 24a, etc PD or 50a, etc PD, etc which the said 24a, etc PD works better with TT, and fig shows how you can drink, etc more the one, etc drink, etc by also being able to drink, etc from said 44, etc which also shows the straw 46, and plug top 47 shows to open and close said straw to drink from said 44, also is shown is the PD use for product, etc. FIG. 7 shows and FIG. 8 operation of the coffee cup/mug container 51, and the cup container 52, on how to use these container and PD, etc are also the same as said FIG. 3, etc note you must see product section and drawing text, etc also; and furthermore said FIGS. 7 and 8 operations can be also to carry product, etc to hold, etc to dip product having dipping ability's, etc to store product, etc to cool and heat product, etc and see product section, etc (note not shown all of the present invention PD and PD, etc doors, etc can have valves, etc to let out hot or cold, etc).

The operation of FIG. 9, which shows the wine bottle container 53 use real wine 67, etc in the container, etc with product 55a, etc (chocolate, etc cigar, etc, electronic cigarettes, etc, cheese, etc love music CD'S, etc love DVD'S, etc 1 all DVD, etc all CD's, etc downloads, etc see product section, etc) in pocket department, etc use product, etc together with wine, etc some shows combine health benefits and shows aging together benefits, etc or use wine with dark chocolate, etc, eat and drink them together or apart one more great thing about the present invention allows you to eat, etc the PD, etc content and drink, etc the container, etc content later, etc, (with have to open said container, etc) for great health benefit known by other studies, etc the present invention bring them together, etc not combine for no reasons, etc, and the present invention allows wine, etc to be in, etc rack, etc with a problem because product inside PD safely and out the way, and the operation is to allow away to have food, etc with your alcohol beverage, etc to try to help slow down the level, etc of alcohol, etc in your body, etc then from just drinking, etc alone, etc.

The operation of FIG. 10 shows carton 57, which you can use the container content with the PD contents if you wish; contents can be milk, etc juice, etc any beverage, etc in the container, etc and cookie, etc milk, etc juices, etc donuts, etc cake, etc in, etc the PD, etc or to said some more UN-obvious uses it can be orange juice, etc in the container and a real whole orange, etc in the same, etc shape as said orange juice container, etc PD, etc can be any fruit, etc or vegetables, etc; advantages PD also act as a space save for homes and stores refrigerator, etc and racks, etc and for packing boxes, etc. FIG. 11 shows the bottle container 58; and FIG. 12 and FIG. 13 shows the can containers 60 the operations of these container, etc and PD is the same as FIG. 10, etc by also drinking, etc container content, etc and eating, etc PD contents, etc but remember teaching said PD, etc contents can be game, etc also see product section, etc to learn teaching, etc. FIGS. 14 and 15 shows the medicine bottle container 61, the operation on how to use this container and its PD start by screwing off child safety top 62, then drinking, etc (could be pills, etc which you do not drink, etc; or in which you place in liquid, etc in mouth, etc but slit out, etc; so therefore the uses, etc are wide for the present invention see product section, etc and also learn teaching, etc) medicine 80, etc could be any contents; and also by screwing off the child safety top, etc release the see through clear PD hinge door 81, etc and medicine package 82, etc could be any product mints, etc gum, etc cough drop, etc, furthermore FIG. 14 shows the back foil side, etc of this medicine package, etc, push down on plastic bubble domes 84, etc to release real pills 85, etc (could be mints, etc) from out of the back foil side, etc to (remember the soda container, etc can have this PD, etc) take as you normally take medicine, etc; also FIG. 14 shows how when PD is close it locks PD with its pin 63 and with its spring 64, and FIG. 14 shows how pin 63 lower down into the see through clear PD hinge door 81 hole 65c when child safety top is screw on to container, remember some more UN-obvious connections, etc this container can have a robot in its PD or your robot can have a PD in its hand for said pills, etc or pills container, etc images that, but its real and really UN-obvious, etc remember the teaching of the present invention, etc.

FIG. 15 shows once again when child safety top is screw off pin 63 with its spring 64 let pin 63 raise out of said 81 hole 65c and PD hole 65b, so door open and give you access to PD contents, etc or medicine packages, etc a quick said advantages PD can hold packages, etc and other PD and product at the same time. The operations of FIG. 16 shows 86 bag container, the operations on how to use its container and its PD, this bag container shows 55a (chips, etc or dog food, etc or human food, etc or both, etc) also for dipping, etc (or not) into 55b (dips, etc) form out of the storage PD 87 with its 55b (dips, etc salad dressing, etc food product, etc; which said storage PD can also be made resealable by zip lock, etc by snap together male and female parts, etc (remember the present invention can uses each-other parts, etc) and the operations advantages PD, etc allows you to dip, etc and hold, etc bag, etc at the same time; additionally FIG. 16 shows the connector removable PD 88 etc which can be also made permanent, etc or made to be removable sold apart, etc; and which come with and without slide up and down, etc handle rod 95a, so said PD can connect to the tunnel slot holder hole 94b for advantages, etc ability's more said on this later.

The operations of FIGS. 17 and 18 shows the O-circle container 92, (which can be any shape, etc) the operation on how to use container and its PD, this container hold, etc carry's, etc stores, etc product (chips, etc any product) for dipping, etc (or not) into the lid top dipping, etc PD 93 with dips, etc 55b, etc additionally this said lid PD also holds, etc stores, etc 55a, 55b,55c,88, etc; and the operations on how to use the container and said lid pd is by flip open the top as shown in FIG. 18 then dip, etc your chip, etc; and to open the container you must move said lid PD 93 as the arrow shows in FIG. 17 to have access to the container, etc contents, etc which is 55c, etc then you dip, etc chips, etc into said PD; more specifically you open container by lifting up, etc and Turing, etc the lid top dipping PD 93 as shown in FIG. 18 (see arrows, etc); and the pin rod trap bar 94a which connect to the lid top dipping, etc PD which connect said lid pd 93 to the O-circle container 92; and use the container and its PD also by dipping, etc its product (chips, etc) 55a into said lid PD dip 55b, etc (advantage PD allows you to dip chips, etc without the need for a 3^{rd} hand, by holding container and dipping, etc chip, etc at the same time and this container shows advantages display PD place this container in your car cup holder, etc and still allows you access to the container and its PD'S, etc) and more advantages said 92 can be placing in beverage machines, etc because some can be made the same size, etc shape, etc as beverage container, etc and these can provide away to have ice cream, etc floats, etc by having soda, etc in the container, etc and ice cream, etc in PD, etc combine together to made your float, ice cream and soda, etc can be sold apart and both together in PD,

and in container, remember this invent teaching said PD can also be made of insulting materials, etc and it door, etc materials like, etc said new sleeve, etc. The operation of FIG. !9 shows the pull out cup door PD 96 which will be place anywhere on container you can also use PD by dipping, etc chips 55c, etc into dip 55b, etc said PD works by sliding, etc out, etc or without sliding out because this PD also allows you to dip, etc from the said cup door PD see fig, this also means that the PD door can also be seal close by weld, etc by adhesive, etc and still allow access to PD and container content, etc. The operation of FIG. 20 shows the also the O-circle container, which also use-each-others, etc PD, etc and uses a, etc different PD, etc, the operations on how to use this container and its PD shows how the connector removable PD, etc fill with dip, etc with its slide, etc up, etc and down, etc handle rod 95a and connect by sliding, etc into hole slot 95b (by snapping together, by locking and unlocking together or just by connect fitting tightly together, etc as shown in drawings, etc) advantages this allow you to hold the container, etc and dip, etc at the same time, etc.

FIGS. 21 and 22 shows the I representation containers 98, etc which shows the operation of these figs and also shows the touch tech, etc which will be use by food, etc drink, etc electrics products, etc clothes, etc any product, etc using cold, etc and hot, etc contents, etc in the container, etc and in the PD, etc and by using products, etc which cools, etc heats, etc operation shows place your product in PD, etc to cool, etc or heat, etc said product, etc, by touching, etc the container, etc; these fig also shows how container will also use labels, etc wrapper, etc which will hold, etc stores, etc and to help cool, etc said product, etc by holding product with and without PD but with container, etc; additionally FIG. 22 also shows the structure PD 107a, which shows how PD will be made all shapes, etc sizes, etc dimensions, etc and design, etc and fig shows this PD have no door, etc note all, etc PD, etc are also made by machining, etc by molding, etc by engineering, etc PD and container, etc together, etc or apart, etc and by designing, etc product, etc to fit, etc said PD, etc also without the need for a door, etc the operations to remove PD, etc and product with out a door by using your finger, etc or by squeezing suitable present invention container to pop out its container, etc. FIGS. 21 and 22 also shows how these figs will represent any product fill container with and with out contents, etc; and shows the representation deep PD 103, which this PD have a different reference number, because it represent both 24a and 50a PD'S and all PD'S, etc and will surround and compass any container, etc and product, etc;

and fig can be a cigarette, etc cigar, etc package or (real cigar and electronic, etc cigarettes) case, etc with, etc PD for electronic, etc cigarettes to help to reduce or help with to smoke when you can not smoke in the pubic, etc or help you slowly to stop smoking real cigarettes, etc. FIG. 23 operations, etc shows the cap top PD, operation on how to use this PD will be for carrying, etc holding, etc dipping, etc storing, etc using the TT, etc can be made long to use said TT and short to not use said TT, and will be made all sizes, etc and fig shows easy access to PD content (very importance text, etc) without open, etc or unscrewing, etc it off its container which spoil the contents, etc, so therefore you can use the Pd content with out use the container contents, etc and without open the container contents, etc; and fig shows the bubble dome 102b made all sizes, etc and made for all containers, etc and the operations on how to place this PD to container is by screwing, etc by snapping, etc said cap top PD 102a to container, etc and dome top door 102c shows how this PD door can open and close, so its contents can be pull out or contents can be more then what said in these operations description and detailed description and operation can be also seen through-out the present invention drawings, etc; and some uses, etc or operations, etc will depend on container and PD materials, etc and PD designs, etc because PD, etc can surround, etc any container.

FIG. 24 shows the cooler container with different kinds of PD'S, etc the operation shows the same shapes CH-PD 300 which you can (or not) also pull out in cool or heat in suitable products to do so like refrigerator, etc for cool, etc the removable said 300 ice replacement materials product, etc, etc and phase changing materials product; and this said CH-PD is hollow, etc fill with said materials, etc for heating, etc and cool, etc your product, etc like food, etc drinks, etc (see drawings shown in the shape of a bottle you can place in it can be any shape and have also have door or a insulate door, etc remember teaching, etc) and once you remove this said PD, which can have its own door you can use the empty PD it came from as a PD, etc also which can have it own door also, so there it, etc can be also a, etc PD, etc within a, etc PD, etc with double, etc doors, etc; insulating it product even more said MULTI-doors, etc (not shown but real and will or can be done as well, etc) also place said CH-PD in a, etc heat source, etc to heat, etc said PD to use to heat, etc product in, etc PD; and fig shows the display push door PD 301 which can also be made of said ice replacement materials, etc also which said PD 301 can be removable, etc (or not also like many of the present invention PD, etc) and its can be a, etc PD, etc within a, etc PD said display push door PD is connect to cooler container, etc by swing pins 302 and by push said door at the bottom, etc open said door and by push, etc at the top, etc close said door, etc which is use to cool, etc heat, etc hold, etc store, etc your, etc (remember teaching could be for your also pet, etc) food, etc drinks, etc your hot shirt from playing at the parks baste ball court, etc uses, etc are none stop also see product section, etc. Which product, etc also define as all water and power pump, etc and closure pump, etc known in the arts, etc PI see as suitable to use, etc and product define as incense burner and incense storage devices, etc and, product, etc and define all wipes, etc dispenser and all the like, etc; this fig said door can be also place on any PI container, etc.

FIG. 25 shows operations of the edible molded closure and any container, etc it can be connect to or place in PD, etc; fig shows container 58 shows container thread 306b, etc onto edible (hard candy, etc) thread part 306a made by machining, etc and by placing said edible in a mold which has threads molds to match containers threads to be connect to each-other, etc said 306a can also be made to be a push on or snap on, etc edible closure also mold to do so, etc and add to the said 306 mix to made it can be flavor agents and extracts, etc which taste like beverages, etc and trade secrete beverage, etc flavor agents, etc and extracts, etc and real beverages, etc, can be add to the mix of candy, etc (candy bar, etc); also use said closure by sucking out of said 303 beverage, etc from said container with content of beverages, etc; and fig shows helper 306c shown with hidden threads 306d, etc which when edible (candy, etc) part is being molded, etc said 306c can be replace where (candy, etc) edible threads, can be or would have being to take the place of the said hard candy, etc threads, etc; this allows you to eat all of the said candy, etc off of the container, etc because its said 306c, out side surface is smooth, etc and said helper, etc, can be also made of also bio-materials, etc. FIG. 26 shows the different kinds of edible sucker products, etc, which you uses them by eat them sucking them, etc and can be molded by machining, etc into hollow center of edible treat 304 and connect to (when still molded, etc) a, etc hollow molded totally edible straw 305 or all can molded at the same time by said machining, etc; and suck hole 303 shows how you use said sucker, etc also by dipping, etc said 304 into a container, with content suck, etc (note all product, etc made also all shapes, etc so this product, etc can be also in the shape, etc of a spoon, etc) out it content, etc; or said 305 or 304 can be sold apart not connect, etc; and fig shows straw plug 310 which connect to said 305, etc or connect to none edible straw, etc or stick, etc (which said 305 can also be a candy, etc stick and not a straw also);

said plug connect to seal said hole and hole shown, etc and fig shows top candy part 307 use to eat suck beverage from it, etc and said 307 shows candy PD 308, etc which can be any edible PD use the hold, etc nuts, etc candy, etc candy powder, etc for you to eat, etc and all straws can be also fill with edible products, etc to eat, etc; and said 307, etc can have in its mix also beverage flavor agents, etc; and beverage taste extracts, etc and super hot flavors agents, etc, and nasty tastes flavor agent to use with container contents, etc also cool down your mouth by drinking, etc your drink after sucking your hot, etc sucker, etc; and said secret, etc to taste like beverages, etc; and fig's shows every product the none candy edible product 468, which can be corn dogs, etc on a straw, etc you dip in gravy, etc on can be meats, etc burrito, etc ice cream, etc make a ice cream float, etc and use the straw to suck container content out with the ice cream you dip in said container with soda, etc or can be a candy bar, etc on said straw on stick eat, etc said candy and use straw to suck, etc container contents, etc or can be a icy lollipop on a straw, etc; or ice cream sucker, etc made by also mold to a straw and freeze, etc to said straw which you can suck beverage, etc through, etc and allowing a drink, etc and some to eat, etc together, etc and which all can be on or also molded to said 304 or 309, etc so this allows you to suck drinks, etc and eat, etc at the same time, etc, also see product section, etc for use, etc operation, etc for all figs, etc; and fig shows with-out the hole, etc zip, etc lock, etc wrapper, etc 444b and its said contents ED-zip lock 444a, which can be food chips, etc, (55c, etc) and fig shows the snap close, etc grooves, etc 444c.

FIG. 27 shows how the design B-water gun product and any product can be on any container, etc and the operation shows design B-water gun 313, etc connect hose 314a, to water gun straw 314b, which (said 314b, etc can be made any size, etc long, etc short, etc reflex-able plastics, etc, and drawings do not shows how said 314b can be place anywhere, etc and connect to hose, etc, and any designs, etc) water suck through to shoot water out of said gun, which is connect to hose 314a which is shown connect to container 23 could be any container, etc, which when you shoot said gun suck water, etc out of said 23, etc when is connect to do so to said 314b (Note; any water gun, etc can be use for PD, etc and water gun said is a design product, remember product will be made all designs, etc this one of them also, etc); and fig shows the shape water, etc gun PD 315, etc (etc in this case show that this could be any product shape, etc not just a, etc water gun, etc shape, etc) use to place your said water gun in, etc, and fig shows the ex tar stuff PD, etc or PD'S, etc, remember teaching, etc., and fig also shows the fan connector 317 product use to blow air, etc on yourself, etc this can be also a combination fan and water sprayer, etc also known in the arts, etc; and also connect to said hose, etc; and fig shows the nozzle connector 318 product use to also to connect to said hose and use to drink or pour water on your self, etc; you must see product section also for uses, etc and more operation, etc; and all made by machine, etc. More when the PI said sucker product, etc and edible product they could be own by soda, etc beverages, etc companies, etc with trade secrets, etc, which who's soda, etc is a, etc trade secrets, etc, and add there secrets flavors, etc into, etc the mix, etc of the PI edible products, etc and sucker product, etc. (the PI will made its own secrets beverage-food edibles, etc and drinks, etc add in to the mix or the PI edible products, etc); fig also shows 416.

FIG. 28 shows the backpack beverage bag container holder which can also hold said 319 and said 338 shows 337 use it to place your ice, etc or drinks, etc food, etc and you can use 314a to drink out, etc of 338 and fig shows 339 you can place a, etc product to use the TT, etc, also see product section, etc. shows the operations of said holder with PD which also is the all holder container 319 shows how a, etc container with cold, etc or hot content, etc transfer, etc cold or hot etc, said also as TT to said holder PD 320 which a, etc product can be in, etc said PD or any product or candy bar, etc can be in, etc and this said holder materials can be plastic, etc stainless steel, etc aluminum, etc remember this invention teaching this is also a, etc company rights, etc invention, etc this is another reasons for using each-others materials, etc or many different choices, etc of materials, etc also known in the arts, etc and is also suitable, etc. FIG. 29 shows the operations of the container 321 using a, etc new use sleeve or wrapper or label, etc as a, etc sliding, etc up and down, etc door, fig shows also the new use sleeve 323, etc use by sliding up and down, etc to hold in your product candy bar, etc any product you wish that can do so; and fig shows adhesive SC 322 to connect to your product, etc then slide said sleeve by up to close and slide down to open PD and you can use product with container content if you wish to do so; said sleeve can also be made into a door with hinge, etc or glue, etc to a door, etc; or glue, etc onto container as a ladle, etc (or not to all said) because once again because company choice, etc go see teach in product section, etc, and for more uses, etc and operation which was necessary to be place there to also show utility, etc and UN-obvious, etc and newness, etc. FIG. 30 shows the operation of the button product, etc and product for promoting; and for other needs, etc and reasons; the operation also shows uses also the button, etc to help promote no texting, etc, drinking, etc and driving, etc; and many other reasons, etc; and use the alcohol tester, etc to see if you had to must to drink, etc; and use, said wrist bands the same, etc and use them to promote no driving, etc, and drinking, etc; these said product, etc can be use for many reasons, etc see also the product section, etc.

FIG. 31 shows the operation of the sport cooler, etc; which can be any container with MULTI-PD, etc and containers product, etc; shows the sport team/worker container 326 with the section slot/angle PD 324, which can be angle or not, etc which holds MULTI-products, etc for sports teams, etc or truck worker, etc products like said 23, etc and said 58, etc or chips bags, etc food product, etc any product it which to hold, etc, so sport team, etc can grab there sport bottle, etc because some of these container will also be able to wrote on them, etc and will be made also with changing active logo's, etc which the container content cooling, etc changes the logo's, etc appears, etc both, etc known, etc in the arts, etc, and you can use a, etc PD on said 23, etc if it come with a PD so sport player, etc can drink and eat, etc or even more UN-obvious can look at him, etc self, etc on TV, etc because remember the present invention product, etc can also be a TV, etc radio, etc remember the teaching, etc; and fig shows the display PD use with container content, etc if you wish, etc holds, etc use TT, etc for product players headband, etc when said headband product (or any product, etc) have become to hot from players, etc playing in the game, etc and this said band can come, etc (or not) with a PD for said ice replacement product, etc; once again you must go see the product section, etc and the fig's of all operations texts, etc for more UN-obvious, etc newness, etc. And go see teaching you must to try to understand the invention better because it must more then what you see.

FIG. 32 shows the operation, etc of the different kinds of container, etc with different uses PD, etc the fig shows the grip beverage, etc container 328 use to also wrap around your product (candy bar, etc) this 327 PD also shows as a said defender product because it surrounds product to use the TT more, etc use by sliding, etc product into said PD, etc (made all designs, etc remember teachings, etc so product can enter, etc said PD in many different ways, etc,) or slide out, etc your product to eat, etc and drink with the container content, etc; sent you can also place any product in said PD'S; use can be your choice, etc; and fig shows the label door 329, etc which can be on any container, etc use adhesive SC 322, etc or stick tape, etc on said label to close and open to PD content, etc and in PD use said 322, etc to hold etc product, etc and use said 322 to hold product on the out side of container also, etc said 322 can be place anywhere, etc on container, etc; and fig shows the interlocking plug PD 330 use to lock with male plugs 332 on product connect to female plug 331 on container on, etc product or package is the heat re-flexing materials 333 product package these said materials reflex heat, etc using suitable materials, etc known in the arts, etc to do so; and said product can be also a power bar, etc use with container contents of power drink, etc but you must remember teaching, etc container content and PD content can be any, see product section, etc;

and fig shows the tear tab PD 334a which open when top is twist, etc to open the cap top tab 334c tears then the PD tab 334b tears, (also made like top tear tab known in the arts, etc) etc to open said PD, which shows the plastic, etc hinge door 335, and fig shows the tear package 336, etc could be any package, etc use with container contents, etc if you wish, etc; go see product section, etc, (not shown) PD can be also made to be a twist top, etc PD which open like the container which twist open, etc ex soda bottle top, etc but can be made sinking into the container so it do not get in the way said top of being in soda machines, etc and fig shows the spinning hotel door PD 372 use by spinning said door to gain access to container contents, etc which can be games, etc food, etc drinks, etc to be use with or not with the container content which can be drinks, etc food, etc drug, etc; all for these figs products, etc can be made my machining, etc.

FIG. 33 shows the operation on how the touch tech (TT), etc works, and shows a test you can do yourself; by placing in one hand a glass of hot water, etc (test is done at your own risk!) and placing and the other hand a glass of ice cold, etc water, etc this is the TT use for products, etc food, etc drinks, etc, and uses newly on electric products, etc clothes product, etc any product, etc. FIG. 34 shows the box container, etc can be any container contents, etc in the container or the same contents in said container, etc and in, etc the PD, etc fig shows the display PD with also the same, etc content as the container contents, etc to be also uses together, etc or apart or take the PD products, etc to school, etc to work, etc with you this product can be tear packages, etc ex cereals, etc dry milk, etc honey packages, etc to use with container content or use by you taking said product to work and leaving the main (the box, etc) container at home, etc, you can also just eat the product apart from container content, etc ex may be a package of nuts, etc meant for the cereals, etc; more operation, etc said in the product section, etc.

FIG. 35 shows the MULTI-PD'S container with MULTI-PRODUCTS, etc and product shows Pd and product shown stack in main container, etc fig shows the same, etc content family container 340 with its shape fits container PD 341 to be use with its MULTI-PRODUCT 342, which you can pull it off said 340 which can have the same content as the main bigger container, etc (or not, this is always a option for the present invention product, etc container, etc PD, etc contents, etc) use also to take them on the go with you, etc or use at home, etc the main content could be cherry juice and the smaller, etc container can be milk, etc or cherry juice or soda, etc or food, etc, and fig shows the within product 343 on said 342 which said within product is a product within a product use this product with, etc or not with the content, etc of said 342 allows you also to drink and eat, etc or play games, etc or see, etc jokes, etc said jokes shows benefit help with your health proven by other this invention also combines health benefits, etc; must see product section, etc; and fig shows the stack-able products 344 use by pulling, etc them apart one can have drinks, etc the other can have food, etc or both can drink, etc or both can have food, etc. This fig can also have (not shown) and use the known in the arts plastic, etc tab like rings like use on the six pack cans soda, etc to connect them to hold them together but use on this container fig with smaller, etc same types, etc as this main container, etc like said main container PD product containers, etc said rings made to connect to said main container,

and said smaller, etc container to hold all together, etc use by pulling off said smaller, etc containers, etc; the whole PI remember teaching, etc. FIG. 36 shows operations, etc of different types of cap top that can be uses together, etc or apart, etc and fig shows the float-able top 345, etc could be any product, etc and PD, etc and shows the float pocket 346 which is made by machine, etc to float, etc the present invention will also use all known materials in the arts, etc, which floats to make the present invention product, etc and PD, etc out of also, etc; use said 345 by place any product in it and it can float in your bath tub, etc your pool, etc and can come product, etc like candles, etc soap, etc, food, etc drinks, etc so uses with this product, etc is great, etc also see product section, etc; and fig shows the MULTI-PD top 348 with its MULTI-flip doors 347, etc which could also be screw off caps, etc pull tabs, etc; place in, etc or already fill (note all container, etc PD, etc for this invention can come already fill, etc) said 348 product, etc, one PD can have food, etc the other drink, etc, and you can drink from one of the PD see dome hole 354 allows you to drink from said PD without UN-screwing the main top off of its container; and fig shows the share caps 353 (note all made by machine, etc and this PD, etc materiel can be plastic, etc metals, etc and suitable materials, etc in these fields, etc) use as food and drinks, drugs, etc product holder stores, etc and fig shows how they connect together by thread, etc and fig show how they can be wearable, etc see clip on 356, but product, etc products, etc can be made wear many ways see product section, etc,

and fig show the flip top 355 to open and close said 353 but they can be open by screw cap threads, etc also, etc so therefore they all can connect together or be one only one, etc or many, etc for you can share with your friends, etc; and fig shows the float-able top 345 or can be also cap top cap 350a use for drinks, etc drugs, etc food products, etc, and can be also wear-able, etc and float-able, etc and shows flip top 355, which could also be made with threads top, etc to close, etc said 345, etc, and shows the thread ring 350b, which you can screw, etc its on to container neck mouth, to eat from it, etc and drink, etc from the container, etc; and fig shows the wine stopper 366 said cap can be connect to a wine cork, etc which said 367 can be plug into wine container, etc and use 366 for to hold, etc product, etc like food, etc wine, etc use as a cup, etc, also see product section, etc for more details, etc, and fig shows the clear top tube PD 368 shown with more then one PD could just be one, etc or many, etc to hold, etc store, etc food, etc drink, etc shown with a, etc screw off cap, etc, could be many, etc screw off tops, etc; this PD could be many PD, etc many products, etc shown outside of the container to keep container content normal levels and also not touching the container content this PD content, etc would change, the container contents, etc with its content, etc; and this fig shows the tube slice top PD with bottom seal could be a, etc hole; and this pd, etc, also hold, etc food, etc drinks, etc drugs, etc for you to use as you wish, etc also and can thread together see the middle tube part 370 can be thread to the 369 part and 370 can be thread to the slide tip 371, which all can hold, etc the same contents, etc or different contents, etc of food, etc drinks, etc any product, etc and its content can be seal in by resealable covers, etc tops, etc pull tab, etc tear tab, etc all made by machining, etc and said PD, etc made by Machine, etc; furthermore, FIG. 36 shows the flip cap top straw 465 which is shown thread to 396 and 395 which can have a option dome hole 354 which can also have a plug an cord connecting said plug to said top; and shows how if you flip said top straw 465 you can screw it onto 396 by thread 394 then use it as a straw, etc to drink, etc (remember parts, etc product, etc made all sizes, etc) from container contents, etc, see drawing.

FIG. 37 shows the already made store, etc product connect to PD same shape, etc the operation of this fig shows the cup cake product 381 which could be any product connecting the fit any body PD 380 on the fit anybody product container 379, use the container content with the PD contents can be food and drink, etc go in the store, etc and buy them together or apart they fit each-other, etc, and eat, etc and drink, etc container and Pd contents, already filled container, etc and already filled product, etc coming and connecting, etc together, etc and said already filled can be also weld, etc or adhesive, etc together option for companies, etc and made, etc and done, etc by machining, etc remember teaching, etc. FIG. 38 shows the operation of the family size container with PD, etc and shows the stack-able cups, etc and fig shows 340 content (could be soda, etc food, etc drink, etc) to be use with 383 (which be also plates, etc microwave containers, etc cook-wear, etc, bowls, etc or already fill product container, etc); products sold together or sold apart; and fig shows the jugs container for family, etc use for friends and family and provides family products, etc and family sizes, etc drinks, etc (note this container can be a, etc family, etc size mouth wash with family size, etc or mints product packages, etc or gum, etc or tooth brushes, etc in PD, etc) you must see product section, etc and not just rely on this section, etc. To also remember teaching, etc.

FIG. 39 shows the BNF1 MULTI-PD'S container in different kinds, and fig shows the MULTI mouth container 388, which show many different PD you can put many different products in or it come fill with product you use with each other or use apart or use with the MULTI container contents (this container also allow company to set how many PD, etc they want or products they want because this container PD, etc and products, etc also goes be forward and forwards, etc) which could be the same content as PD contents or different contents, and fig shows loose product 384 (pills, etc) which can be the same content or not as the 388 and fig shows the 386 which can be the same content, etc as 386 and fig shows the on the go packages 387 which also can be the same contents as the 388 which you can use to take with you on the go and leave the 388 the main container at home, etc, and fig shows the tube container you can refill with said 388 container contents, etc and fig shows said door 389 open and close PD to have access to there contents, etc these PD, etc can have any contents cereals, etc nuts, etc food, etc drinks, etc and be the same content, etc or not;

and DF1 shows the tube container 485, etc which can be reuse also be placing your product in it to take with you on the go or use as a container, etc to eat, etc out of, etc; and fig shows the operation of BNF2, which shows how a company can change 388, etc and how many PD, etc they want; and container shows loose product 384 and 387 can be use together or apart and can be the same contents, etc pills, etc cereals, etc nuts, etc dry meats, etc any products, etc; and fig shows BNF3 which its operation shows the flip side PD, the divider PD open both direction 391, etc which one side shows 384, etc and flip to the other side to have access to 387, open by the divider push, etc child safely cap, etc 392 push and turn to have access to contents, etc uses as you like, or leave main container at home, etc and its said loose 384, etc (could not be loose can also be any product, etc) and take said tear packages, 387, etc with you to work, etc contents can be any, some ex's pills loose, etc and tear packages, etc combination squeeze and tear package, etc or combination packages, etc, and note this said BNF'S, etc can also have PD, etc on the out side, etc of the main container, etc also or not, remember teaching, etc, and you must see product section, etc.

Furthermore this PI can mix as long as it do not infringed, etc the PD place anywhere even at the container, etc mouth, but a patent which mix milk and cereal; the PI will not do, but will do mixing of the same contents, etc example one, etc kind of cereal, etc and another kind of cereal, etc; or yellow color milk, etc and blue color, etc milk, etc also making a different color drink, etc or tasting, etc drink, etc or your daughter like chocolates milk, etc and your son like strawberry milk, etc; and remember PD, etc (when said milk, etc can be any product, etc like and unlike, etc like corn, etc and pea, etc can goods, etc) can be made none stop PD, etc on container, etc (or none, etc remember teaching, etc); so therefore at the mouth, etc of said container, etc (made by machining, etc also known in the arts, etc) can be as a example, five, etc or not PD'S, etc at the mouth, etc all different mils, etc pouring, etc different contents, etc which in a, etc way which do not infringe on the milk and cereal pouring mixing patent; another way the PI will not infringe the cooler with a build in radio the PI can have many PD'S (not just a product molded, etc into a, etc container, etc and remember the PI can have a product within its product, etc),

etc products, etc; or have a, etc removable, etc radio, etc; or just have a new up grade remote control, etc radio, etc and TV, etc which new uses, etc and convent use sit down and watch or listen (or place your own product, etc in the interlocking PD, etc or the fit all, etc PD, etc use, etc your own, etc radio, etc computer, etc TV, etc mp3 player, etc toaster oven, etc in said PD, etc) to your TV, etc or radio, etc; UN-obvious remember the PI said rods and joint, etc can be add to the said TV, etc and you can sit on your cooler, etc and watch TV, etc at the same time, etc why because said rods, etc can be long, etc or short, etc so it come right up to your face, etc, so therefore said rod can also have a severing tray, etc computer, etc, remember the PI teaching and practice them yourself, etc

FIG. 40 shows the operation, etc of the fat mouth container 402 which shows the under MULTI-PD under the container which can have product like food, etc drinks, etc any product you can use with the container content or use apart; and fig the under MULTI PD 400 and shows flip tabs or can be pull tabs, etc; and fig shows the under screw off cap 399 sink into the bottom, etc of the container, etc allow container to sit up right and to allows access to PD contents, etc of products, etc could be nuts, etc fruits drinks, etc this said fat mouth container, etc can also allows you to have your morning drink and food and then flip it to have your drink and lunch, etc because remember to do what the present invention teaches, etc said fat mouth part can also have a, etc mouth PD (not shown, but this is also what this invention does, etc) with lunch meal, etc lunch bar, etc nuts, etc and this said can have a, etc mouth PD can a flip closure, etc then said fat mouth screw on top can still be screw on, etc, learn this invention, etc go see product section, etc; and this fig shows the sleeve closure 401 use to hold your power bar, etc dry fruits and nuts, etc any product, etc use said 397, etc (this is also a, etc PD) zipper 398 to have access to said contents, etc shown as 55a can be any product, etc and said 397 could be a zip lock type bag adhesive to a (which all materials are known in the arts, etc) wrapper, etc a label, etc; or all made by Machine, etc. Note a really good way to made the PI is by super computer manufacture Machine, etc or by manufacture, in there fields all said products, etc; and by suitable machining in each suitable field each PI product, etc containers, etc falls under, etc; because the PI PD, etc uses also all designs, etc.

FIG. 41 shows the operation of water, etc gun, etc product (note this water gun product, etc will also for the cooler container, etc product, etc and can be in a, etc PD, etc) and said water gun product is also a design product define as the present invention will also be made all design, etc and remember the present invention products, etc can also connect to other product, etc and fig shows the design water gun 403 and the fig shows the MULTI water gun product 408, etc, which can split into many water gun, etc with, etc pd in, etc (for prior art reader notice said new add into said water gun, etc PD, etc and notice, etc that PD can be empty, etc) them which there PD'S can hold food etc drinks, etc and toys mans, etc which you (the reader) can shoot at remember the teaching the splitting apart water (and remember PD and its Products can be and will be made all sizes, etc so therefore the PD product can be bigger, etc or smaller, etc then its main water gun, etc or not this also shows difference how because the present invention product, etc can be for a grown person have one, etc water gun, etc and his/her Little child have the smaller water gun, etc product, etc which my be could not hold the bigger said water gun product, etc, this is a advantages, but note said water guns, etc can also be the same size, etc because its in a pocket and because its can have a new pd its with a water proof radio, etc TV, etc and because this said split apart PD water gun, etc or any water fun product, etc with and without PD itself, can also come in the new combine cooler container, etc) gun can have in its PD a laser, etc or laser gun, etc (for any prior art this just said text, etc shows difference and will show even more with coming text);

so therefore the water gun, etc (any water, etc toy, etc can have PD) product can have PD and its water gun, etc can have also a PD with product which can be a dog water, etc throw toy, etc; or a empty PD for your own toy or water gun you bought last year, etc the present invention provides a place for it, etc; now back to the fig which also shows pet, etc or human, etc PD 418 which can be for your food, etc or for your pet food, etc but remember you can have and your dog, etc have there own PD, this product always a new way to eat to play and to drink at the same time even with your pet remember plying at the park with your pet now play water gun and give your pet a, snack at the same time and remember the product can be a laser toy or gun play laser with your pet then give pet a snack or you and only you play video, etc game on the laser, etc toy and then shoot laser gun, etc, once again you much place every product, etc pd, etc container, etc in every PD, etc to really try to understand this invention like every product can be wearable, etc and once you add the PD, etc, its become new over prior art and over these said, etc toy products, etc; now back to the fig, which shows the laser product 409, etc, (PD products etc can also be all sounds effects and lights effects, etc toy gun, etc and products, etc) which shows said 408 in said 409, which can connect, etc to any product; etc

remember all of the present invention product, etc can connect to you or other product, etc (or not; remember teaching, etc and see product section, etc) and fig shows the fill tank 411a which holds (which can also be made out of the same materials as beverage, etc containers, etc also see materials section, etc or use suitable materiel to drink, etc from to made said tank, etc and all parts, which come in contact with water, etc which you can, etc drink, etc safely, etc, remember PI uses also each others materials, etc) water, etc ice, etc and also allows water, etc to fill in also by the squirt product (made on said 404) connecting hole 412 which connect to tank hole 413 so juice, etc fills tank, etc by the pull and push squirt trigger 415, on the toy jet squirt product 404 which can disconnect by said plugs, etc and can be also made all designs, etc and can be also (or not) made permanent on said 403, etc; and fig shows connect to tank, is the toy plug 407, which close (said tank when said squirt product is not connect to said tank by toy female and male plugs 405, and fig shows said squirt product suction plug 414, (see drawing at the in of squirt product show hole to let water, etc in to fill said squirt and said tank which said squirt will also have plug to seal hole in it and said squirt can have PD and product, etc) which when said trigger is pull sucks water, etc into said tank hole to have water, etc to shoot water gun, etc at other, etc or in your mouth, etc; and fig shows make up 416, which make up is all known in the arts, etc toy guns, etc and water guns, etc make up's shown as box (and will also be made with safety materials and safe plastics, etc to eat from and drink from, etc known in the arts) make ups is the parts which makes water gun, etc and toy gun, etc work already known in the arts, etc and fig shows the electric product or PD 406, which angle product, etc or PD, etc (remember teaching PD and product can be wearable, etc float-able, etc waterproof, etc);

which angle product, etc to also (not just angle PD, etc to use TT better like said in early text) see and use product better (advantages) which hold, etc your game, etc or video game, etc; and fig shows the fill tank mouth 411b, which shows option straw (removable, etc or not) to drink from said tank this, said tank mouth also made to have place in it ice, etc ice replacement cubes, etc any product, etc and said mouth also made all sizes, etc and can be a, etc twist off top, etc pop off top, etc to have also access to said tank content, etc remember teachings even all, and every parts, etc of PI can be multiply, etc or not and can be use by other containers, etc products, etc in the PI and remember even PI materials can be use by each product, etc learn PI and yes this means PI design b-water gun, etc can have a, etc cooler, etc PD, etc do what PI teaches and place every said, etc product, etc in every said PD, etc, “reader” do not limit yourself from leaning PI, the drawings, etc do not show 100% what PI is inventing you must do teachings and learn PI; and fig shows the enclosed or hollow shell filled ice replacement, etc mask 419, which fits over this drawings tank part, etc to cool, etc said tank, etc contents, etc (said mask, etc can also be made to go over the entire design-b water gun, etc container, etc product, etc remember PI and remember this said water gun product, etc can also have eye glass games, etc with screen, etc media video glass, etc),

and said mask can have mask candy, etc PD 417, and fig shows the water pump PD 410, etc which you can use to hold your quick to fill tank water gun, etc pumps, etc could also be air pump, etc for your other toys, etc and said water gun, etc can have soda, etc bottle, etc PD, etc; and the said toy gun, etc and products, etc can have the walk'ie-talk'ie products, etc and a water balloon PD, etc. When using with cooler, etc uses also melt cold water from said cooler container, etc fill said, etc water gun (remember the present invention can use any water gun, etc product not just the design water gun, etc) with the cooler, etc cold, etc melt ice, etc contents, etc with the cooler, etc pour spout, etc or by dipping, etc the water gun tip end, etc of said squirt into said cooler, etc to suck water out into water gun, etc or use pumps to pump water, etc into water gun, etc from cooler, etc.

Note of importance for the water gun product, etc, and toy guns, etc and products, etc when said PD can be place anywhere (this is also what this invention do), so therefore said water gun, etc trigger, etc (not shown) can also have a, etc PD, etc with, etc or without, etc a, etc remote control for video games, etc for TV, etc for radio, etc for toy cars, etc for toy plane, etc, and yes said gun, etc can have a, etc PD or PD'S, etc for them and you can use said water gun, etc to shoot at them and shoot at there sensors, etc of all kinds, etc; remember the present invention teachings, etc; example, said product, etc can be removable or not so therefore said remote can be made permanent because to use product better when its not necessary for it to be removable; so there for the present invention product, etc can be made permanent in its said PD and remember product, etc made all sizes, etc designs, etc so therefor said remote can fit any said trigger and note said remote, etc can be place any where even next to said trigger, etc and I ask reader to find other text in this invention which say on, why some time product, etc will be made to stay in PD and it will not be removable, but can be removable, etc also, etc; and use said toy gun, etc, (the water gun, etc any toy gun, etc) and control the toy gun, etc at the same time, etc,

by once again placing remote control and games remote controls products, etc, on or next to the trigger and once you squeeze trigger, etc you squeeze remote control button, etc together or apart; shown advantages theses said remote can be removable or not; if removable place a TV remote or nite, etc vision camera, etc remote, etc in said trigger pd and place a TV, etc in a angle PD any where on said toy gun, etc. Further more said trigger PD, etc product, etc can be a radio, etc wave, etc controller, etc; or a, etc remote controller, etc, and all the likes, etc and UN-likes, etc. FIG. 41 also shows buttons, etc (note when add in, etc PD, etc to product, etc, which never had a, etc PD makes the product new, the PI make the water gun, etc and other product new with the PD, etc and products which can be in said PD, etc the PI is so usefully, etc it turn products into new products, etc like PD etc can be a water bottle, etc for you to drink when playing and you get hot, etc) on trigger these buttons, etc could be remote controlled, etc (can be also radio controlled product, etc, remember teaching, etc) in, etc in said trigger PD, etc made the same shape, etc as said trigger PD or mold, etc formed, etc, extends into, etc, or made into, etc said trigger, etc, remember teaching, etc said buttons, etc shown on fig, could be any where on said water gun, etc (this trigger product shown without, no number to make a point, not just for the remote product, etc, but for any product can be place any where, etc); FIG. 41 also DWG straw 314c, to drink from said tank, etc; and fig said 407, etc can also be multiply on said 404 and on said 411a, etc, so both, etc also can be plug close etc and use, etc apart, etc.

FIG. 42 shows the operation and shows the different kinds of moving trays; (this fig also shows how PD, etc will be made all designs, etc) which can be use in any PD; and fig shows the moving walls PD 420 and shows the gap shape tray 422 which slide up and down by groove female and male in said PD, to hold product or to be dividers for said product, etc, and can come out of said PD and can be use as a plate, etc or a sever tray, etc; and which allows side walls trays 421 to slide in said of gaps, etc in 422; when said walls tray need to hold etc or become smaller to hold smaller, etc product, etc; and there no limits on how many's trays, etc can be in said PD; not shown tray can also be made to slide into PD like food trays slide by pulling tray in and out not up and down, etc this also shows how PD, etc will be made all design, etc; and said 422, shows the female gap rotate hole 424 (which can be use by any product, etc and any PD, etc for the present invention and can be a, etc wearable products, etc, remember teaching, etc) which connect to the pierce or flat stick male rotate ball 423, which connect to food product like and unlike (candy bars, etc), which allows you to eat said bar and any angle and without remove said bar from said PD by placing said bar on said pierce stick, etc; said tray will also be made to press product against container, etc PD in-order to use the TT better; and will move as the product become smaller ex if you are eating a candy bar, etc power bar, etc weight loss bar, etc; Always see product section, etc and remember teaching, etc. Note said trays, etc can also be made of all materials, etc suitable, etc and can be made hollow, etc and fill and seal with ice replacements, etc and or, etc suitable, etc heating, etc and cooling, etc gels, etc materials, BLUE ICE, etc, and all phase changing materials, etc all known in the arts materials, etc and see PI materials, etc through-out the PI.

FIG. 43 shows the operation and shows the containers 23, etc and product, etc connecting to containers, etc and products, etc without the need for PD, etc; see fig shows container, etc in-bedded or with removable magnetic, etc product 427, etc (note can be also said grooves male and female connect; etc or said plugs connected, etc or adhesive connection, etc or permanent connection, etc or weld permanent connected, etc or VELCRO, connected, etc to wear band, etc and be connect by fasteners, etc), which connect to wearable band, etc 425, in-bedded or removable metal straps 426, (or said magnetic connect to magnetic, etc) etc; which all said help you to wear your product, etc for your suitable container, etc or for connecting to your PD, etc; fig also shows any CP-product magnetic 434, (any containers, etc and product's, etc and PD'S, etc magnetic, etc) which also shows double, etc adhesive backed, etc panel 432, etc which stick to any product and wearable products, etc and sticks to product holder (which also define as product, etc) and any product see also product section, etc for more examples like magnetic (or not) uses to connect product radio, etc to your bike, etc by magnetic, etc; see fig also to see how magnetic is not needed see how 432 and 431 is not connect to magnetic but connected to a, etc double adhesive backed panel and shows protected by two cover panels, etc. Now some more examples of UN-obvious magnetic products, etc cup, etc product, etc with a, etc magnetic products, etc connect to said cup PD, which now can be connect to your ice box, etc (once again you must place in every product, etc PD, etc container, etc said magnetic, etc remember teaching, etc);

to understand the present invention even more and the magnetic product, etc can be place on any product, etc (or not) once you (the reader) do this place this product, etc on, etc other present invention containers, etc products, etc PD'S, etc then you will see what this invention also teach, etc and see the greatness it produce, etc; another example to help you to understand this invention more thew bike container have magnetic to connect to the wearable bands, etc (not shown) said bands made in a way where it do not cover your skin but allow said container to touch your skin to use TT on your skin, etc or said magnetic product made to connect or connect to your product PD like the reflector product, etc or the TV product, etc or the need pads product, etc elbow pads product etc helmet product, etc or the computer product, etc or the speed reader product, etc; and remember teaching these product, etc can have PD'S, etc and, etc Products, etc; see fig also shows anybody product 428, of any kind but shown as candy bar product package and see adhesive tape or bands or clips 429, which is connect to said package, etc by said ways of connections, etc; and, which will connect to you or your, etc container, etc like bottle, etc or food chips bags, etc, and see how 428, can have PD called AB-PD 430, and (not shows) 428 can also connect to containers, etc by said 429, etc.

Fig also shown adhesive, etc 429 sticky's to product soda, etc 60 and 98, but can be any product even (and see how fig said 98 is representing different kinds of containers, etc) product not meant for the PI, this also shows how in the PI a candy bar, etc (said candy bar product, etc can (or said container without, etc said candy, etc) come with, etc said adhesive, etc already on it but sold apart, etc), can be sold apart from container, note to what the PI doing right now, etc. Furthermore PD, etc and product, etc also can, etc come off (or not) to also be wearable, so you can (by said connection through-out PI like said grooves, etc, plugs, etc weld, etc adhesive, etc, fasteners, etc molded, etc) jog, etc run, etc with said PD, etc and product, etc; and this PD, etc is connect to bands, etc or clamps, etc which connect to your pet, etc or body, etc, your outfit, etc; said PD, etc also can come off, etc to float in water, etc (using also all suitable waterproof materials, etc known in the arts, etc) your tub, etc pool, etc which you, etc can eat from, etc drink from, etc hold, your soap, etc your kids, etc toys, etc; all, etc while said PD, etc or product is floating, etc in your tub, etc and this PD, etc is made with hollow walls air tight, etc, which define also PD, etc made all design, etc and said PD will also be made with waterproof/resealable doors, etc and materials, etc known also in the arts which is suitable, etc to use, etc; these just said clamps, etc and clips, etc and bands, etc can be made also on the none removable PD, etc also,

(can be made any where, etc on, etc said PD, etc product, etc container, etc) in-order to keep the main container with you also but note other PD'S, etc (if any, etc) on container can come off, etc (or not) and be float-able, etc (or not) or be wearable, etc (or not, etc); and note these said wearable, etc containers, etc bands, etc connect to said container, etc said bands, etc can be made where band do not cover your, etc skin at all (or some by placement of said band where some or all cover your, etc skin, so connect band to container, etc where it touch's all of your, etc skin, etc in stead of connecting said bands where its, no space to touch your skin leave space and connect bands etc to container, etc why to use the touch tech (TT) on yourself not (or not, remember PI all come with all, etc or not with all customer and company choice, etc can have many or none or all said PD, etc and even the TT) so said TT, etc is not just for food, etc your dog, etc.

When said bag container, etc can be also open, etc by the kinds known in the arts, etc like tear, etc packages, etc by the zip lock bags, etc by the snap, etc together male and female snaps, etc; and fig shows said 98 and said 431 connecting to said 55a, etc, but note said 55a, etc can also be connect, etc to 431, etc permanent, etc and sold apart from said containers, etc and can be place on containers, etc not meant for the PI containers, etc; coming, etc with adhesive, etc already on them said bars, etc products, etc different also from prior-art, etc and said bars, etc can also have PD, etc in the with loose, etc nuts, etc (or a, etc candy bar, etc formed, etc within, etc a, etc candy bar, etc can be fruit bars, etc food bars, etc and remember PI can be a, etc cork remover, etc in said of a, etc dark, etc chocolate, etc bar, etc for the wine container, etc PD, etc, note said candy can be any of the PI products having, etc, or not product formed, etc within them, etc learn PI) candy, etc in there said candy, etc PD mold, etc into, etc them when they are being made said candy bars, etc and bars, etc also new from prior-arts, etc.

FIG. 44 shows the operation and shows containers, etc with removable PD (or not) and with adjustable PD and fig shows the rotating plat form PD 435, etc which holds product, etc and fig shows MULTI-male plug 436, and shows MULTI-female plug 437, connecting said form PD, etc to container which allows said form PD, etc to rotates, etc allowing product to be use better by you, etc and this said form PD can be wearable, etc connecting to you or products, etc or PD etc (and remember if you do not see reference number or I representation drawings, etc or look at drawings, etc) and float-able, etc remember teaching, etc in product section, etc; fig also shows the platform product holder product 438, which also will connect to products, etc and PD'S, etc with male, etc or female plugs, etc or male and females grooves, etc see PF-male groove 439, etc (shown as male but can be female groove, etc which will connect to any product made to connect to; remember this product, etc can have bands, etc to hold product, etc also; not shown); and fig shows the product loader holder product 443, with adjustable parts not seen but known in the arts, etc; 443, shows MULTI-male plug 436,

which said plugs, etc will connect to suitable, etc products, etc with female plug, etc or connect to any product even without said plug, etc or said grooves, etc because of said bands, etc; 443 also shows loader clip 442, which also like, etc a bike product holder, etc and said clip (clips will be clips of all kinds, etc known in the arts, etc to be able to clip on, etc) will connect to bike, etc; or any product, etc; fig also shows the joint rod product 440, made from any suitable rigid or flexible materials, etc which this said 440 shows its rods see drawings, etc; and see joints 441, which rotates, etc moving said rods inward, etc and outward, etc remember rods can flex, etc and can fold up into, etc PD, etc; and is made all designs, etc and sizes, etc and all shapes, etc and 440 shows said MULTI-male plug which can connect to container's, etc PD'S, etc; product, etc with female plugs, etc; and 440 shows said MULTI-female plug, etc which will also connect to any container, etc product, etc PD'S, etc and can connect to said platform product holder product and connect to rotating plat form PD which holders product, etc and when connect to said container, etc can extend product out closer to you or display product, etc better a, etc example, etc the bike container on its bike holder, etc and this said joint rod product, etc allows your candy bar to be closer to grab, etc or allows your coffee cup, etc product donuts, etc or e book, etc to display or closer to you or able you to see display e book, etc screen, etc better even when and while you drink, etc and even with or without PD, etc; note fig also shows how a, etc wearable, etc float-able, etc PD can also look, etc, see also 435, etc.

FIG. 45 shows the operation and shows the drone product with PD, etc and fig shows drone product 447 see drone PD 448, which can hold, etc any product, etc and see product section, etc; FIG. 46 shows robot with pocket department for products, etc see robotic dog/robot product 450, etc could be any robot shown as a, etc dog and fig shows robot PD 449, which can have a, etc miniaturize size, etc power, etc refrigerator, etc product, remember the present invention also define product as all power product power from all power sources like the sun, etc and define products as being able to use all adapters, etc and see product section, etc; and the robot product, etc PD can be made to be interchangeable, etc interlocking, etc product, etc so therefore this said robot PD, etc said miniaturize product can be (or not) change, etc replace, etc with another product or miniaturize product, etc like product ice cooler, etc and can have ice replacement package, etc food, etc or said dog product, etc or PD could also be empty for said reasons; (note product made all sizes, etc; and remember the teaching this said dog, etc can have or not a, etc PD with a cat robot, etc another dog robot, etc a, etc bug robot, etc a, drinking container, etc, a, etc remote container plane, etc and all of them can have a, etc PD, etc product, etc themselves in, etc said 449 PD, etc); and FIG. 46 shows charger PD 451,

which can also hold, etc charger products, etc; and fig shows hidden, etc tunnel PD 454, etc which connect PD'S, etc to (or not) each-other; and can be use for products, etc or for product cords if any (remember the present invention use all charging products like sun product, etc batteries, etc rechargeable products, etc); and said tunnel PD can be use as a, etc water drain hole, etc because said robot PD can be uses also as a ice chest, etc without a ice chest product its said robot PD, etc become the ice chest itself, etc; and 454 can be use to move one, etc product, etc to another PD, etc; and also remember remote control products, etc; and FIG. 46 shows also another place to put charger PD or product 452, which is shown (see drawing) in a good place to connect a charger product to charger station, etc product 453, and note the present invention products can use any type of power products power by the sun, etc by light, etc by wind, etc movement, etc by water, etc, by batteries, etc all power source the present invention wish to use, etc this is also what this invention do, etc; and said 453, etc and all suitable products, etc in the PI can be made (adapted change to connect to all power sources, etc) also to connect to any and all power sources, etc like car chargers outlet, etc power plugs, etc, homes, etc power plugs, etc, and any and all known in the arts, etc sources of power, etc connections which is suitable, etc. FIG. 47 shows wearable product and PD shown on person, etc see drawing, etc.

FIG. 48 shows the operation and shows the container connector 457, etc which show on said container is FG female grooves 465, which is connect to the flying throw product 455, which connect to with flying PD 456, which connect to MG male grooves 466, etc (note said grooves, etc can be plug, etc magnetic, etc all said connection for the present invention, etc); and said 455, etc can also be made in the same shape as the PD shape (not shown on drawings); and sink into the said container, etc or product, etc this will allow said 455, etc and its container, etc to also be place in beverage, etc machines, etc or stack better on racks, etc in boxes etc; this also define as product, etc container, etc PD, etc made all design, etc sizes, etc shapes, etc and a, etc PD is made without changing the container size where that it would change in a way that would prevent a container with PD from being in machines, etc and racks, etc which said machine are made to hold, etc a certain size container, etc, so always remember the teaching, etc even more then the drawings, etc fig also shows the fly throw product 455, etc; which is also made from safe materials known in the arts so you can also eat, etc out of flying Pd 456, etc; and UN-obvious play a game throw it and if you catch it you or your dog, etc get snack, etc, so said PD holds one, etc or many product, etc PD, etc or any product, etc remember teachings, etc; and said container, etc and said throw product, etc can be made with plastics, etc with glow materials, etc known in the arts, etc and made by machining, etc like the so call flying saucer, but with the new PD, etc and or product, etc, remember the present invention can be made also float-able etc; and said invention can or will also have remote planes, etc with and with out PD, etc.

FIG. 49 show the operation of shows the container with roll-able PD, etc; and fig shows the said 457, connect this time, to the roll-able/float-able PD 458a, etc by connecting to said groove 465 and to said groove 466 which is not seen but under said 458a (shown as a car, etc) which could also be made with or without remote tech, etc, remember teaching, etc (not shown) or can be made only as a rolling, etc product but not a float-able product, etc or both, etc or fly, etc; and said 458 can be connect on (not shown) said container, etc where said 458a wheels, etc are touching the ground, etc but said 458a is still connect to said container (or not), by said groove, etc by said plugs, etc; which said grooves, etc is now connect on the top, etc of said shown as car 458a, etc to said container connector 457 which will also allow said container, etc to be roll-able, etc and float-able, also, etc; which this way move the whole container not just; the 458a and its 458b PD, etc. which said 458a, etc will be design, etc by machines, etc (made by plastic, etc paper, etc metal, etc remember the present invention will also use each-other materials, etc) can be made with paper, etc cardboard, etc also to throw like paper, etc air plane; and can be made totally different by being made remote controlled, etc cars, etc boats, etc plane, etc, any toy, etc all known in the arts, etc; and can be connect to any container, etc and any PD, etc product, etc; and can use spring, etc moving tech, etc and all the like, etc;

known in the arts, etc to make car, etc move, etc; by rolling, etc backward, etc so car, etc springs forward, etc; and uses all the likes and UN-like, etc; and remember all of the present invention product, etc can have PD, etc; further, said 458a can also be sat, etc on a, etc table, etc and you can eat out of it, etc drink, etc (also can be made out of suitable safe materials, etc) out of it, etc and it can also roll, etc around, etc, remember teaching, etc this 458a, etc can also fly, etc or roll, etc (PD can also be a, etc removable bowl, etc) by remote, etc, and yes it can be use as a, etc cooler, etc, and yes scent it can be a remote control product, etc said cooler, etc, remember product, etc made all sizes, etc, learn teaching. FIG. 50 shown as alternative go see alternative section, etc and product section.

FIG. 51-53 (DF1, DF2, DF3), etc shows the operation of, and shows the chamber PD'S display, etc and surrounds product 100%; and fig shows the container wdf with the door chamber PD 374 and shows the optional drink hole 375, etc which (remember the present invention can be made all design, etc so this PD can be place where it content level can be higher then the container mouth neck, etc); and said hole can be a punch hole, etc use straw to open this is known in the arts, etc also and said hole can be made to or could be a screw off top, etc pull tab, etc and can be use to drink out of said chamber, etc or use to put ice in it, etc any product the present invention wish to place in it, etc said chamber can cool, etc product in chamber 100%, etc and you place in it or company place in it product, etc, see chamber flex-able part 376 this allows you to bend, etc said chamber so you can remove, etc or place product in it, etc and at the same time display, etc your product, etc and still be able to have access to your product even in your car, etc bike, etc container holder; etc and fig shows how said flex-able part can be connect to any (fig shown as a plastic, etc suitable container known in the arts, etc, to drink, etc out of; but can and will be any materials container, etc) container materials, etc like metal, etc glass, etc by said weld, etc (or not) or by said adhesive, etc; said flex-able part 376 can be connect to a glass, etc chamber door, etc then connect to container 373 connecting to said 377, see drawing, etc; and fig shows (DF2) chamber container 378 which also surround product 100% to hold, etc to cool, etc heat, etc said product, etc and use hole 375, etc can also be screw off top, etc, and this container 378 can be use also for your own contents, etc of ice, etc drink, etc food, etc and this container can be a already fill content container by company, etc like soda, etc; any contents, etc; and fig shows how said chambers can be place any where on said container, etc; and fig shows (DF3) on the container 98 with its PD 462 surrounding product, but its door made of ice replacement materials, etc or made of heat re-flexing materials, etc or made of insulating tech, etc or insulating materials, etc to help,

with product coolness, etc or warming, etc it, etc; see protect-p insulate door 464 and you can use container contents with Pd contents (or not); and contents can be food, etc drink, etc; and said defender plastic, etc chamber, etc (said chamber and container, etc made by designing computer, etc and computer machine, etc in one whole part, etc or container, etc is made and then chamber, etc is made then weld, etc adhesive, etc together, etc) can be also weld to a, etc plastic, etc container, etc remember teaching, etc go see also product section, etc and also fig's texts, etc, and this operation, etc. When said defender shows advantages, etc you will notice how other patents, etc expose it article surface and its container do not surround and display, etc its article completely, etc or all sizes, etc and the PI doors, etc wrappers, etc labels, etc sleeve, etc will also be made of insulate, etc materials, etc and heat re-flexing materials, etc also and known in the arts, etc. And when said using containers, etc already groove, etc and hand like impression the PI can use said groove, etc on said already made container for said impression as a, etc PD'S, etc by have them for a place for said product candy bar, etc which can also be made tiny, etc (or not) to use said already made on container hand like, etc groove impression, etc, Remember the teaching like interlocking, etc product, etc and PD, etc

which also define as interconnecting, etc of PD and product, etc; or by also means of mounts, etc which could also be by said grooves, etc by plugs, etc female, etc and male, etc by magnetic, etc or by wearable means which could also connect by bands, etc which can connect to said wear product, etc PD by welds, etc by adhesive, etc and remember many other teaching, etc. Furthermore when said use-each-other products, etc in the PI, etc is also seen as also use-each-others, etc containers, etc; note all containers, etc and products, etc and PD, etc shortly said description text (you will find this also near detail description of figs, etc where containers, etc ex say wine, etc in container, etc and chocolate, etc in PD, etc this is a short description, but is not all the PD, etc will or can have in its PD, etc) but not exclusively define its self an example, the sport bottle container can have or not a, etc candy bar product, etc this is also shortly define its self as being a, etc product for this said container;

but this container product, etc can be any container products, etc and this said container products, etc can be and will be more then the shortly said text like this said sport bottle container will also be tools, etc bike, etc kits, etc cell phones, etc radio, etc lights, etc c display products, etc and any products, etc and this container, etc can have (not all shown) 10, etc or none, etc or one, etc PD'S, etc; and when said sport bottle container, etc and use each other products, etc also means for a UN-obvious example (if you did not place every product, etc one at a time, etc in the sports container, etc container, etc like the PI teaches to do so, said sports bottle, etc PD, etc will have a, etc (not shown, etc) miniature, etc UN-obvious bubble gum machine, etc product, etc (or not), or said sport can have a, etc miniature TV, etc product with (or not) a, etc remote PD, etc. The PI will also be made on stack-able, etc and collapsible containers, etc.

The PI with its newness will also use all stacking containers, etc for the PI, etc note do not try to be the invention (for those who try to limited the PI) this what the invention want to also be seen as, and see its self as being this way, etc like the statements, etc of the with and without, etc, the uses each-other, etc product with in a, etc product, etc the backward and forward of products, etc and PD'S, etc, which can be MULTI-PD'S, etc or MULTI-PRODUCTS, etc (or not, etc); and the touch tech which can be also uses newly on more then food, etc and drinks, etc products, etc, surround product, etc 100%, etc removable, etc or not removable products, etc PD'S, etc, product, etc and PD, etc in more then just food, etc and drinks, etc container, etc wearable, etc float-able, etc PD'S, etc and products, etc the pairing of products, etc and there benefits, etc (or not to all said, etc); and you must place every said products, etc in every said PD, etc and you must place every said PD, etc in every product, etc and display PD'S, etc and products, etc; and containers, etc PD'S, etc products, etc and packages, etc made all sizes, etc shapes, etc designs, etc and made also to inter lock, etc with product, etc PD, etc and inter lock with containers, etc and companies, etc and customers, etc rights, etc and the heat, etc blocking sleeve, etc merge of products, etc into, etc containers, etc and into, etc themselves, etc and products, etc can be made into, etc the container PD, etc to be the wrapper, etc the body of etc the casing, etc of said product, etc PD it casing, etc;

and many more newness, etc advantages, etc UN-obviousness, etc through-out the PI, etc these scopes, etc said is also the PI, etc. Said MULTI-PD'S, etc and products, etc shows more advantage, etc by holding MULTI-PRODUCTS ice and heat packages, etc and by holding many PD'S, with many ice, etc inside, etc of container, which are extra ways to cool, etc or heat container, etc contents, etc or PD contents, etc; and note the PI can have many product not just shot glass, etc; now the PI will move beyond prior art said PI shot glass can have the new PD, etc on them, etc with and without products, etc in said PD, etc

Beside the description in this invention, some more reasons for patent-ability and addition advantages and benefits and arguments are, these are only some more examples you must you through-out the whole invention and drawing, etc:

(A) PD usefulness and advantages, etc also keeps your food products, etc (always expect the unexpected with PD, etc and product, etc) from being damage, which not like lunch bags and bag, etc which do damage your food, etc the PD prevent this, etc; and also said bags allows stains from your food, etc to come through which could cause your lap to became stains or even worst heat from said bag can could your lap, etc can get burn from the hot said bag PD prevent this and at the same time use this said heat, etc to help heat, etc your product even more, etc. Further, advantages is shown a, etc PD, etc also can have a, etc product, etc within a, etc product, etc or, etc or and, etc (or not to all said because of said company, etc rights, etc) a, etc PD, etc within, etc a, etc PD, etc within a, etc PD, etc and so no and so on, etc to use as a, etc bowls, etc and use for many reasons, etc like some can be edible chocolate, etc bowls, etc to eat remember the PI use-each-others PD'S, etc; further UN-obviousness, etc a, etc chocolate bar, etc can have a, etc PD, etc (could be tiny, etc hard shell candy, etc in this bar PD, etc) and a, etc product, etc made by machining, etc and machining mold, etc or even by hand, etc.

(B) The drinking combination of drinking product and food products, etc, which allows more energy from just eating alone; these combination will shows the problems they will resolves, an example, fluid drinks leaves the body quicker from sweating and from said body burning off these fluid energy, etc, but with this invention combining energy drink, etc and energy food, etc (with and without PD because of TT) solves the quick lost of energy from just drinking fluid alone, because both together (any food, drink, etc) takes longer to burn off as energy in the body and is slower to leave the body; given the body longer energy, which means more energy from just drinking alone, etc, said PDS, etc provides, this, etc.

(C) Furthermore this invention offer the combination advantages of weight-loss drink, etc in the container, etc and weight-loss food product and bars, etc in the pd, etc, given benefits which provides help with weight-loss by providing weight-loss food, etc with weight-loss drinks, etc which could be weight-loss video, etc, music, books, etc downloads, etc, once again you must see product section, etc and learn this invention, etc. Further more the PI PD shows even more advantages; container which can be place in car holders, etc bike holders, etc backpacks, etc can be a problem if it have a part for products beside the container content, but the present invention solve this problem with its, display PD which can also surround it product 100% to use TT and its the PI contents can be remove without caning to UN-screw, etc (which can danger while riding a bike, etc) and screwing, etc its PD to remove it Product, which other have to screw, etc and UN-screw, etc and have to remove there container compartment in-order to get to its contents, etc, which when driving, etc could be life danger to them and to other driver, but once again the PD, etc allows easy access, etc even when said display PD is in said holder, etc like said biker holder, etc like said car cup, etc holder, etc; and will be apply to the O-circle container which can hold chips, etc without having to screw, etc to have access to its content, etc; and the milk container, etc and the thermal bottle container, will use the new kids spill proof closure, etc (not shown but known in the arts kid spill proof cup) made by machine, etc to now connect to any container of the PI, etc so they can be for the bike holder container, etc so its content do not spill while riding bike, etc; also see the FIG. 36 which show how a kid, etc spill proof look like but they design some what difference or go see FIG. 21; note when said DF3, etc will also be (not shown made to be in container, etc with out angle molded, etc into the container, etc and still surround by being made in the container up, etc and down, etc without just being angle, etc. The said O-circle container can be made also to be in beverage, etc machines, etc made in the shapes, etc of said soda, etc container, etc.

(D) PD, etc also shows advantages, etc in combing refrigerator products, etc in the container, etc and shelf food, etc products, etc in PD, etc for fresher longer; an example now will be giving, using package cookies, a, etc shelf product for this example, once these type shelf food products (cookies, etc) are open they become stale when replace back on the shelf after open them, etc, but with container with PD and with contents of beverage, etc in container and shelf food product in PD provides away for these shelf product, etc to stay fresher longer, because they are combine with refrigerator products and also uses the TT, etc.

(E) A product advantages, etc shows a food product, etc or product, etc for PD with container contents of alcohol, etc; this food product, etc is use with alcohol beverages, etc to slow down the alcohol levels, etc in your body, by using PD, etc with product food, etc which consume and dissolves some of the alcohol in your body, etc, it is well known that when drinking alcohol drinks alone without food (PD provides food) it pass through your blood and body easier and a lot more of it pass through your body easier, a solution do not drink, or a solution to this problem is the PD, etc provides something to eat with your drink, etc; additional it is well-known that drinking alcohol alone makes some people sick this problem is also solve with Pd providing food, etc can providing buttons, etc to not drink and drive, etc go see product button section, etc.

(F) PD shows advantages, etc by allowing you to also combine products with beverage, etc on racks, etc shelves, etc and beverages machines, etc like combing, packages boxes, home shelves with product, etc with out taking up any extra space (PD provide this way) and can fit normally, etc racks, etc because product candy bar, etc is inside, etc (remember this invention product, etc can be place any where, etc) PD on, etc container; additional a beverage and a Pd container let you “get it quicker” which means PD also prevent you from waiting in stores long line for when you fell hungry and thirst PD allows you to just go to your normal beverage machine, etc (not a snack machine in this case, because of PD no changes needed to be made to your beverage machines, etc), just get the PD container with or without a snack which allows you to pick your own snack, etc; and another example to show how wide the PI uses can be, etc, you go to the store to buy something to drink, etc but, this PI container come with a, etc PD, etc which its product can be display and surround 100% and its said chamber shows product through it, etc and its chamber can also have PD'S, etc molded, etc on it also, etc so all products, etc literal is see also as “eye candy”, etc products, etc and a seen as a extra reasons to buy it, but note said PD, etc can come without product, etc also, etc.
(G) Additional more advantages, etc PD solves and eliminates the need for two or more different kinds of machines like beverage machines and snack machines which will also solve energy and materials to make these said machines, with PD, which works great for apartments, etc, because they typically only have beverage machines, also PD on container, etc solves and eliminates the need for two or more store shelves (this also shows benefit for the environment), and the present invention shows advantages by pairing products, etc match up products with each-other because most likely you would have bought them together any way like soda and candy bars, etc or corn and pea's, etc which would have being many container but can be combine the prevent invention does this also; and said PD is a solution to the problem of need more space, which also mean no need for two, etc or more shipment boxes, etc so said PD cut the need for shipment boxes in half, etc; PD pairing products shows to be good.

(H) The benefit advantages, etc for real wine and alcohol in the container, etc and real chocolate, etc and cocoa, etc in PD, wine, etc and chocolate, etc in others study shows that these products provides health benefits, and red wine, etc is well known in giving you (note of importance if you are shopping at the store, etc and ask a store worker where is the wine they would not point you or take you to the beer section they take you to the wine section) health benefits, etc and dark chocolates, etc are well known in giving you health benefits; these benefits are combined together with one, etc container with, etc PD (remember invention teach can be without PD, etc teach yourself this invention) providing and combining these great benefits together, so therefore the present invention do just combine products for no good reason go see product section, etc, this a different approach and utility way to use these benefits together and PD, etc combine them, etc and all antioxidants products, etc. (I) PD advantages on medicine bottle container, which, hold, carry, stores, medicines, etc see drawing, etc is medicine bubble packages 82, etc these said package are sold in stores, etc without PD, etc which do not come with child safety protection, but with PD, these medicine bubble package, etc or lock safely inside of Pd, this container PD also provides many more benefits advantages like combining many bottles, etc of medicines, etc into one container because many people have more then one kind of medicine and can misplace them but with PD, etc all his or her medicine is in one, etc container, etc PD, etc; learn this invention.

(I) Advantage, when said display PD also allows easy access for runners, walkers, bikers, etc; remember the PI use container newly also with display PD (like the bike, sports, worker, mug, cooler, robot, drone, etc container, etc) or to have easy access to there PD contents, etc of candy bar, etc cell phone, etc foodstuff, etc drinks, etc products, etc; a example is given the DETOUR DE FRENCH or the OLYMPIC GAMES bike rider, etc do not have to stop to UN-screw, etc then re-screw, etc and removing container from said holder, etc to have access to there power bar, etc, or there extra power drink which could be in, etc a, etc PD also with easy access, that easy to get to with out stop the bike, etc which could cause them to lose the race, etc; and furthermore the PI can also allow them access to there cell phone, etc tools, etc all while riding, etc there bike, etc said rider, etc just reach, etc down, etc like he or she was reaching to have access to there main container (the sport bottle, etc) drink, etc and leave, etc said main container drink, etc in the bike holder, but just grab the power bar, etc in display PD, etc with and with out a, etc door, etc because some of the PI PD, etc are made the same shape, etc as said power bar, etc cell phones, etc, and some are made universals PD'S, etc for any power bar, product, etc; and once again the PI has no need for UN-screwing, etc and removing, etc; and said PI container, etc and PD, etc will be made also with net doors, etc rubber doors, etc, all made also by computer designs, etc machines, etc.

Said robot, etc remote control or not said robot for said PI will also hold, etc said product, etc which is already known in the arts that they do this and said robot will also be able to come out, etc roll out, etc (ex cooler, etc bike container, etc) of said PD, etc and the PI will have robots, etc which will be of all kinds, etc like and unlike humans robots, etc cars, etc boats, etc planes, etc bugs, etc animals, etc. Remember the PD, etc can have (or not) PD, etc made in, etc it, etc or near it, etc or next to it, etc on said container, etc or product, etc, and product can have PD, etc (or not), etc made in it, etc or near it, etc or next to it, etc none stop, etc and product, etc can have etc (or not) products, etc made in it, etc made by machining, etc. Remember the PI can have many robots, etc for the PI container, etc product, etc and with and without products, etc, remember teaching this said robot can be a, etc drone, etc, which can also be made to clean up your camper ground, etc and place trash, etc in it PD, etc. Note when product is without a, etc PD, etc its can be also in a, etc PD, when product do have a, etc PD it do not needed a, etc PD or container to be sold with, etc.

(J) further text from just said text, screwing and UN-screwing could be dangerous to rider on a bike, etc or dangerous to a runner, etc because the UN-screwing, etc can be complicate to operate when UN-screwing, etc and running, etc at the same time, etc (said display also allow access to product with out moving said container, etc; an ex the cell phone product with this PI PD allows rider, etc to push there speaker phone button without removing it from the PD the PI does this advantage, etc also, not others patents, etc; so said PI allows you to use your hand-free mode on your phone because said PD shows easy access even with the PI door the PI still shows easy benefits advantages, etc; and when said bike holder, etc could be any of the PI, etc new container with new use PD, etc (note seen as new, etc because they are use on bike, etc now with new said product use newly spill proof kid closures, etc,) so therefore reach down, etc and grab your milk, etc and cookies, etc or soda bottle, etc and candy bar, etc or your power drink, etc and power bar, etc, without spilling your drink, etc; for more UN-obvious uses, etc place in the word milk, etc the word juice, etc chips, etc, all with display, etc PD all use newly on the said bike holder, etc (etc, in this case can be also not just biker holder do not think this product, etc or way, etc is just for bikes you would be wrong, etc), and any of the PI containers PD, etc can come with the new use kid, etc spill proof closures, etc.

(K) furthermore PI shows more advantages, etc the PI will also use the said TT newly in the PI buy use it also for electronics products, etc clothes, etc not just food, etc and drinks, etc; furthermore the PI uses are wide, etc like the use of the display PD, etc product for easy access, etc and the uses of the said TT which in the PI can also surround its product, etc 100%, and the uses of combing of product with also benefits, etc; an example the wine, etc health benefit pair with other benefits products making a super container fill with many benefits and with health benefits like said wine pair with dark chocolates, etc and many other pair uses and super uses said through-out the PI and shown in the drawing, etc; also when said dis play PD, etc shows advantages said displays PD'S, etc also allows away to not place your bacteria hands, etc or stuff, etc in with or near your beverage, etc or food, etc; and shows advantages by having Products in PD which also eliminates bacteria, etc germs, etc products, etc safely, etc, so there fore place your dirt shirt, etc in this PD, etc this PD just said, etc can be on the cooler worker container, etc; these said eliminates bacteria's, etc PD, etc, and furthermore when said display do not mean PD can not be place anywhere on said container, etc, because said TT, etc works anywhere on said container, etc which the PI will use in its PD and they can be connect inside of said PD or made in said PD, learn this PI.

(L) The PI PD shows advantages in drinks and (which PI have also solve the problems where they do not have to make changes to there food and beverages machines, etc in-order to have food and drinks, etc together, etc) food machines, etc allowing drinks, etc to be also sold in snack machines, etc the PI also will have PD on pouches, etc (not shown or see FIG. 16, etc or FIG. 21, etc) now a quick example you can do yourself (the reader) take a soda bottle filled with water and squeeze it without the top on it the water which squeeze out allows less content in the bottle, you just have change the design, etc of the bottle by squeeze it; now by releasing it you change the bottle back to its normal design, etc now its less content (this is also why PI will be made all design, etc it shows advantages) in the bottle, this is changing the design of the bottle allowing less or more contents, this one example out of many in which the sizes, etc design, etc matter, and add on's compartment could cause (which the PI have show in previous text how to not lose ounce, etc) problems or lose of ounces, etc and if a product (not the PI container others prior container compartment, etc) is not display which do not shows advantages could also cause problems, etc; so PI container, etc product and PD shows new containers PD, etc and products uses, etc, also with beverage and food machines advantages shows how by the size, etc design, etc of the PI container and PD, etc surrounds the product 100% see fig. Dfl, etc and the sleeve door which stop your hand, etc from transferring unwanted heat, etc to the product, etc; shows great advantages, etc.

(M) Furthermore the display PD would act also as superimposing advantage “eye candy”, a example you goes to the store, etc and buy a cooler PI container PD, etc, but this said container Unexpectedly come with a, etc water gun product, etc “seen on the container as eye candy influencing (buyer) customer, etc”, which in this case, etc for water, etc when there no water, etc (note the PI let you use beverage, etc also to be use in said water gun drink it or shoot it, etc at others, etc UN-obvious, etc but turn) when you run out the park, etc at a big open field, etc you can use the cooler water, etc, and/or ice (for super cold, etc shoots, etc of water, etc). (N) more advantages is shown, and a closely fitted description other invention do not said and should be seen as the PI like the milk container, etc with white milk, etc in the container, etc and chocolate milk, etc in the PD, etc and said PD can even be at the mouth of a, etc container, etc advantages, etc pour, etc two, etc different milks, etc at the same time, etc; and the PI shows advantage with a said out side PD which do not enter the container inside or a container with parts, etc of a body of container parts, etc also would not be effect by this said out side Pd and this said PD, etc can even surround other containers, etc with compartments, etc themselves, etc.

(N) PI shows advantage with its PD which becomes the packages, etc or container, etc for its product which means product need no packages, etc or housing, etc case, etc or container, etc to hold its, etc to surround its, etc said PD, because said PD now is the packages, etc housing, etc container, etc casing, etc; note PD also just hold, etc stores, etc cool, etc and heat, etc product, etc also some will be removable products, etc and PD, etc and some are not removable, etc, and once again you the reader must place every product, etc in every PI container, etc one at a time or many at a time in one or many PD'S; an example, the workers, etc cooler container, etc have a, etc display, etc PD with a radio PD, etc or built in not removable Product or a, etc PD'S radio products, etc for one or many workers, etc (or not to all said because of company and customer rights, etc); or said cooler, etc (said etc could be in this case a, etc sport team cooler, etc) have a, etc TV PD or not (not shown) but this product container inside, etc parts or workable parts, etc or housing is not removable the PD can be its housing (or not); and another UN-obvious example the cup container (not shown container and product, etc without reference numerals, etc or not shown to keep from having to many drawing and text, etc they should be seen as not shown or as I representation containers, etc); so a cup container having a, etc TV, etc or not or a, etc radio, etc or not or even have many PD'S, etc many products, etc or not or a cell phone PD or not (which would be a cell cup which its said cup containers, etc could cool hot said phone, etc); etc remember the PI teaching, etc said PI will be made all designs, etc and said PI can have a, etc odd shape design, etc PD, etc with a, etc product shape, etc different from its UN-obvious PD, etc.

(O) The PI shows more UN-obviousness, etc and novelty, etc wear, etc your garden plant food, etc product, etc PD; or wear your tools, etc product, etc PD; remember this PI you can wear all at once, etc or not in, etc the same container or not; and as you garden, etc snap off, etc (can be also bands, etc which have female and male plugs, etc on plant, etc container and on bands, etc to connect together, etc see PI connect through-out the PI every product can also use them, etc; and use, others known in the arts product connection, etc like and UN-like the camera, etc which connect to your bike helmet, etc) said wearable product, etc and pour, etc some drink, etc some food, etc on said plant, etc; and remember the PI is for human, etc and animals, etc here some more UN-obviousness, etc and newness, etc a, etc wearable pet container, etc can also wearable pet PD, etc or product, etc remember PI teaching, etc; so said pet container, etc can also have a, etc UN-obviousness pet toilet PD, etc (product, etc receive body waste PD, etc or feeder or both, etc in one, etc or not) or feeder PD, etc which can also come off, etc; or not, (by also said ways already said in PI and by collar, etc straps and bands, etc to be wore on pets, etc or you, etc or even more UN-obvious wore on your plant or plant container or plant pot, etc) said food, etc container, etc; now when you walk, etc your dog, etc have a place for your pet food, etc (which can come off to be a bowl, etc or toilet, etc place it under dog, etc or not just wait and with the bag PD, etc which can be on said toilet PD, etc remember teaching, put out said bag, etc and pick up waste, but note waste can be also dog, etc food wrappers, etc); remember all PD, etc product, etc do not need a container, etc can be sold apart in this PI, etc for companies rights, etc and customer rights, etc said through-out the PI.

(P) this is a closely fitted description, once again the PI shows how it can come without (or with, etc) a, etc product, etc an example a normal already filled soda container, etc with PD, etc can be also made filled; or shipped to soda shop bar, etc soda and ice cream shop, etc or fast food place, etc, stores, etc coffee shop, etc without (note can come already filled container content and Pd contents, etc and or one contents and not the other, etc) contents in the container, etc or the PD, etc,; so said fast food, etc can filled them with there soda, etc icy, etc milk, etc or there special soda's, etc in container, etc and in, etc PD, etc; note these container the PI referring to is the soda bottle see FIG. 11, etc but can be also any of the PI containers, etc but soda container FIG. 11, etc sent to these said fast food companies, etc completely without a, etc PD and without content, etc in container, etc; or note this, said FIG. 11, etc can also be sent to said fast food place, etc without contents in the container, etc and PD, etc this mean this container do have a, etc PD, etc the other said first container, do not have a, etc PD but still send to said fast food companies because it is new for said companies to have these types of containers to filled, etc; do you want it! In a bottle or plastic cup;

and remember the PI container mouth, etc can be made bigger, etc so fast food place, etc machine soda, etc pour easily into the new use container with or without PD, etc this is a closely fitted description, etc; major advantages in product sections, etc like the hearing aid for bikes, etc container, etc, which can also in the robot PD, etc the mug container, etc the water gun product, etc, and for all products, etc and advantages; and advantages and product shows advantages in the bike and sports container, etc having, etc also, etc WALK'IE-TALK'IE, etc (remember all teaching) and this just said product, etc can be in the robot product drone, etc water gun, etc; an example of the WALK'IE-TALK'IE, etc product you ride around the street your mom, etc your sister, etc call you back home or call you top ride her self, and shows super advantages by allowing said mom to watch here kids, etc at all time even when they can see them riding, etc there bike, etc; and remember the PI products, etc and container, etc and PD, etc can be sold apart, etc or together, etc for customer rights and companies rights, etc to also to keep cost down, etc for the customer, etc and for the company, etc this is also a super advantages, etc; now go see the products section for more super advantages, etc.

### CONCLUSION, RAMIFICATION, AND SCOPE

Accordingly, the reader will see that, the present invention pocket department (PD), etc and products, etc will also be environment friendly product, yes indeed so, because this invention also pairs products also, etc and which will resulting in reduce shipment boxes, etc, but even so this invention will also use more environmental friendly materials like aluminum, glass, and bio-biodegradable plastic, etc and materials, etc when suitable to use them because the present invention products, etc is so large it should be seen as being able to use a large amount of suitable materiel's, etc; and remember that PD joints two or more products which could also mean reducing trash how remember the present invention product do not need a, etc wrapper, etc or casing, etc or body, etc why, because the present invention can also (or not) be the wrapper, etc casing, etc the body of a product, etc the housing of a, etc product, etc this will result in reducing trash and materials to made one then, etc one, etc product because the present invention can or not take the place said wrapper, etc or said containers, etc for PD, etc, and in lots of cases the present invention container, etc be able to even saves energy and help the environment by not using battery's, etc but instead uses the touch tech (TT) by transferring cold or heat to products, etc; note the TT works with and without said PD; note that PD and products for this invention will be made all sizes, etc shapes, etc structures, etc and dimensions, etc,

and there will be no limits on how many PD, etc and products, etc and that products, etc will be for said PD and for container benefit, etc and the container, etc with and without PD and you will notice how even the product can have a PD and the PD, etc can be place any where on said container, etc PD, etc and product, etc yes once again product can have PD'S, etc and the PD itself can can PD'S, etc (use as cups, etc bowls, etc cook ware, etc or even candy mold into PD which come out to use to eat with another product, etc) and PD, etc can be made inside and outside, etc of said container, etc; and said PD will also be made with shelves, etc for product, etc. The sport bottle container thru out this invention can or will also provide products, etc with PD, etc. The wine bottle container thru out this description, etc invention can or will have PD with or without product, etc which will allow you to also choose tour own product, etc.

The PI pocket department content, PD, and PD door and parts, etc all together define also as one unit not parts; and some PD need no door to hold its contents, etc PD shape, etc sizes, etc structures, etc dimension, etc can hold it, etc. All PD, etc define as product and all product a define as PD, etc and all products also define as PD, etc and all containers define as product, etc in the PI because they all can hold products, etc. And all said float-able, etc wearable products, etc and PD, etc; and products, etc and PD, etc can be sold apart from said PI container they connect to, etc and because they can connect or be use, etc with container they where not meant for also and other said reasons, in the PI text this also said closely fitted description; note some of these just said PD, etc and product, etc can also be made resealable, etc and waterproof, etc watertight, etc air tight, etc, (note and remember the PI will also use containers, etc which you can suck the air, etc out of them, and some, etc can be sealed in, etc said container, etc, these containers, etc and bags, etc are known in the arts, etc, to suck out air from said container and PI can also use them also as a, etc PD, these said container also are the ones which have pump and value hole, etc which suck air, etc out but do not, etc let air in, etc, they are known in the arts and the PI will also use them but not shown) seal materials, etc will also be uses as PD doors, etc and seal, etc for PD, etc all known in the arts, etc and applied to PD, etc, these just said PD, etc and products, etc.

Note wearable PD, etc product, etc can (float-able PD, etc can be made wearable, etc also or both, etc also be remote control boats, etc with, etc PD, etc, learn PI) the PI products, etc can also fly, etc see fig's and the PI products can) be also made to be float-able, etc and wearable, etc (or not to all said) all in one, etc, and remember the PI float-able, etc can hold bowls, etc cups, etc sops, etc food, etc dish, etc cook ware, etc oven, etc yes a float-able oven, etc stove can be also on a floating PD, etc remember teaching product can be also made compact, etc and said PD, etc can be made to go in the oven, ice box, etc stove, etc camp fire, etc connect by said grooves, etc to said container PD, etc or not, can be made out of also known in the arts cook wear, etc and you must 100% remember all said can be one or not wearable, float-able, cookware, etc see fig with seal space wall so product can float said cook ware can be made with said, and can connect to you, etc all in one or not, etc, and note all said can be for humans, etc pets, etc, which also means all container can be also humans and pets food, etc or all humans drink, etc or all animals, etc food and drinks, etc (etc in this case also shows no limits, etc).

And note once again the PI will use suitable material, etc in the arts, etc to made these containers, etc and products, etc, etc like metals, etc cook wear materials, etc float-able materials, etc all suitable materials, etc and because PD can be made also for not to be cooker also its can also be made out of glass, etc plastic, etc and connect, etc or not to said container, etc or not, etc. Products, etc and PD'S, etc will also be made to stack, etc on each-others, etc (or not) by way, etc known in the arts, etc and by grooves, etc and by plug, etc which uses, etc also female, etc and males connection, etc by interlocking, etc; furthermore PD, etc can have many doors, etc open, etc on a, etc PD, etc product, etc.

The PI container also define as sports bottle thermal bottle, cooler bottle, cooler container, mug, coffee cup, wine bottle, carton, bottle, can container, medicine bottle, bag container, etc O-circle container, and the I representation container, etc and products, etc and all the housing, etc casing, etc the body of container, etc and product, etc; are all made also for materials, of all plastic, etc all papers, etc all thermal materials, etc all foams, etc and all Styrofoams, etc all ceramics, etc all, clays, etc all metals, etc all brass; etc all tins, etc all steels, etc all foils, etc all aluminum; etc all future materials, etc all stainless steels, etc and all heat-conductive metallic element materials, etc; and all basket materials of woods, etc and said wood to be use for PD door because of the high end customers; etc for there high end cars, etc; and will use brass, copper, which also conducts, etc cold, etc and heat, etc or can be made to the container etc by machine, etc or move removable, etc; and said PI will use all new, etc and all known materiel's, etc to all to be use also where then are suitable to be uses, etc; and more parts, etc of the PI which can be also conventionally, etc formed if suitable to do so from materials like, etc polyester, polystyrene, also polycarbonate or polyethylene, etc,

and each of the PI containers, etc can fabricated from suitable materials they already use transparent acrylic plastic and known in the arts; but can also use other said materials, etc in the PI, etc; a example the thermal bottle container in the PI can also have or not a 24kt, etc gold PD removable, etc to be uses also as a cup, etc bowl, etc, so there fore, do not limited the PI materials, etc and how to use them for this invention. More materials which can be use like, polymer; temperature-maintaining materials and pressure-maintaining materials and pressure-resistant materials for beverages, etc; the PI can also use materials that include PET, etc RTM, etc polyethylene, LTX series, etc polycarbonate blend, etc (note company who wish to be bio-friendly, which the PI will hope they will be for being apart of PI will choose materials that is great also for our environment, materials like wheat ware, etc and all bio-, etc materials as a great option also this is also another reason the PI preferred all materials and maybe PI can influence them to switch over in the future to use more bio, etc and green materials, etc);

and use metallic substance or microwave reflective materiel; etc; note once again all materials are used when suitable to be use, etc a example if a PI container is needed to be a microwave container then its obvious to use microwavable suitable material which are known in the arts, etc and ones in the who is skilled in the arts could apply, and insulating and cooling and heating materials; etc and packages; and all thermal gel packages, etc and heat/cooling package and devices, etc and refrigerant coolant materials packages products, etc, and materials like BLUE ICE, etc, and the PD and product will also use recyclable materials (which this is also a benefit for the environment, etc) and the PI will use non-toxic substitute material, which also freeze, etc will also help keep PD, etc cold, etc and its content, etc and contents also define as drinks, etc which is also define as product, etc and product also define already filled container, etc; and contents define as all drinks, etc and medicines, etc and liquid and none liquid contents, etc.

Further the materiel text when suitable in PI PD and container, etc will also be made with flexible material, etc adhesive materials, etc thermoplastic materials, etc and materials like polyvinyl chloride, etc polyurethane, polyethylene, and styrene, etc, synthetic plastics, etc, metallic materials, etc, thermal insulating materials, etc or plastic material, etc suitable to drink from for drinking containers, etc and the water gun product, etc and all the likes, etc, note how to make text is through-out the entire PI not just the how to make section it was necessary to do this to show UN-obviousness, etc; when said thermoplastic materials, etc they can be use by the suitable machines, etc which also blow molding, etc stretch blow molding, etc of preform, etc when suitable to use for making suitable container, etc. Furthermore another reasons for PI said use all suitable materials known in the arts, etc when suitable to use them; and use each-others materials, because this invention is also a company friendly invention allows them to choose, etc product's, etc PD'S, etc, materials, etc, and this is away, etc a, etc process, etc for said company, etc (remember customer rights, etc also).

Furthermore the PI, PD, etc products, etc will also be made of materials, etc known in the arts, etc which prevent (not shown) temperature form soaking, etc through-out, etc example the hand cover sleeve, etc materials use at coffee shops, etc to stop the hot, etc container contents, etc from soaking, etc and seeking through-out the material cup, etc and which could burning your hand, the PI will use these materials, prevention materials, etc also so a cold content, etc can be in the container and a hot product can be in the PD, etc; an example a, etc fast food cup, etc with ice cold drink, etc in the container, etc and the PD have, etc chicken nuggets, etc without either materials changing each-other contents, etc in some cases, sometime the container content, etc is use to heat, etc cool, etc Pd contents, etc; and sometime the PD contents, etc is use to heat, etc cool, etc container, contents, etc, so therefore some time the PI will have this said materials just made (by machining, etc) for the PD, etc or not. Furthermore PD, etc can be also made deep inside, etc container, etc, so that the TT still works, even the ice, etc levels or cold or hot, etc contents, etc levels, etc or low the TT still can work, and further with these types of deep level PD, etc you can also place ice, etc or hot contents, etc in the PD, etc with your product, etc, this is also a closely fitted description, etc.

For the PI will also be made under the container which can have a product inside and open by pull tabs, etc known in the arts, etc. All product, etc and container, etc can be made all sizes, etc shapes, etc designs, etc, so therefore all PI product, etc and PD'S, etc can be also made and uses all machines which also miniaturize products, etc and make Miro-products, etc; and the PI will use robotic machinery to made products, etc; furthermore the PI will have squeeze container with container content which can be soap, or conditioner, or dishwasher, etc and in the PD could be soap bars, etc or dishwasher tear, etc packages, etc or tabs, etc or containers, etc or power or liquid soap, etc and product, etc like candy bars, etc and liquid candy in the container, etc. PI container, etc will also be made all design, etc like it PD, etc; an example said PD, etc and it product, etc could be a food, etc chip, etc mold into the shape of a star, etc octagon, etc any shape, etc and its, etc PD, etc; and container content, etc can be or not the same shapes, etc or not. And remember the PI container (logo if any ex soda, etc) can be made in a door, etc said door made all designs, etc like its PD, by machining, etc; which can have diet, etc soda, etc; or even solid edible in the container, etc and diet ice cream bars, etc or none edibles, etc like menu, etc videos, etc text, etc downloads, etc in the PD, etc.

The PI will also use all flexible and rigid materials, and rubbers, and nylon, and all synthetic elastic materials, and materials when suitable for the PI, etc to use said materials, etc all known in the arts, etc. All parts, etc all materials, etc define also for PI as product, etc; and note that the PI is not limited its self to what materials, etc it will use, etc or can or not use; and furthermore the PD can or not have a, etc transfer heat, etc cooling, etc system (not shown) which can cool, etc heats, etc the conductive metallic element in a, etc PD. Pd will also have removable or not (stay in place not removable) cooling container product, etc which holds, etc cans container, etc any product, etc; and cooling, etc or heating, etc said any product, etc and said product define as cooling and heating materials, etc.

The present invention PD, etc can also be made with enclosed shell hollow filled or with outer walls and inner walls (not shown), defining a, etc space, etc between the said walls and these walls, etc can be fill with thermal materiel, etc; or heat conductivity-retarded, etc liquid, etc enclosed in a hollow shell filled (can be a, etc PD within a, etc PD, etc), or any instant cooling, etc media, etc; and/or any suitable insulting materials, etc; made by machining, etc; and PD door can be made this way also; and can be made to be a, etc snap on, etc door with said ice replacement, etc made in, etc said door and all the like's, etc materials and unlike, etc like use materials which also heats, etc; and sealed, etc into, etc said PD and door, etc. The PI PD door etc will also be made to be fit, etc air-tight when close, etc made by machining, etc. And said PD and/or PD doors, etc walls floors, etc can also use phase change materials, etc; note said phase change materials is one materials out of many mater the PI will have the option to use, etc as TT, etc. Materials in PI like stainless steel, etc aluminum, etc, plastics, etc phase changing materials, etc glass, etc all microwaveable materials, etc and all heating and cooling devices, and all the likes and unlike, which all the PI can also use; can all be define as also TT materials, etc.

The sport bottle container, etc (not shown) clear door, etc can have a, etc PD, etc and its dome cover closure spill cover, etc can have PD, etc (or not) like show in FIG. 1, etc; so therefore the whole container, etc and its top, etc closure, etc can have PD, etc products, etc. And the PI doors, etc will also use, etc all known the arts and connection known in the arts, etc use all (not shown or go see I representation FIG. 21, etc) to be connect to PD, and Pd doors, etc use known the arts locks, etc, etc combination locks, etc and safe locks, etc to lock PD doors, etc and use finger print tech locks, etc voice, etc locks, etc eye, etc tech locks, etc and computer control locks, etc all locks tech, etc; and use all remote control doors, etc like also the open, etc doors, etc and lids, etc and motion sensors, etc open doors, etc and lids, etc (not shown) but connect to the PI and all define as product, etc and PI will use, etc all the like, etc and unlike, etc known in the arts, etc; these said lock doors, etc can be use are not depending on the company, etc needed, etc or want, etc; and all the PI, etc doors, etc and parts, etc and different name PD, etc are all define as PD, etc.

The PI PD'S, etc product, etc can also be, etc made to (not shown) connect to doors, etc to tunnels, etc and connect at all angles, etc, so therefore you can put products, etc in one PD, etc an said product, etc ends up in another PD, etc or run a cord, etc power cord, etc from one PD, etc to another PD or stack etc stuff or products, etc in said tunnel PD, etc which also can be one, etc or none stop or none tunnels, etc PD, etc, which said tunnel PD can be also like the connect four game which color parts made color connection (or real games, etc); and said tunnels can dispense product, etc (etc in this case can be also a, etc tunnel PD dispensing, etc trash, etc or recycle, etc product, etc (cans, etc) so they are easily removable or slide into bags, etc once door, etc is open, but note these tunnel PD, etc can be line with trash bags, etc trash cans, etc like and UN like you place bags in your trash cans, etc, so therefore these tunnel PD can be use in many different ways, etc like some tunnel PD do not have a PD door, etc on the opposite end, etc you just reach into them or place ice into them, many ex can be given, etc; and said tunnel PD will be made to stop the slide of said product, etc.

The PI PD, etc can also be a secret door, etc pathway, etc and some of the PI product, etc will be trade secrets, etc and the PI have a product book, etc different from the PI, etc but fall within said PI, etc at the open door end, etc to stop product, etc from slide out and falling out when door is open product do not keep sling, etc, this PD can have a, etc lift portion, etc at the end of said tunnel, etc PD, etc; the PI PD, etc is also to house product which can moves itself out of said PD like the robots, etc product, etc, which can be made the same shape, etc of its PD; when said robots, etc can be made like and look like, etc humans, etc bugs, etc animals, etc no limits, etc on how they look, etc.

Furthermore PD, etc which have (not show's) the ability's to hold ice, etc which could also have tiny holes (could be bigger holes, etc), etc in the floor, etc to drain the said melted ice, etc, at the bottom, etc of the said PD and said floor, etc can be made to open as a, etc hinge floor, etc or slide out, etc floor, etc with a PD inside of said floor to fill with melded ice, etc and you can use this melted ice, etc to drink or use it for said water gun, etc, but note PD, etc made all designs, etc so instead of the floor hinge, etc to open said PD it can be a, etc PD under a, etc PD, etc and the top PD floor still have said floor with holes, etc note floor, etc could also be ice replacement product, etc remove, etc floor to help prevent ice from melting, etc and this said replacement product, etc (also can be trays, etc walls, etc) can be made to still allows melted ice etc to drain if need to drain; remember product, etc made all sizes, etc and this said under (could also be a slide out bowl, etc in the same shape, etc of said PD, etc and with a door, etc and the door can be the same shape, etc as said bowl, etc) PD hold, etc drain water, etc; and can have a, etc tunnel PD, etc which can drain water, etc to a, etc spout, etc or a, etc hole leading to the (note imagine this is a cooler container could any, etc) ground, etc;

or leading to a, etc water gun product tank hole, etc to fill said melted ice into, etc said tank, etc in, etc a, etc PD, etc on, etc cooler, etc or leading to a, etc cup, (when said to drink this water, etc will be safe to drink because of said replacement floor product in cooler, etc or in said PD with tunnels PD lead to said products, etc said floor, etc can interlock tightly and water proof and can slide, etc up and drown, etc, and said floor, etc can interlock inside, etc of said cooler or inside, etc of said PD and can sit on top of said ice preventing ice, etc from coming in-contact with said ice so said ice drains clean to said cup, etc by the tunnel PD, etc and draining floors, etc) etc in, etc a, etc PD for you to drink from, etc, these said products can be connect to a, etc cooler, etc (all not shown but real, etc). When said interlock also means product, etc can be screw, etc (using screw threads, etc on product packages, etc and screw threads, etc on container, etc PD, etc, and etc, in the case just said can be said product can also snap, etc in to, etc PD, etc unlike and like closure, etc snap on to its container mouth, etc) into its PD, etc, which also define as all design made PD, etc.

All containers, etc and a, etc product for PI also define as all containers, etc and products, etc, which uses power like car, etc plug outlet, etc the PI will be in them also and in battery's, etc power containers, etc and products, etc. Note all said tunnel PD, etc can have doors, etc and can have also waterproof doors, etc and plugs, etc or can have pour spouts, etc connect to them, etc or not, etc but made by machining, etc. A quick note PI container, etc can go in venting machine, etc with no product in, PD, etc, and wearable said bands, etc or weld or adhesive, etc or mold inside, etc of said PD can be also in the inside of said PD, why because said wearable, etc can be sold also in said venting, etc, so said PD also shows advantages by PD holding, etc said bands, etc but note the design of said container can also hold said bands, etc by container having groove, etc in said container for said bands, etc; and said wearable, etc products, etc and PD, etc are for all of the PI said, etc products, etc and PD'S, etc (or not); an UN-obvious example wear your deodorant, etc (or not) after, etc jogging, etc running, etc working out, etc then,

etc use your deodorant, etc (a, etc deodorant, etc PD product container, etc can be also mold etc be worn, etc on your finger, etc) product, etc (said deodorant can be perfumes, etc cologne, etc any product, etc); note the PI wish once again to use all materials, etc because product, etc made all designs, etc and can be any product, etc. When said wearable products, etc will also (not shown) be connect to (or not) belts, etc like also straps, etc watch straps, etc and these straps, etc can also be changeable not just the wearable product can be changeable but the straps, etc also (or not). And many different colors, etc designs, etc styles, etc and said straps, etc belts, etc can connect to product also by VELCORO, etc by buttons, etc loops, etc threads male and female threads made on said straps, etc and on said products, etc; sealed, etc weld, etc bonded, etc perm, anent, etc to straps, etc and product, etc PD, etc by machining, etc; and see all other connection said in the PI and what ever suitable connection is need for the PI will be use example if the product if the product is a more heavy, etc product, etc use the more suitable connection, etc; this text and other said text shows how all, etc PI products, etc can be wearable, etc and products, etc PD, etc containers, etc (or not companies, etc choice);

some UN-obvious connection (this is why you the reader should do what the PI teaches to do, etc all of its teaching, etc not just this teach about to be given, etc) you slide, etc your robot product, etc (could be a miniaturize, etc drone, etc) on to your watch like, etc straps, etc or bands, etc with grooves, etc connection and lock on to said band, etc, and said robot is moving, etc and can show the time (could be cell phone, etc radio appliances, etc) in his belly/chest PD, etc and this said watch, etc can come off, etc to also (or not) connect to other product, etc; you can take off said robot, etc and place it on your desk, etc to also see said clock better, etc said in PI, etc; and wearable products can connect anything suitable, etc and to other products, etc by also grooves, etc and by other known in the arts connection, etc like connection use for bike computer, etc cameras, etc reflectors, etc which also connection and UN-connects, etc from also its base holder, etc; so therefore there are many different types of connection the PI will also use or can use and will, etc or not use them all, said in the PI, etc and put in it PD, etc these said products, etc, and remember teaching and remember they can also be miniaturize, etc or any size, etc shape, etc design, etc), said PI states the rights to be made in all designs, etc; and further the females, etc male grooves, etc and plugs, etc can be use on the strap; etc bands, etc necklaces, rings, etc,

wearable PD, etc and product, etc and container, etc be once and the container, etc can also the TT for your skin, etc (or not); can be just wearable, etc or not, etc; when said use container as TT said bands, etc can be position on purpose (position to stop said TT for cooling, etc your skin, etc) or so that container touch, etc your skin, etc or not, etc, and said bands, etc can also be made from material's, known in the arts to stop temp changing, etc transferring, etc to your skin, etc. More UN-obvious text the PD, etc which holds ice, etc (or not) can be strap on to you, etc (your pet, etc) your arm, etc your leg, etc your headband with your, etc drink, etc or food, etc candy bar, etc power bar, etc; or pet food, etc inside, etc said wearable PD, etc; or the miniature ice box, etc product, etc can connect on, etc your bike, etc your wrist, etc with your drink, etc, remember this PI to understand it; more UN-obvious text the robot; the PI is a invention that allows its user to also use product, etc without removing said product, etc from holder, etc of any kind from container, etc and from its product, etc; and can merge product, etc PD, etc because also the PD, etc can become the packages, etc;

the PI can also can without product, etc because of the customer may already have that product a, example is given the container PD in the shape, etc of a diabetes, etc device, etc, these shapes (or not) made in empty container, etc like cups, etc mugs, etc any, etc and made in already filled beverage, etc food, etc container, etc and already filled diabetes beverage, etc and food, etc, containers, etc, which fits your diabetes products, etc with container contents or not with or without product in the container in the PD, etc, this is another reason, for the “or not” statements, etc said through-out this PI, which all PD, etc all products, etc containers, etc will be also made all sizes, etc all shapes, etc all designs, etc from big, etc to small, etc from super tiny, etc to super bib, etc from wide, etc to short, etc from to long, etc no limits, etc and with and without products, etc and PD, etc The PI also allows a, etc company, etc of the PI to review other patents, etc in-order to not infringe can add a, etc PD, etc in there product, etc or add the PI newness, etc to not infringe, etc. Note PI shows also advantage, etc they can be for many people, etc, an example johnny have a, etc PD on milk container, etc just for him but his bother keep eating his cookie he tell his mother and she tell johnny bother to only eat his cookies, etc out of his PD, etc and also using materials in the arts these PD, etc and products, etc packages, etc can be materials you can write on to show how many PD'S, etc,

you have, etc or that your product with your name on it, etc. Note the PI PD, etc can be bigger, etc (or not) then the whole main container, and can be said Pd to slide, etc apart, etc or slide, etc into many parts, etc from said main container PD, etc by also said grooves, etc disconnecting and connecting, etc advantages eat your lunch, etc and drink, etc and eat your dinner, etc from, etc the same container, etc and different, etc PD, etc; (note said etc, shows also how wide the PI will be and shows how the PI is thinking and doing way beyond the said text and is real option, etc or product, etc or PD, etc beyond what is said, etc and all could be said but text, etc is already very long, etc so the scope is beyond text, etc this also the reason why said reader must place, etc every product, etc in every PD, etc this way of done was created to shorten text, etc because text and drawing can be none stop if this way of doing was not created by the PI.

This super text referred to plug, etc in, etc car, etc vehicle, etc out lets, etc the PI will use all cooling, etc and heating, etc container, etc which plug in, etc to vehicles, etc to power them said heating and cooling containers, etc (cups, mug, etc all product which power by vehicle or by homes plug outlets, etc) and products, etc and note PI will also use transfer energy to said PD to heat, etc and cold, etc said PD product, etc. Note all name container, etc are also define as just container, etc; and all name, etc PD, etc and products, etc which do not have reference number are name to show usefulness, etc numbers not need, but they are define as PD, etc or product, etc see ones, etc that are number, etc. Once (PI hope that you have already lean this teaching, etc) you the reader start add in, etc or deleting products, etc and PD'S, etc then you will truly start seeing what the PI is all, etc about, etc. Note a not shown product, etc PD, etc can be (or not) connect to PD, etc and still leave room, etc for (or not) other products, etc said connect by all said connection text, etc said in PI, and made all designs, etc. The PI can be made by the manufacture in all the fields, etc the present invention fall in, etc and further the PI containers, etc can also be made cheaply, etc and display products, etc and the PI container, etc can be made to save time and the money, etc because with the beverage container like the already can be made with a, etc impression, etc which the PI can use as a, etc PD, etc saving energy, etc and money, etc.

When said PD door, etc can use a, etc pull off lid, etc can be made also by scoring machining, etc controlling the thickness shape, size, structures, and dimension of said PD, etc. When said already filled means also in the PI (they can also come empty for company can fill them like soda containers, etc) container company's fills with there product, which can be different from containers customer fills with contents like cups, mugs, etc. When said agent, the taste of flavor agent is to also taste, etc like, etc (note can be made of real material, etc also, and real trade secrets, etc) beverage soda, etc juices, etc nasty tastes, etc chocolates milks, etc, hot flavors, etc which a, etc container contents can cool, etc down, etc, these flavors agents, etc and extracts, etc the PI will also use, etc. In relative to how the PI products, etc are made, etc besides the operations text, etc, the PI will use all suitable machining, etc, and manufacture machinery, etc known in the arts, etc to make all products, etc container, etc PD, etc, and for the most part or mostly (or not) product, etc are already made products, etc known in the arts, etc and when products, etc is being made, etc or mold, etc into, etc or designs, etc into, etc the casing, etc the body of, etc the product, etc the container, etc,

this is a suggestion for when the PD, etc can be made, etc mold, etc into, etc formed, etc extends into, etc said product, etc and product can be place, etc into the same, etc shape, etc PD, etc removable product, etc (or not) or weld, etc or adhesives, etc permanent, etc; or customer can use there own product, etc in, etc said PD, etc; PI text already talks about this said customer, etc can also use there own product, etc find texts, etc (or not this is a business friendly PI there choices, etc more will be said about this right); and remember the suggestion text the PI allows the buyer rights (this is also the reason for said suggestion section) given the buyer the rights to designs, etc said product, etc containers, etc PD, etc there way, etc, remember made all designs, etc, made all shapes, etc sizes, etc, and give said buyer the rights to even choose there own make ups, etc (see design products water gun, etc) function, etc the build of its parts, etc of said containers, etc products, etc PD'S, etc; and even allowing said buyer the rights to choose even there own machines, etc designs, etc (which could be cheaper, etc for them this is what this PI was also highly made to do, also give companies, etc the buyer, etc supreme power rights, etc, another reasons for said text made all designs, etc); said only suggestion because the buyer, etc will make the final call, etc decision, etc determination, etc judgment, etc.

The present invention can also have (or not) inside walls, etc floors, etc hinging, etc open some open to other PD'S, etc within said PD, etc and some hinging, etc open to the container contents, do you understand ! use your imagination. When said use each other container a quick e.g is given a, etc robot PD, etc have a, etc sport bottle container in, etc said PD, etc and said robot can be connect to said bike by said connection groove, etc magnetic connection, etc The present invention (PI) product, etc container, etc also can (or not) use each other materials, etc, because the PI product, etc can be place into, etc any product, etc examples, candy, etc robots, etc drones, etc all can use each other (because using each-other, etc is what this PI also do, and want this PI is, etc) materials because the robot, etc, have a, etc candy PD molded into it, etc and candy, etc can have drone, etc in it PD, which also can be a candy drone, etc its self, etc (or not); this is another reason the PI said made with any materials, etc; said PD will also sell to high end customer, etc; a example a, etc 24kt gold, etc PD, etc materiel in the coffee cup/mug PD, etc or even more UN-obvious the water gun product, etc PD for said high end customer, etc there this rich kid, etc have a, etc 24kt gold, etc PD for his, etc water gun food PD, etc or a 24kt, etc gold PD, etc (removable, etc gold, etc PD, etc within a, etc PD, etc) travel cup; or PD is made all sliver, etc or the whole cup, etc is made this way;

or the PD is removable use said Pd as a bowl, etc cup, etc cook wear, etc; and this also another reasons the PI prefer all materials and the present invention can use each-other materials, etc each-other PD, etc use each-other products, etc. Note no matter how UN-obvious it appears to be you must once again place every product in every PD, a other example is given, etc; the PI may want to be a wold recorder, etc holder by having house refrigerant product inside a super size world record, etc sizes cooler, etc PD, etc so do not limited this invention uses and rights, etc; so therefore you must pull, place ever said product, etc in, etc every said PD, etc container, etc product, etc, no matter how UN-obvious it seem, etc. Product, etc not seen in container, etc drawings, etc; and the present invention doors can also use adhesive resealable clear, etc plastic, etc doors, etc, and can be pull tabs and be pull rings top now use as a, etc PD door, etc; and PD will be made also to hold many different products, etc in many different PD'S, etc on the same container, etc.

When said a product for said container will mean also a, etc product you buy yourself for Pd, etc or when said a product come with the container also means product come with and without PD, etc but for container having a, etc product or with container and container and container contents, etc. A, etc container, etc can have the same contents as the container PD, etc or have different content, etc from the PD content, etc; a ex spray bottle container have spray bottle, etc products, etc in it PD, etc; or same content can be ketchup, etc in the container and ketchup, etc tear package, etc; any containers, etc in the PD, etc; or same contents can be also salt, etc in the container and salt tear packages, etc in PD, etc, also allowing away to leave the main bigger container at home, etc and taking the said tear packages, etc with you, etc. PD doors, etc will also be made (not shown) open as divider doors, etc which will also allows container to be in holder, etc car cup holder, etc bike holder, etc worker truck holder, etc and still have access to PD contents, etc because the lower door, etc can be block by said car cup holder bottom, etc part, etc.

Note one of the out of many of said PI main, etc goal is to also help people and animals, etc; and to have fun, etc and is not made to hurt people, etc animals, etc; and also, etc to provide help!, etc; and help to also try to influencing better materials to use in your environment (the PI will try this way with companies); when said provide help!, an example it may be someone hurt and is Unable to move a camper, etc and his or her robot, etc (could be drone, etc) in the cooler, etc PD, etc can come out and go catch some bugs, etc and get water etc (remember the robot, etc can have a, etc rechargeable cell phone device, etc and use solar power and bring you its phone or your phone, etc or bring you band aids, etc; go learn teaching in product section, etc) and bring it back in PD, etc to UN-able person, etc this is helping, etc one of the points of the PI, and also one of the points also is inventing PD, etc and products, etc and container, etc which will help us and our environment, etc by start with materials already use by company and influencing them to move more over to bio-biodegradable materials, etc and green materials, etc this is another reason for the PI preferred all materials.

The PI materials can also be when suitable, etc to use (or not) thermal glass, etc, PETG plastic, etc; and thermoplastic material, etc by blow molding, etc to the shape, etc of a, etc container, etc with a, etc PD, etc, and note said float-able product, etc can also be made with the housing, etc is encased, etc within, etc a, etc polyethylene, etc (and all the likes, etc) closed cell foam shell, etc, remember PI use all float-able tech, etc and suitable float-able tech's products, etc and materials, etc known in the arts, etc. The PI containers, etc PD which also do not allow the container content to change it out body or cover or materials, etc

The PI description “hoping to also influence” section text (for companies, etc to make also better choices, etc in terms of materials, etc); and this is also another reasons for using all materials, etc known in the arts, etc for beverage and food, etc and products, etc container, etc is so to try to change how these products, etc are made so in-order to try to be apart of the problems in-order to change the problem within the systems by starting off using the materials already used like P.E.T, etc and change (like many material also because of designs, are many but hope to use better bio-materials, etc also or try to add more in to the production of products, etc) its materials over to or some of it's materials over to wheat wear materials, etc and all the likes, etc; or try to use recyclable materials, etc to made some, etc of the PI product, etc. Furthermore when said the PI hope for at lease, etc one person (or many) to see the PI buttons products, etc and help someone who had one to many drinks that will catch a cab instead of driven this PI will be worth it ! (the reason for trying to be in the beer, etc field is not for money it is to try and help with the problem of drinking and driven, etc, and money can be donate, this invention is trying to help with this problem, etc; and note this is why the defender was born so the PI can also be in this field) and to try to help save a life would be worth it!; even more can be said be apart of the problem within in-order to try to change or help or change

one, etc life, etc; which could a life that could change the world; combining products, etc reducing boxes, etc; and reduce the need for more or have less shelf to be made, etc; reducing gas from truckers, etc shipping different products, which could have being combine together because people buy these products together any way, etc. Once again the PI doors, etc will be also made to open in all direction, etc and can also made will all materials to match or not its product, etc; and can be made said door with PD, etc made in said door, etc which can be fore ice, etc and heat packs, etc to also help keep, etc PD, etc of said door contents, etc cool, etc or hot, etc a quick note the PD will also use known in the arts containers which you fill with hot, etc or cold contents to hold, etc against your body, etc when it hurting, etc to use this way and use to cool, etc food, etc drinks, etc PD, etc products, etc. Note is known through-out history that inventors use some time many parts to get there invention to work and something add wold not have made there invention work they clear, which some patent the PI have search did not made themselves clear, like something add, etc; so the PI has made its self very clear on what its is inventing like the same contents as PD contents, etc,

which contents can also relate to each other, etc or pair with each other, etc which can as be define as same contents, etc as container, etc and PD, etc contents, etc; and if you have learn this PI and remember the teaching you the reader should know this PI, but the PI is not limited to this because the PI ways as being made so you can plug in products, etc PD'S, etc so you can see the PI rights even more, etc then the drawings and text, etc; and this invention allows the PI to stay up to date by also stating, etc (which be seen as this PI land deed) PI container, etc product, etc PD'S, etc made all designs, etc shapes, etc sizes, etc; and is even also for new products, etc and new products, etc not invented yet, this will allow companies of the PI to also be able to design, etc different products, etc within the PI every year, etc every month, etc always staying up to date; because remember this PI can also merge products, etc container, etc also into, etc its container, etc and products, etc, look up the word merge.

The PI may only want to use aluminum materiel to make its PD container, etc; or use only plastic to make it PD container, etc or a combination of them (materials) both; combination uses of materials are known in the arts, etc; so therefore the PI use its materials like its uses its PD'S, etc products, etc which PI uses them in many different ways and different containers also, etc. A, etc product that appears inside of a, etc container, which can be the same shape, etc of the said container PD an, example, etc out many is given a, etc mouth wash container have also a bottom under its container a, etc PD with a, etc tooth brush product in its PD, which appears that the tooth brush, etc is inside the clear said mouthwash container, etc contents, but really its in the container PD; made also by machine, etc. PD door, etc will (not shown) also be made or connect to open in many ways example open like a drawn bridge door, etc which can be use as a plate, etc also for your stuff or open like a house door or pet door, etc and open upward and downward; and open by sliding in all ways; and PD door will hold any suitable, etc product and can be in the same shape, etc as the product, etc all made by machine, etc. Note once again when said same contents, etc is also define as the same contents, etc as container contents, etc or relate to each other contents, etc, an example diabetes, etc drink in the container, etc and diabetic device, etc or food, etc in PD.

Relating same content, etc can also be mouthwash, etc in the container, etc and mints, etc mouthwash, etc gums, etc toothbrush, etc in the PD, etc or wide same content, etc can be vehicle oil, etc in the container, etc and bike oil, etc wipes, etc oil tear package, etc or tools, etc replacement nuts, etc caps, etc funnel, etc in the PD, etc or PD'S, etc; so notice how the PI can have one or none stop PD'S, etc and products, etc and notice how PD, etc product, etc can be even angles, etc into, etc container, etc so that also that all side, etc and bottom of product, etc use the TT (but note said angles, etc is also made so you can be able to use product, etc also without removing, etc product, etc from said PD, etc ex the bubble shooting, etc gun product, etc can have a PD with a, etc screen, etc to see and to record shooting of the bubbles, etc said angle PD, etc allows this, etc which said product screen, etc can be made to stay in PD'S, etc yes PD'S because its, etc a, etc PD for the camera, etc and remote, etc also, etc which can be your own said camera, etc to use in said bubble gun, etc (or PI can sell them to you, apart or with your said bubbles gun product, etc).

In the PI MULTI-PDS, etc and MULTI-PRODUCTS, etc also define as product, etc and PD, etc because the company, etc of the PI have the right to design there product, etc and PD, etc the way the like etc and to keep cost down, etc, so the reader must no what to look for by know to not just look for MULTI-PDS, etc and MULTI-PRODUCTS, etc, because there can only be one, etc PD, etc with, etc product, etc or one, etc product, etc without (or with) PD, etc or product, etc, this is also the reason why many products etc and many PD'S, etc is also define as product, etc and PD, etc. In the PI removable and mounted, etc also define as float-able product, etc and PD, etc, and note when said mounted, etc also means removable, etc or permanent made, etc product, etc and PD, etc on said container, etc and product, etc, which also define as with and without PD, etc product, etc or MULTI-PD'S, etc or MULTI-PRODUCT, etc which also define as removable or not, etc; because once you remove it said PD, etc it can be also a, etc product, etc or MULTI-PRODUCT, etc and MULTI-PD'S, etc product, etc. Note heat reflective, etc sleeves, etc also will be use as a define as doors, etc labels, etc PD'S, etc products, etc and new uses, etc.

The PI will also use the cooler display container, etc can also have plug, etc connect products (go see teaching in product section, etc); so therefore said cooler container, etc PD can also have and said PD can still fit other products, etc at the same time, and have a connect etc germicidal lamp, etc, and all safe, etc bacteria limited products, etc and all the likes, etc and unlike, etc to help with, etc (also to limited them) in the trash PD, etc and the food, etc PD, etc and the cloths cooling, etc PD, etc no limit where this (the PI will also use double, etc layer container, etc known in the arts, etc; and the PI will have shell PD with said filled materials, etc or not; and this said product can be in a, etc PD itself seal in, etc PD or removable, etc) product, etc can be it can even be in other products, etc. When said trash PD, etc and recycling PD can also be uses (not shown) as a, etc PD, etc to also, etc hold (or not), etc products, etc. The PI has the right to be used the way it want to be used and use product, etc and PD, etc the way the PI see them use PI defines itself, as this way also, etc and use each-other PD, etc benefits, etc product, etc; and if said PI did not have the rights to uses its said each-other PD, etc; said PI would be effect by this and the PI rights effected to not do so, etc, this is also what this invention is the, new said use-each-others, etc.

Another reasons for one or none or many PD, etc the PI container, etc; an example one company, etc may have a need for only one PD, etc and another company, etc may have a need for four, etc PD, etc with four, etc different, etc products, etc in said PD, etc; and another reasons for many PD'S, etc, the bigger PD container (the main container which have smaller container, etc) can have eight, etc PD'S, etc, the same shape, etc as the said smaller container, etc which can also pull off, etc said bigger container, etc. Furthermore the PI shows even more noticeable different which shows the PI product can be made into the container and be also not removable (or removable) the PI is also base on these just said options, etc, example the game pin ball can be made of bio-materials, etc (optional) when said option, etc also allows company, etc of this PI to design, etc in many way allowing them customize to there need, etc, so therefore these PI companies, etc do not, become limited with the PI design, etc another example a, etc container with many, etc PD'S, etc and products, etc or many, etc PD, etc with the same products, etc; note when the PI mention dirt as product this statement was not for no reason; an example the PI wine container PD, etc can have (or not) dirt, etc from the same, etc wine fields, etc to be use, etc in your home, etc garden, etc, UN-obvious, etc benefit, etc.

Once again you must place every product in every product, etc in every PD, etc one at a time or many at a time in one, etc or two, etc or 100, etc or 1,000, etc PD, etc or none; a example the cooler container, etc with the 1,000, etc coins PD, etc which can have in the same, etc shape, etc (or not) size, etc, with and without a, etc door, etc; and said 1,000, etc coins PD and coin products (made by machining, etc), advantages, can be use to buy your pops, etc (for your said cooler contents, etc or for your bike container content, etc remember teaching, etc) conveniently on your said cooler, etc, this text just said is to show those who believe there can not be a 1,000, etc PD, etc the PI have now shown that it can be done and will be done (not shown in drawings, UN-obviousness, etc a new, etc yes, but real); to be clear with this also count text, etc with and without, etc PD, etc products, etc and contents, etc can be 1, 2, 3, 4, 5, 6, 7, 8, 9, 10, 11, 12, etc and keep going none stop; or none PD, etc product, etc zero. So therefore with PI do not believe totally what you see, you must believe in what the PI teaches, etc; and what its say to do; and the PI PD, etc and product, etc uses, etc are, etc UN limited, etc, and the PI is also base on this and also base on also the backward and forward, etc PD, etc and, MULTI-PD'S, etc and products, etc, and containers, etc products, etc (or not); and also note that the PI is also this and closely fitted description, etc once you start add, etc or taking away,

the PI products, etc PD, etc (said adding, etc is for all new, etc use, etc container, etc with PD, etc, this will also not infringe, etc); then when said adding then PI will start looking even more not like no other invention, etc; an example add in products, etc (or not) the float-able PD, etc which can act as a, etc float-able cup holder, etc disconnect, etc or connection, etc (can be not removable at all) to main container, etc (which can a bio-soda container, etc floating on said holder, etc) by said grooves, etc male, etc female, etc grooves, etc; or add in (or can be said as plug in, etc) wearable, etc PD, etc to the same just said bio-soda container, etc (or plug in to any other PI products, etc) with float-able ability, etc (or not, remember teaching) so said wearable PD, etc or product, etc can also connect and disconnect to bands, etc; which said wearable PD, etc can connect, etc to container, and connect, etc to containers PD, etc said bands, etc (or not) and product, etc and PD, etc can also be necklace, etc rings, etc and said wearable PD, etc products, etc can also connect to only, etc float-able product, etc (but remember the present invention can be both, etc wearable, etc and float-able, etc products, etc or not, etc or none to all said, etc);

by said groove, etc plug, etc removable, etc reusable, etc, recyclable, etc advantages, etc said bands, etc can also connect to product, etc and can be made to attached anywhere on said container, etc; and products, etc can connect, etc to rings, etc necklace, etc clip on, etc clamps, etc and all other ways of connection in the PI, etc and all known in the arts, etc which is made to connect to you, etc other products, etc connecting to cars, etc bikes, etc boats, etc any product, etc; and said bands, etc can also be made to be also (or not) interchangeable which means said same band, etc can also connect to many different, etc product, etc PD'S, etc by said grooves, etc being on, etc said band, etc also on, etc said products, etc and PD, etc and container, etc, connect them, etc. and to show even more advantages when said add in (or not) add in eight PD'S, etc (or not) the PI is must greater then what it appear to be another UN-obvious, etc example add in, etc, (or not) a, etc TV, etc or radio, etc to the water cooler bottle (the big, etc bottle, etc the trucks, etc bring to your house, etc or job, etc to connect to a cooler system to cool, etc the water which this cooler machine, etc can have a, etc PD, etc on it also, etc) or add in said radio, etc m3p player, etc or TV, etc to the keg container, etc which the robot belly, etc could, etc (or not hold, etc said keg, etc); or add in, etc said product, etc to the water gun, etc product said TV, etc radio, etc any product, etc.

Note the final product from all just said could be only, etc (or not) one, etc product, etc or one, etc PD, etc on the main container, etc, depending on what the companies, etc of the PI want and how they want to make there design, etc; and can afford to do the final decision is there, with the guidance, etc of the PI for them to use better product materials, etc yes in this PI material is also defines product; and once again this is a, etc company, etc friendly, etc and customer, etc invention; furthermore speaking when said giving companies, etc the choice to do this also base on there budget, etc, which we all know the world economic goes up and down, this PI still allows company, etc to do business and cut cost; another reason and advantages the PI to be uses; and product, etc come with and without product, etc and sold apart (or not). As you the reader can see the PI is much more then just same content, etc back and forward products, etc and PD, etc, and much more the merge product, etc and wearable and float-able product, etc; and MULTI_PRODUCT'S, MULTI_PD'S, etc, and display pd, etc, if you the reader at this point do not know these just said products, etc you need to go back and learn this PI because it even much more then I just said; and even its singles container, etc can serve, etc more then one, etc person, etc or not, and shows advantages doing it, etc;

so therefore the present invention (PI) is grand, etc great in sizes, etc beauty, etc importance, etc imposing, etc splendid, etc supreme, etc and can serve one, etc many, etc or animals, etc humans, etc plants, etc. Remember the PI also place PD, etc in the casing, etc housing, etc of products, etc containers, etc and electronic products, etc and robots products, etc and drones and toys products, etc, any products, etc, water gun products, etc and the housing, etc or casing, etc of laser gun products, etc and paint ball guns, etc and product remote controls, etc which all can also define as container, case, etc housing, etc the body of, etc which define as contain which define as container, etc or product, etc (note is a container a product YES! we all no the answer to this); now a, etc example the PI allows you to connect a, etc laser product to your water gun, etc (remember teaching can also be seal into the said product, etc or removable, etc) play laser, etc and shoot water, etc at your dog, etc at the same time; so remember a, etc product can connect, etc to a, etc products, etc or PD, etc or connect in angles, etc and also in angles, etc in PD, etc. The PI PD product, etc made also substantially all sizes, etc shapes, etc designs, etc because of said reason, etc through-out the PI, these predetermined shapes, sizes design can also contain, etc anywhere and anywhere on said container, etc; whereby the benefits, etc allows great ability's of newness, etc. A PD, etc can have (or not) MULTI-PRODUCT'S, etc or that same PD can hold, etc or have, etc (or not) many, etc,

different types, etc products, etc or PD'S, etc; an example hold, etc a, etc TV, etc product, etc in the same, etc PD, etc holds, etc a, etc radio, etc and so no and so no, etc (or not). Note PD, etc can also be place inside of another PD, etc with moving parts, etc place where moving parts are not affected by said PD, etc; further if the reader, etc do not understand (with much respect) fully do not mean the interconnection or interrelate or logically (the PI try its best to help you understand this invention and its process, etc; go and teach your self this PI, more) is not there or is not known or can be seen by the reader but is known by the inventor, this is not a easy to see or to understand invention; you the reader may not see it but its there (just look harder, etc); in the case of many UN-obvious things it may be right in your face and you just do not see it or can found it, the PI have and will teach you the reader to go back and relearn, this PI and this PI will teach you more with the drawing, etc now, etc; further speaking the PI will also connect, etc by the customer rights to place any product they wish in the PI and its there rights to do so etc; define as customer rights, etc; no one can tell them want to place in there PD, etc this means and define as also customer rights, etc.

The PI states its closely fit description, and its product uses, etc and shows its different, etc uses, etc and different, etc drawings, etc. Note for this present invention all is important there is no part of this invention that is not important. The PI is more then (a article of manufacture, etc) a significant step forward and changes our world, the PI PD was design, etc also to reduce waste by combining products, etc (container content, etc and PD contents, etc which both also define as product) and combines coming use products together a example reducing package, etc because the PD can be the packages, etc (PI allows combine ability and TT ability, etc); and the PI container, etc provides PD, etc advantages position, etc and infused, etc merge, etc PD, etc or also infused, etc merge, etc products, etc and they can be made where they do change the form of said container which would cause problem to use, but note the PI will be made in at form, etc design, etc (or not to all said I hope you learn this invention from previous texts, etc).

The present invention has other features and advantages which will be apparent from or set forth in more detail in the accompanying drawings which are incorporated into also this specification, and the following detailed description of the invention, etc which together serve to explain the principles of the present invention; and furthermore the fore going description of the specific embodiment of the PI have been present for the purpose of illustrated and description, they are not intended to be exhaustive or limit the invention to the precise form disclosed, and obviously many modification and variation are possible in light of the above teaching, the embodiment were chosen and described in order to best explain the principle of the invention and its practical application to thereby enable others skilled in the arts to best utilize the invention and various embodiments with various modification as are suited to the particularity use contemplated it is intended that the scope, etc of the invention be defined by the claims, etc appended hereto and their equivalent, etc.

Furthermore, this invention (PI) has additional advantages, etc and benefits, etc and arguments for patentability, etc, which are:

(1) the PI PD, etc in container, etc provides a, etc place for your left over, etc and your left over candy bar, etc which can also be use in the bike, etc bottle PD container, etc; the PI PD utility provides advantages and solves, etc and provides solutions, etc, by also acting sometime, etc as a, etc packages, etc for products, etc, which also means, reducing more then shipment boxes, etc, an example take a candy bar, etc and its packages, etc, and a real beverage container, etc soda, etc, which both are empty, etc because you ate, etc and drink, etc them so now hold the said beverage container, etc in one hand and hold the empty candy wrapper in the other hand throw both in the trash, which show you just throw a package, etc in the trash, etc but with the PI PD, etc with, etc the door with holds, etc and become the said wrapper, etc now you only throw one package in the trash reduce said trash, etc; and said PD, etc can come with a, etc small, etc bio-biodegradable napkin or cover, etc to hold your candy, etc food product, etc and this said candy wrapper make not seem like a lot to save from being made, but they add up into many; why not prevent them from also ending up in the trash we have to start small then reduce more and more waste, and see fig trays which also shows no napkin, etc is even needed and show how a, etc candy bar, etc can be hold, etc on a, etc stick, etc; so there the PI can act as the wrapper, etc.

(2) PD also shows and allows advantages in the cooler container, etc to stores, etc hold, etc cool, etc your meats, etc and breads, etc chips, etc your food stuff, etc and all UN-obvious, etc products, etc like hats, etc (not shown, or see I representation product, etc) and shoes, etc; which also can have PD, etc hold, etc your keys, etc money, etc; (this said PD, etc on the shoe product, etc can be made with a extra thick, etc sole if said PD is locate on the bottom of said shoe this said bottom PD, remember PD, etc can be also place any where, so said bottom PD can be mold into the rubber, etc of said shoe sole, etc or a more rigid PD can be place and seal into said sole PD, etc or cut out place or mold space for said more rigid PD, on said sole, etc which could be also a cut out place on heel materials, etc, all known in the arts, etc then a made PD adhesive, etc in to said heel, etc or said sole, etc which can be also a, etc remember teaching be a, etc PD, etc with a, etc radio wave, etc controller, etc or a, etc remote controller, etc (and all the likes, etc and UN-likes, etc) car, etc boat, etc toys, etc which come out of said shoe, etc UN-obvious but true, and note remember teaching again the shoe, etc logo can have a, etc hinge door open to said remote product, etc, teach your self this PI) a cooler container product, etc for its PD, etc;

which said cooler container PD also can prevent your product bread, etc meats, etc from (said meat, etc and bread, etc can also have PD how made by machine, etc cut hole, etc or when cook or before cook, etc molded with hole then place after cook or when package, etc a, etc product matching, etc said molded, etc, then place in said hole product other type of meats, etc in said meat product with hole, etc and other type of bread in bread product said with molded, etc hole, or cheese, etc or tear packages, etc of spreads, etc; and these said meats, etc and bread, etc product can be also the already-cook and slice products, etc not shown; this just said products, work best with meats because breads normally holds edible product together without a, etc hole in it.), becoming soak in water if they was in the main cooler container, etc contents (not in PD in container part) like some people place in bags, etc there meats, etc which said bags, etc could open and contaminate the main container content if said meats, etc was place in said main container, etc but the PD in the PI prevent this problem but allowing said meats, etc to be in PD, etc and still be cool, etc and said PD prevents your product, etc

from being soak with and floating with the said contents, etc, which said meats, etc which could cause said contamination like e' coil, etc which could cause you to become sick, etc or even worse; but once again the PI solve this major problem of placement of dangerous product, etc which do not need to be place together, etc; and the PD allows and shows advantages, etc by have PD also use the TT so your product cools, etc without having to place your hands, etc in ice freezing water in order to get your drink container, etc out of it; but with said display PD, etc instead of said freezing soak hands, it allows said PD hold, etc and cools, etc said drink, etc show advantage, etc; so therefore display PD, etc provides a, etc place for your products, etc meats, etc can goods, etc cans containers and bottle beverages, containers, etc and your sport products, etc any product you like, etc. Which said can good can have same contents, etc PD, etc peas, etc in container, etc and peas, etc in PD, etc pea, etc and corn, etc meats, etc in the container, etc and meats, etc in PD, etc wet and wet, etc products, etc.

(3) the medicine bottle, etc container and PD, etc shows advantages, etc and can provides a number of different medicine, etc container in one container which means this container with its PD help you to better keep up with you important medicines; an example is given, your home medicine cabinet fill with what seem like hundreds of different medicines bottles, etc but with this PI medicine bottle, etc container made all side, etc with its PD made all sizes, etc, shoes advantages, etc reduces and solve this problem totally eliminate this problem which also means you do not have to look through many different medicine bottle, etc to find the medicine you need because PD provides different medicine, etc inside of PD, etc and PD packages, etc (see medicine bottle container fig's drawings, and text information, etc); so therefore PD on this PI medicine bottle, etc is also good for people who have to take many types of life saving medicines at one time but with PD shows advantages they are all in one container with its PD packages, etc. The PI notice argument, the PI notice that when placing a bag of food chips, etc in the refrigerator, etc the cold, etc bag, etc and cold chips, etc (etc in this case can also be neutral, warm, hot, cold etc) was refreshing to the tester hands, etc and mouth, etc, which the tester like the cold bag and the cold chips, etc, so therefore the bag, etc also use TT and also the chips, etc (product), etc without the bag, so therefor the PI like the feeling, etc of the cold, etc product, etc.

(4) the present invention shows containers, etc with new uses PD, etc products, etc and display PD, etc containers, etc like the: the sports bottle container, etc the thermal bottle container, etc the cooler bottle container, etc the cooler container, etc the mug container, etc the coffee cup container, etc the wine bottle container, etc the medicine bottle container, etc the bag container, etc; note many more containers, etc product through-out the PI will be seen as completely new, these containers, etc are only some of them which shows advantages, etc having also the display PD, etc. More advantages will be said now a container with content of drink, etc its PD can and will also have the same contents, etc as said container, etc, example container has drink content, etc; PD has same drink, etc or different flavor drink, etc to show a different new drink, etc sold with your flavor drink, etc; and more advantages will be said now PD, etc will also be made to pop out, etc slide out, etc to drop out, etc product, etc from it, etc main PD, etc or container, etc, and can be done also by products, etc pop out, etc devices known in the arts, etc dispensers, etc; which you also push buttons, etc to operate, it etc; and furthermore the PD and popping out products, etc and PD'S, etc can use also known in the arts cold, etc activate word, pictures, (etc can be also hot, etc) which will show your PD come with or without products, etc

(5) Argument for patent-ability you can do your self; a neutral container out of the cabinet, etc have a pour hot coffee, etc into it, to heat, etc a, etc product, in PD, etc; which shows a new uses must be said or seen as new and not guess to be new; (was not said in other invention) a example to prove this is different from a refrigerant and microwavable transfer energy; an example taken two empty neutral glass cup's place one in the refrigerant; and leaves the other out on the counter top wait instill the neutral glass cup has cool, etc in the refrigerant, etc; then fill the other glass neutral cup on the counter top with content of hot, etc water, etc (sink boiling water, etc or camper fire pit; try at your risk) and see how the counter top neutral cup is now heat, etc, said counter top glass cup without the electrical refrigerant or electrical micro-wave electrical power; the PI use TT with out this help of said electrical, to cool or heat said cup place in it; but the present invention (PI) shows how the contents with out power products cools or heats (and will be newly use for PD in newly use containers, etc with PD, etc) and the PI will newly also uses none power products, etc to cool, etc or heats, etc it PD, etc contents, etc in empty container, etc and in empty PD etc;

which prove that the PI uses this also in none already-filled containers, etc, also example shows the cooler container, etc filled with ice content not place in a refrigerant, etc said cooler PD contents, etc, use ice contents, etc in etc said cooler container, etc. (to see micro-wave difference place said cup in the micro-wave instead of in said refrigerator, up above text.). Note the PI PD'S, etc and products, etc parts, etc materials, etc and all new uses, etc and all new products, etc and all new containers, etc with PD, etc; and all of these of all kinds, etc falls on the land of the present invention, and should be seen also as a closely fitted description, etc. Further, unexpected products that the new use sleeve product, etc and the FIG. 51, etc (defenders, etc), and said sleeves prevents your hands, etc (sun, etc) from transferring heat, etc to said product, etc or, its is unexpected that the defender cools, etc heats, etc product, etc better with greats results, etc. All new container, etc (never had the PD, etc product, etc within it like the PI place products, etc within, etc products, etc for a quick example different from prior art a, etc candy bar, etc with, etc a, etc PD, etc mold, etc into it, etc holding, etc other candy, etc one example out of many that could be given, etc) product, etc can also uses TT,

which means, said TT is uses different and newly, etc in containers etc which had a, etc PD, etc or display PD, etc, who are suitable to use said TT (but note containers, like the robot, etc can have a, etc cooler, etc in its, etc chest, etc back, etc arm, etc) like the sport bottle container, etc with and without MULTI-PD'S, etc, or PD, etc products, etc; and even more like the sport bottle cooler container, etc (new also with the display PD, etc) can have, etc or not MULTI-PD'S, etc and products, etc, which can hold sport player chips, etc pickles, etc power bars, etc, cups, etc mugs, etc, and further said dis play PD, etc will be newly in the workers truck container, etc the mug, etc in products, etc like toy, etc soft, etc shooting balls, etc darts, etc shooting gun, etc, and many more said through-out the PI, etc; and once again in the PI product, etc also define as container, etc, PD, etc (because they can also or come off of container, etc or can even be sold apart, etc use different from said container, etc) and a, etc product, etc within a, etc product, etc define as product, etc why, because a, etc PD and product can be also uses as such a, etc cup, etc a, etc blow, etc.

Some more of The present invention (PI) advantages scopes, etc; when said design water gun product, etc will also represent all merger products, etc and container, etc and removable pocket departments (PD), etc and not removable, etc products, etc, remember all closely detail statements and all closely fitted description will also be seen as the scope also of the PI; and when said design sucker product (also one of the design edible product) also represent all said edible product said through-out the PI, which are also some of the PI scopes, etc. When said container also define as the I representation container and representation product and all container, etc in the PI, etc and all are also the PI scopes, etc; and when said customers rights, etc and companies rights, etc define also as buyers, etc rights, etc, which give rights to not even have a said product, etc, PD, etc. More company, etc (note this only some scope see entire PI) rights, etc which will also have rights over this entire PI and have the rights; to go backward and forward when using, etc all said products, etc, all said PD, etc, all materials, etc which means said company, etc if they, etc wish they, etc can only use one or none or many said products, etc PD, etc, parts, etc, any wish they like to do when work with the PI,

so therefore if they, etc wish to have a hundred PD'S, etc and one product, etc this PI is base on this right also or to have none PD'S, etc and one, etc or none product this PI is base on this as well, etc see PI text, on how PI can also have products, etc with no PD, etc, this is also what the PI is base on in also in a primary way. Even more company scope shows given the rights to made said TT optional, etc come with and without said TT, which can be also products, etc in said PD, etc which cools, etc or heat, etc could be even solar products, etc which do this, etc in any product, etc container, etc for the PI. Which the PI product materials, etc and product, etc also define as all refrigerants, etc oven, etc metals, etc ice, etc cold and hot contents, etc all cooling and heating devices, etc and all other related, etc products, etc; and combination heating, etc and cooling, etc devices, etc for food, etc and drink, etc and all other said related devices, etc in the PI, etc and the PI will use container, etc and PD, etc contents, etc to cool, etc heat, etc said product, etc and PD, etc (which all said in the PI, etc can be made compact, etc and made adaptable to connect to cars, charger, etc outlets, etc and adaptable to solar device, etc battery devices, etc all power sources, etc; not shown, but can be made permanent, etc or removable in, etc PD, etc remember teaching, etc).

Note more scope for define as which PD, etc and product, etc, and container, etc define also as all name PD, etc, and all name product, etc, and all names containers, etc and all said in different names, etc, product, etc. When said wearable, etc and float-able PD, etc and product, etc, and PD, etc also define as product, because also they will be use also as products, etc and will be sold as product, etc; furthermore a, etc wearable product, etc can be also a float-able PD, etc or can also be all in one, etc; so therefore when said wearable also can be float-able products, etc, which said wearable products, etc are also wearable pocket departments, etc. More scope container also define as the housing of products, etc, the body of products, etc and containers, etc, and the casing of is the product, etc container, etc surrounding, etc of any container, etc product, etc not just food, etc drinks, etc product, etc; some examples of body, etc housing, etc casing, etc product, etc, a cup, etc robot, etc, TV, etc radio, etc drone, etc, shoes, etc, bike container, etc bike bottle, etc, mugs, etc, cooler, etc, all kinds of products, etc (note for etc in this also see the product section, etc;

and note these said housing, etc product, etc can be also containers because they can hold contents also like food, etc drink, etc). More scope, etc when said removable also define as not removable in the PI, because PI can do both, etc, because of the customers, etc and companies, etc rights, etc (buyers); also and when said customer, etc and company, etc also means or not or none, to all or some said the said buyer have the option to use or not use for many reasons given through-out the PI, this PI scope is also highly base on given these rights to business, etc so they can save money, etc, and as there money grows there product line, etc can also grow, etc. The customer, etc and company, etc define in the PI as the buyer, but also said because said company also give the customers, etc rights or the abilities, to give them rights also to save them money, etc (so to be clear the buyer is also the company, etc also given rights, etc to said customer, but customer also make there own choices, etc also no one makes the final choices, for said customer they can also pick want they like in the PI use there own product and pick even products, etc not meant for the PI container, etc this is also what this PI do, etc). Some more product, etc scope, etc, which product also define as container, etc PD, etc MULTI-PD'S, etc MULTI-PRODUCT'S, etc,

wearable and float-able PD, etc and products, etc and fly-able products, etc and remote controlled, etc and radio controlled, etc products, etc, all design products, etc like the design water gun, etc, edible product, etc, sports container, etc robot, etc drones, etc the laser gun, etc cooler container, etc and all said products, etc and container, etc and all new uses container, etc and products, etc with PD, etc and products, etc; said in the PI, etc. Which said all new use container which also define as product are also define as product; and product define as all vacuum seal container, etc bags, etc known in the arts, etc, which the PI can also place, etc in the PI, etc or seal, etc in, etc to said PD, etc container, etc; and some scope shows icy, etc, which can be place in the freeze to be eaten later can come with the soda, etc container, etc and can be soda, etc or taste like soda, etc. Note the PI do not make assumption the PI define (and lead you the reader to its scopes, etc) itself like weight-loss products, etc e.g diet beverage, etc in the container, etc and diet candy bar, etc in, etc the PD, etc remember the PI can sell product apart, etc.

Furthermore when said benefits also define as pairing and aging, etc together, etc; see text which talks about said pairing, etc. Once again e.g of housing robot, which can be also in the PI as a, etc product, and a, etc container because of also its hands, etc can have a, etc PD, etc and can hold, etc containers, etc; and said robot, etc PD, etc can be a, etc container, etc to hold, etc your food, etc drinks, etc, and said robot PD can come off by said groove, etc and products, etc within itself; product, etc PD'S, etc within, etc products, etc PD'S, etc, which can be taken, etc out of a, etc PD and use as a containers, etc for cup drinks, etc plates, etc cookware, etc. More scope the display PD, etc (note a, etc products, etc can also be display, etc connecting to said container, etc product, etc with said plugs, etc even without a PD, on said container, etc) also allows away to allow access to product without open drink, etc, container, etc, e.g eat, etc PD contents, etc now and/or, etc drink, etc container contents, etc later, etc (drinking and eating, etc container and PD content at different time or at the same time, etc display, etc provides benefits, etc advantages, etc), also display allows away to eat some of the PD contents and place leftover back in, etc PD, etc to be eaten, etc or drink, etc later, etc.

The display PD, etc also allows, etc quick access and easy access (like also the cap top PD, etc and the bike bottle container, etc does, etc), without screwing, etc UN-screwing, etc or even removing container, etc from the spot, etc its in, etc. The PI container, etc also define as container already filled, etc, or meant to be filled with beverage, etc sold in the store, etc, and define as container, etc you fill yourself, etc with your own, etc drink, etc. More scope is said a container which also use each other uses, etc, methods, etc uses, each other TT, etc use each other contents, etc, further, container define as also container, etc empty contents, etc without contents, etc or without, etc content, etc in the PD, etc. All closely fitted statements and description, etc, and all text, etc not like any prior art, and all products, etc which is UN-obvious, new, and unexpected, etc,

in the PI as containers, etc products, etc having new and/or, etc specific uses, etc, and specific container, etc with and without products, etc PD, etc, are all seen also as specific uses and specific containers, etc (which they both, etc just said, can also stand with each other, etc, can also be known also as the same, etc (or not) said specific container, etc, and specific uses, etc); to find these specific uses etc look for statement closely fitted description, etc and all UN-obvious text, etc, or text that is UN-obvious, etc, the robot text, etc the drone text, etc, and any, etc description that is new, etc in PI. The PI also allows two, etc or more companies, etc (or to work within there own company, etc or companies, etc using there own bar codes, etc and all the likes known in the arts, etc) to do business or allow the same company to do business with companies, etc they own by also bar codes, etc radio waves tech, etc and all the likes, etc allowing discounts, etc at the cashier, reduce prices, etc by (when interlocking product, etc is in, etc a, etc interlocking PD, etc said bar codes, etc are together or near each-other to be scan together, etc) interlocking bar codes, etc made to read each other products codes, etc and manufacture codes, etc which all just said text also define as buyers rights, etc, which also mean the PI company, etc do not have to do this; or any other text, in the PI etc they can made there own adjustments to there products, etc parts, etc, because reasons, etc given, etc through-out the PI.

All parts and materiel, etc in the (because note how said gold PD can be use as a conductor of cold, etc and heat, etc and be use as a removable or not cup, etc, so therefor said gold can be use as a materials also and use as a product, etc or not buyer rights, etc) PI also define as product, etc, a example of a part, etc be define as a product the tray, etc can be or not pull out, etc the cooler container, etc and use as a severs, etc tray for your food, etc, making said part into, etc a, etc product, etc all parts, etc can be products, etc if the buyers, etc wish it, etc, buyers rights, etc. More buyers right text (the customers, etc and companies, etc of PI rights, etc), buyers rights, etc also defines as with and without products, etc PD, etc, parts, etc materials, etc, backward and forward, etc MULTI-PD'S, etc MULTI-PRODUCTS, etc, the placement of all said products, etc PD, etc removable, etc or permanent said PD, etc products, etc; said company and customers, etc makes there own choices, etc for what is needed, etc or not needed, etc; and said buyers is also given the rights to company's, etc to do none, etc of all just said, etc, or some of what was just said, etc, or to do more then what was said, etc; or not to all said through-out the entire PI, within the PI they can change the PI products, etc parts, etc materials, etc PD, etc around, etc do them in many different ways, etc define also as PD, etc products, etc container, etc made all designs, etc, and buyers, etc rights, etc.

Note the housing of, casing of, the body of, etc all also define as container, etc, and products, etc because of an e.g said drone, etc, said UN-obvious shoes, etc (shoes can have a, etc PD, etc with a, etc slide off, etc remote controller car, etc or can have a, etc pop off, etc PD, etc with can be a, etc screw off lid with beverage, etc in it, etc which can connect to your belt, etc as a, etc clip on, etc remember the PI teaching, etc learn PI, etc) can be use as a container or as a, etc product, etc as you can see the PI container, etc definitions, etc are wide, etc. When said shoe, etc PD, etc product etc can also be connected to said shoe, etc by male, etc and female, etc plugs, etc, all made by machining, etc. Note very important when said “without”, etc in the PI and when said in the claims are not negative limitations, they are define as a process, etc (said through-out the PI), and to keep the invention cheap, etc (if a, etc company have a low budget, etc) and cheap, etc for customers, and company, etc to buy and to make, etc, the PI “without”, etc can also be that the product, etc or container, etc or PD, etc may not have a need for more, etc then one, etc person, etc use, etc, so therefore “without”, etc is not said limitations, in the PI.

Further scopes, etc the PI product, etc are able to also be float, etc be wearable, etc, cookware, etc, using also known in the arts, etc products, etc and materials, etc (use suit cookware materials, known in the arts, etc use all said connection means said in the PI connects; and when float-able use all float-able materials, etc an all ways, etc to made float-able product, etc; also use other text, etc in the PI, etc on float-able, etc products, etc, and see PI fig which also shows how products, etc can be also made with air pocket, etc all the PI products can also use this way when suitable to use or when suitable to use can use all other known in the arts float-able materials, etc and products, etc because the PI also define its self also as using all products which can float will be a, etc PI products, etc which can also use, all said connection means to also become wearable, etc); note learn the PI it can be also a, etc product, etc within a, etc Product, etc or not, etc; can also just be wearable, etc or not, etc; or float-able, etc or not, etc; or be both, etc or not, etc; can be within a, etc product, etc which is edible, etc, and the product its self is not edible, etc, or edible, etc; go and learn this PI (look back at text before this just said text, etc also). Product scopes also define as all glow in the dark products, etc, which are the ones also which never needed batteries, etc, and all glow in the dark, etc products, etc.

Product also define as all products mugs, etc cups, etc all products, etc which also plug into your vehicle, etc cigarette, etc lighter, etc socket, etc, which also (or not) fits in, etc cup holders, etc (or not), these said mugs, etc can also be made with PD, etc and transfer energy, etc said TT to said PD, etc but remember the PI teaching PD, etc can have power products, etc in its PD, etc, which can also heat, etc cool, etc PD, etc contents, etc which these said cooling, etc and heating, etc devices, etc (also known in the arts, etc) can be also made adapter, etc to use all power sources, etc battery, etc; plug in to, etc cars, etc chargeable, etc and remember the PI can take already made product, etc which cools, etc heats, etc and place it into said PD, etc this is what this PI also do merge product, etc; product also define as all adopters, etc 12-volt, etc adopters, etc.

More scopes, etc further more said drone, etc robot, etc products, etc also define as the housing, etc the casing, etc the body of any (Also the casing, etc housing, etc of any product, etc is also a part of the PI) all define as just, etc, product, etc because that is what they are also, etc and further they also define as container, etc because there PD if any can be a, etc container, etc and there PD, etc can hold, etc drinks, etc food, etc cups, etc, so therefore you can even take a, etc fork, etc and reach into said robot hand, etc PD, etc, and eat, etc out of it, etc; this is what this PI is also trying to teach you, etc, how wide the and how the PD, etc product, etc can be place anywhere on said container, etc product, etc. Note FIG. 50 can also have in it loose, etc cigarettes, etc (also can be in, etc PD, etc smoke free cigarettes, etc or/and gums, etc or/and smoker gums, etc and to help to stop smoking product, etc) with, etc electrical, cigarette (and all the likes, etc and unlike, etc) etc or smoke free, etc cigarettes, etc to help with to stop, etc smoking, etc or less the it, etc or to not smoke around baby, etc people who do not like smoking, etc.

More scopes is given for the containers, etc of all kinds of contents, etc can be drinks, etc ice replacement, etc moving parts, etc electronic parts, etc hot and cold, contents, etc; and all the likes, etc and unlike, etc, said and for which the PI can also surround, etc. Note the PI also define its self as being able to be one or none or many, etc or not, PD'S, etc products, etc; and define as with and without said product, etc PD, etc parts, etc, which can be also products, etc PD, etc the TT, etc its self, etc or not. More scope for the sucker product text the lollipop product (the sucker, etc) can be made or be use to dip in content of all edibles, etc without said hole to suck contents, etc be cause the PI said lollipop, etc candy, etc part can be mold into, etc a spoon shape, etc fork shape, etc (not shown) use also a, etc candy mold machine, etc. More scope for the said design water gun product, etc and all said design and all which can be a, etc design product, etc which design product, etc also define as product, etc, because that what its is a, etc product, which is design in more details define as made all designs like the design candy suckers, etc and edible product.

The once again PI containers, etc PD, etc products, etc will be made also all substantially sizes, etc shapes, etc designs, etc; and will be made also all predetermined shapes, etc sizes, etc designs, etc; and can be place anywhere on, etc said container, etc PD, etc products, etc, whereby allowing benefits, also which will also allow great abilities, etc of newness, etc also. More scopes is given for the display PD, etc which can also allow advertisement advantages, etc of another products, etc and allowing one, etc product, etc to be bought, etc because of another product, etc or because the other product, etc is more like to be bought or is more known to people, etc or can be pair with the container, etc contents, etc e.g wine in the container, etc and chocolates, etc cigar, etc in the PD, etc of said wine container, etc, the PD, etc pairing abilities combines benefits, etc; the PI also allows to have a, etc cold container contents, etc and a, etc hot PD contents, etc at the same time; by remember the PD can be made with a, etc removable PD which can be made of said sleeves, etc (said sleeve materials made into the shape, etc of a, etc PD, etc then can be place in a, etc same, etc shape PD, etc all by machines, etc and suitable, etc machining, etc) heat reflecting materials, etc, insulation materials, etc and made with many other suitable materials, etc known in the arts, etc, and also see neutral text, etc; this can be done also by said container contents, etc place in the cooler, etc and the PD contents, etc place in the camper, etc fire grill, etc and many other ways said in the PI go and find and learn this PI. The present invention (PI) is a invention which is also highly, etc (all of the PI is very importance) depend on its, detail description, etc which its claim must also reference.

Still further advantages, etc will become apparent from a consideration of this ensuring details description and drawings; and although the description above and through-out the detail description, etc contains many specification, etc, these should not be construed as limiting the scope of the invention, but as merely providing illustration of some of the presently preferred embodiments, etc of this invention, for example the PD, etc can have other shape such as circular, oval, trapezoidal, triangular, etc, and the product can also have different shapes, etc as said PD, etc and products, etc made all sizes, etc shapes, etc designs, etc.

Although the description above contains many specifications, etc the PI is not limited to them, etc like more limits that other wise would not have being said but said to show how wide the PI scopes are the PI shows also but once again not limit to the example about to be given now as well; so the PD doors, etc (not shown) and parts, etc can also be (or not) hinge, etc to PD, etc container, etc; and also because a, etc pocket less PD container, can still press the said product against said container using said touch tech (TT), etc without said PD, this shows more advantages, etc as well; and said doors; and also PD, etc can connect, etc and dis-connect, etc from its main container, etc; and use also as a, etc separate PD, etc because also said doors, etc and said PD, etc, can be use also as cups, etc bowls, etc holders, etc containers, etc (see FIG. 6, etc); which would have be otherwise unconnected parts, etc which parts, in the PI are also define as PD, etc, thus the scopes of the present invention should be also determined by the appended claims and there legal equivalents, rather than by only the examples given, and the present invention closely fitted description, etc should also be seen and up held as rights of the present invention.

I claim:

1. A container having at least the abilities to at least uses each others product and pocket department, and said pocket department and at least said product can also substantially come with and without at least said container, further comprising at least said container, also providing away of backward and forwards of said at least product and pocket department, which can at least surround said product completely, and said container at least have substantially the same content as said pocket department and product content, and at least said product and pocket department at least made substantially all sizes, all shapes, all dimensions, and all designs, and at least said container can at least have substantially a new display pocket department, and at least said product, causing at least said container to become at least completely new products substantially in said at least container, and said container having at least said product within at least said product, and at least said container and at least said product and at least said pocket department can be at least place substantially in the body of, the housing of, the casing of at least said container and at least said product, further comprising said container having at least substantially a new use heat reflecting sleeve on at least said container and at least use as substantially a new pocket department door, and at least said container can substantially have also at least substantially new specific use for at least said container, with at least said product, and providing at least buyers rights to chose, to decide, there own at least said product, and about all said, comprising:

2. The container of claim 1 wherein said uses each other, said at least product and pocket department means for placing every said at least pocket department substantially in every said at least product, and every said at least said container can substantially have at least substantially a new at least wearable pocket department, or further comprising said at least buyers rights.

3. The container of claim 2 wherein said at least wearable pocket department substantially have means for connection to said at least container, or further comprising said at least buyers rights.

4. The container of claim 1 wherein said at least product can substantially came with and without at least said container, which said at least said container, further comprising the abilities to at least have substantially multi-pocket departments and multi-products, and at least removable pocket department an product, or further comprising said at least buyers rights.

5. The container of claim 1 wherein said at least surround said product, means for using at least the touch tech completely FIG. 51, and also using said touch tech at least newly for more then just at least food, drink, and means for at least product material, which use at least container content, and at least substantially a product for substantially at least cooling and heating, or substantially at least preventing said cooling and heating of said at least food, or further comprising said at least buyers rights.

6. The container of claim 5 wherein said at least preventing, further comprising at least substantially a heat preventing sleeve product, and at least use new as substantially a pocket department door, or further comprising said at least buyers rights.

7. The container of claim 1 wherein said at least having substantially the same content as said at least pocket department and said at least container contents and said product contents, further comprising pairing and aging of at least product, and allowing benefit of said pairing and aging, further comprising said at least buyer rights.

8. The container of claim 1 wherein said at least said product and at least pocket department at least made substantially at least all sizes, all shapes, all dimensions, all angles, and all designs, and at least said pocket department and at least said product can be substantially place anywhere substantially on at least said container, said pocket department, said product, or further comprising said at least buyers rights.

9. The container of claim 8 wherein said at least all designs, further comprising at least substantially a design water gun, with at least with said pocket department, or further comprising said at least buyers rights.

10. The container of claim 8 wherein said at least all designs, further comprising at least substantially a design edible product, which can have at least a flavor agent which could be also at least trade secret add substantially in the mix to of said edible product, to at least taste like beverage, or further comprising said at least buyers rights.

11. The container of claim 1 wherein said having at least said product within at least said product, further comprising at least a merge of at least said product substantially into at least said container, said at least product, said pocket department, or further comprising said at least buyers rights.

12. The container of claim 11 wherein said at least merge of at least product, substantially into at least the housing of, the casing of, the body of said at least product, or further comprising said at least buyers rights.

13. The container of claim 11 wherein said at least merge of at least said product can be made at least substantially permanent, and said at least product can be also at least removable, or not removable, or further comprising said at least buyer rights.

14. The container of claim 1 wherein said at least substantially new specific use for at least specific container can be also with and substantially without said at least pocket department, further comprising at least said product with and without said at least pocket department, but said at least product substantially for said at least container, and said at least container and said at least product substantially together or substantially apart having means for at least benefit, or further comprising said buyer rights.

15. The container of claim 14 wherein said at least substantially new specific use for at least specific container, further comprising at least said pocket department substantially on said at least container, at least for humans, animals, plants, or further comprising said buyer rights.

16. The container of claim 1 wherein said at least container having at least sports container, cooler container, bag container, cooler bottle container, wine container, drone body of, mug, robot casing of, medicine container, water gun housing of, i representation container, and said at least container substantially without or with at least said display pocket department, and with and without said at least product, and further comprising said at least display pocket department allows quick access and easy access to at least said pocket department contents, or further comprising said buyer rights.

17. A method for backward and forward pocket departments and products substantially on at least a container for at least for company and customer for at least rights, comprising:
(a) providing at least said container with and substantially without at least said product, further comprising said at least container with or substantially without at least multi-products, and at least said product substantially without and with at least said product,
(b) providing said at least container with and substantially without said at least pocket department, further comprising said at least container with or substantially without at least multi-pocket departments, and at least said pocket department with and substantially without at least said pocket department,
whereby giving at least said company and said customer, the rights to at least chose there own at least product, and at least numbers of products and pocket departments needed, and with at least even more further rights.

18. The combination of at least a container and at least a pocket department with and substantially without at least a product within at least said product for at least said container means for to at least use said product with at least said container contents of at least drink content, having the means for at least the purpose of not becoming sick from just at least drinking alone, further having said at least pocket department and said at least said product, and at least said container content having means for at least health benefits and benefits, further comprising said container and said at least pocket department having means for to at least cooling and heating said at least product, at least completely, see FIG. 51, and further comprising said at least pocket department having at least means for carrying, holding, storing, dipping ability, and at least having eating and drinking abilities and cooking ability from at least said pocket department, at least said product which at least said product come with and substantially without said at least container, further comprising at least said pocket department and said at least product can be place anywhere substantially on at least said container, further comprising at least said container can having means for connecting for at least wearable and at least float-able for at least said product, further comprising at least said container having the means for backward and forward said at least pocket department and at least said product, and further comprising said at least said container having means for to at least use each others at least said products, said pocket departments, said multi-pocket departments, said multi-products, said display pocket department, further comprising at least said container content can be at least substantially the same content as at least said pocket department contents, further comprising said at least pocket department using at least a substantially new use at least heat reflecting sleeve, which is use also as at least substantially a pocket department door,
further comprising at least said container, which can be at least said container shows, sport bottle container, bag container, thermal container, cooler container, drone casing of, cooler bottle container, robot housing of, mug container, coffee cup, O-circle container, i representation container, having at least substantially a display product with and substantially without or for at least said container, and at least said product, further comprising from said container, which also can substantially have already fill said at least said container, which can at least be wine bottle container with and substantially without at least said pocket department with and substantially without at least said product, with means for at least substantially using said at least container contents and at least said product contents for at least benefit, said substantially already fill at least said container further shows, carton container, bottle container, can container, can container, O-circle container, robot body of, i representation container, and at least said container having at least said display pocket department substantially without and with at least said product within at least said product, means for at least said container contents and at least said pocket department contents to be at least use for said benefits, further comprising at least said i representation container having at least means for said i representation container to at least represent all said container and at least encompass any container not said, which at least said product within at least said product can at least place substantially in, further comprising said i representation container also at least having means for the touch tech for at least said product with and substantially without at least said pocket department but or at least said container, further comprising at least said display pocket department allowing quick and easy access to, at least said container contents and at least said pocket department contents, further comprise said buyers rights, whereby giving at least customers and at least companies abilities to make there at least own choice to want to buy and what to not buy, and to at least give them economic advantages, by means of the abilities to at least chose from many or none of said at least product.
